(19) United States
(12) Patent Application Publication
(10) Pub. No.: US 2017/0046685 A1
(43) Pub. Date: Feb. 16, 2017

(54) TRANSACTION PROCESSING SYSTEM, TRANSACTION PROCESSING METHOD, TRANSACTION PROCESSING DEVICE, AND TRANSACTION COMMUNICATION TERMINAL

(71) Applicant: PANASONIC INTELLECTUAL PROPERTY MANAGEMENT CO., LTD., Osaka (JP)

(72) Inventors: Hiromasa TATARA, Tokyo (JP); Yoshihide NAKASHIMA, Osaka (JP)

(73) Assignee: PANASONIC INTELLECTUAL PROPERTY MANAGEMENT CO., LTD., Osaka (JP)

(21) Appl. No.: 15/305,800

(22) PCT Filed: Dec. 22, 2015
(86) PCT No.: PCT/JP2015/006384

§ 371 Date: Oct. 21, 2016

(30) Foreign Application Priority Data
Jan. 15, 2015 (JP) 2015-006064
Jan. 15, 2015 (JP) 2015-006065
Mar. 6, 2015 (JP) 2015-045112

(51) Int. Cl. G06Q 20/34; G06Q 20/40; G06Q 20/24; G06Q 20/20

(52) U.S. Cl. CPC G06Q 20/341; G06Q 20/204; G06Q 20/209; G06Q 20/409; G06Q 20/24

(57) ABSTRACT

A transaction processing apparatus sends to a transaction communication terminal an obtaining request for a screen that includes the input settlement information and prompts input of the settlement information corresponding to the subsequent input process. The transaction communication terminal receives the screen corresponding to the obtaining request from a settlement-side apparatus and sends the screen to the transaction processing apparatus, which prompts input of the settlement information on the screen. The transaction processing apparatus sends to the transaction communication terminal a settlement process request that includes the settlement information input in the last input process. The transaction communication terminal sends the settlement process request to the settlement-side apparatus and sends to the transaction processing apparatus a settlement completion notification that is sent from the settlement-side apparatus. The transaction processing apparatus prints a slip copy related to a transaction in a case where the settlement completion notification is received.

### TECHNICAL FIELD

The present disclosure relates to a transaction processing system, a transaction processing method, a transaction processing apparatus, and a transaction communication terminal used for performing a procedure of a settlement process in a transaction.

### BACKGROUND ART

When, for example, a settlement process using a card (for example, a credit card) is performed in sales of goods, a transaction processing apparatus (for example, a settlement terminal apparatus) in the related art sends sales information (sales registration) to a predetermined settlement-side apparatus related to settlement (for example, a settlement center operated by a settlement center or a settlement relay center operated by a settlement relay center) in a case where a credit inquiry is made with respect to a holder of the card and where a response indicating no particular problem is obtained. Customer information and sales information are stored as transaction information and accumulated in a random access memory (RAM) in the transaction processing apparatus in a state where a line between the transaction processing apparatus and the settlement-side apparatus is unavailable and in a case where a one-time sales sum is smaller than a predetermined sum. Such accumulation of the transaction information is referred to as “tanking”. After the number of the transaction information tanked for each sales transaction reaches a certain value and the line is restored, the transaction processing apparatus sends all of the tanked transaction information to the settlement-side apparatus at once. The transaction processing apparatus disclosed in PTL 1, for example, is suggested as a preceding technology related to such tanking.

However, an online settlement service (hereinafter, “online settlement”) cannot be performed in a case where the line to the settlement-side apparatus is disconnected. The problem that online settlement cannot be performed is not limited to a case of line disconnection but also arises in a case where the line of a store in which the transaction processing apparatus is installed has a failure such as a break and a short circuit, in a case where a line network goes down, and in a case where the settlement-side apparatus goes down (that is, in a case where the settlement-side apparatus is in a state of unavailability). The transaction processing apparatus in the related art can perform an offline settlement service (hereinafter, “offline settlement”) in a case where online settlement cannot be performed. That is, the transaction processing apparatus in the related art can perform offline settlement without communicating with the settlement-side apparatus if the sales sum does not exceed a predetermined upper limit of a transaction sum that is determined in advance based on a franchise contract between the store and an acquirer (or a third-party settlement processor or an issuer).

The transaction processing apparatus in the related art, in order to perform settlement using an IC credit card function, compares a personal identification number (PIN) that is input by a customer using, for example, a PINPAD included in the transaction processing apparatus or a subordinate apparatus, with card information that is read by a reading device included in the transaction processing apparatus or the subordinate apparatus. Comparison of the PIN is performed in the transaction processing apparatus. Settlement using the IC credit card function is available in a case where the comparison results in a match (authentication).

Meanwhile, in a new settlement scheme (for example, a settlement scheme using an IC credit card function of EMV Level 2 in the EMV specification that is an international unified standard for financial transaction IC cards) in which information required for authentication of a card used in a settlement process is sent and received between the card and the settlement-side apparatus through the transaction processing apparatus, the transaction processing apparatus installed in the store has a problem that not only online settlement but also offline settlement using the IC credit card function cannot be performed in a case where the line to the settlement center is disconnected and in a case where the line network goes down (that is, in an offline state). The offline settlement using the IC credit card function is settlement that is performed between the transaction processing apparatus and the IC credit card without the use of the settlement center.

In other words, in the new settlement scheme described above, while the transaction processing apparatus can access a memory in a chip incorporated in the IC credit card, various types of information stored in the memory (for example, a card number and an expiration date) are encrypted and can be initially decoded by the settlement-side apparatus and cannot be decoded by the transaction processing apparatus. Thus, authentication of the IC credit card is performed by the settlement-side apparatus and not by the transaction processing apparatus. In the new settlement scheme, the transaction processing apparatus sends to the settlement-side apparatus the encrypted card information that is read by the reading device included in the transaction processing apparatus or the subordinate apparatus, and the PIN that is input by the customer using the PINPAD included in the transaction processing apparatus or the subordinate apparatus. Authentication of the IC credit card (for example, comparison of the PIN) is performed by the settlement-side apparatus and not by the transaction processing apparatus. Therefore, in order to perform settlement using the IC credit card function in the offline state, an operator is required to perform offline settlement using a magnetic credit card function that uses information recorded in a magnet stripe provided on the IC credit card.

Settlement using the magnetic credit card function of the IC credit card can be performed since the IC credit card includes the magnet stripe. However, various types of information recorded in the magnet stripe are not encrypted, and security is degraded compared with settlement using the IC credit card function. Furthermore, since settlement using the magnetic credit card function is restrained by the predetermined upper limit of a transaction sum that is determined in advance based on the franchise contract between the store and the acquirer (or the third-party settlement processor or an issuer), the store cannot sell products beyond the upper limit, and it is difficult for the acquirer or the issuer to expect an increase in a commission of the store.

Furthermore, settlement processes cannot be sufficiently processed by the transaction processing apparatus provided in advance in the store when the store is crowded (for example, in a case where purchasers are temporarily increased at a weekend and the like and in a case where purchasers are suddenly increased due to some campaign or limited time sales service hosted by the store). In that case, purchasers form a long line in the store, and purchasers wait for a long amount of time. Thus, convenience of use for purchasers is decreased.

An object of the present disclosure is to prevent degradation of security of authentication information in an offline state and to smoothly perform settlement using a card in a settlement scheme in which information required for authentication of a card used in a settlement process is sent and received between the card and a settlement-side apparatus.

Furthermore, an object of the present disclosure is to smoothly perform settlement using an IC credit card and to avoid an increase in a wait time of a customer for card settlement by using an additional apparatus in communication between a transaction processing apparatus and a settlement center in a case where the number of transaction processing apparatuses provided in a store is not sufficient enough to process card settlement for visitors (customers).

### CITATION LIST

### Patent Literature

PTL 1: Japanese Patent Unexamined Publication No. 2-75097

### SUMMARY OF THE INVENTION

A transaction processing system of the present disclosure includes a settlement-side apparatus to which settlement of a transaction using an IC card is connected, a transaction processing apparatus that makes connection related to settlement of a transaction using the IC card to the settlement-side apparatus, and a transaction communication terminal that is connectable to the transaction processing apparatus and the settlement-side apparatus and makes connection related to settlement of a transaction using the IC card to the settlement-side apparatus. The transaction processing apparatus, in each input process for a plurality of different settlement information related to the transaction, sends any of the input settlement information to the transaction communication terminal in a case where communication between the transaction processing apparatus and the settlement-side apparatus is in a state of unavailability, and sends to the transaction communication terminal a settlement process request that includes any of the settlement information input in the last input process. The transaction communication terminal, in a case where the settlement information sent from the transaction processing apparatus is sent to the settlement-side apparatus, sends to the transaction processing apparatus a screen that prompts input of the settlement information corresponding to the subsequent input process, and in a case where the settlement process request sent from the transaction processing apparatus is sent to the settlement-side apparatus, sends to the transaction processing apparatus a settlement completion notification that is sent from the settlement-side apparatus. The transaction processing apparatus prints a slip copy related to a transaction in a case where the settlement completion notification is received.

A transaction processing system of the present disclosure includes a settlement-side apparatus to which settlement of a transaction using a card is connected, a transaction processing apparatus that makes connection related to settlement of a transaction using the card to the settlement-side apparatus, and a transaction communication terminal that is connectable to the transaction processing apparatus and the settlement-side apparatus and makes connection related to settlement of a transaction using the card to the settlement-side apparatus. The transaction communication terminal, in each input process for a plurality of different settlement information related to the transaction, sends any of the input settlement information to the transaction processing apparatus and sends to the transaction processing apparatus a settlement process request that includes any of the settlement information input in the last input process. The transaction processing apparatus, in a case where the settlement information sent from the transaction communication terminal is sent to the settlement-side apparatus, sends to the transaction communication terminal a screen that prompts input of the settlement information corresponding to the subsequent input process, and in a case where the settlement process request sent from the transaction communication terminal is sent to the settlement-side apparatus, sends to the transaction communication terminal a settlement completion notification that is sent from the settlement-side apparatus, and prints a slip copy related to the transaction.

A transaction processing system of the present disclosure includes a settlement-side apparatus to which settlement of a transaction using an IC card is connected, a transaction processing apparatus of a thin client that makes connection related to settlement of a transaction using the IC card to the settlement-side apparatus, and a transaction communication terminal that is connectable to the transaction processing apparatus and the settlement-side apparatus and makes connection related to settlement of a transaction using the IC card to the settlement-side apparatus. The transaction processing apparatus, in a case where communication between the transaction processing apparatus and the settlement-side apparatus is in a state of unavailability, sends to the transaction communication terminal transaction settlement information that includes brand information of the IC card, a transaction sum, a method of payment, the number of payments, and authentication information of a customer which are input, and includes a card number and an expiration date which are read from the IC card. The transaction communication terminal, in a case where a settlement request that includes the transaction settlement information sent from the transaction processing apparatus is sent to the settlement-side apparatus, sends the sending completion notification for a settlement request including the transaction settlement information to the transaction processing apparatus. The transaction processing apparatus prints a predetermined slip copy in a case where the sending completion notification is received.

A transaction processing system of the present disclosure includes a settlement-side apparatus to which settlement of a transaction using a card is connected, a transaction processing apparatus of a thin client that makes connection related to settlement of a transaction using the card to the settlement-side apparatus, and a transaction communication terminal that is connectable to the transaction processing apparatus and the settlement-side apparatus and makes connection related to settlement of a transaction using the card to the settlement-side apparatus. The transaction communication terminal sends to the transaction processing apparatus transaction settlement information that includes brand information, a card number, and an expiration date of the card, a transaction sum, a method of payment, and the number of payments which are input. The transaction processing apparatus receives the transaction settlement information sent from the transaction communication terminal and sends to the settlement-side apparatus a settlement request that includes the received transaction settlement information. The transaction processing apparatus prints a predetermined slip copy in a case where the settlement request including the transaction settlement information is sent to the settlement-side apparatus.

A transaction processing method of the present disclosure is a transaction processing method in a transaction processing system to which a settlement-side apparatus, a transaction processing apparatus of a thin client, and a transaction communication terminal are connected. The transaction processing apparatus, in a case where communication between the transaction processing apparatus and the settlement-side apparatus is in a state of availability, makes connection related to settlement of a transaction using an IC card to the settlement-side apparatus to which settlement of a transaction using the IC card is connected. The transaction processing apparatus, in each input process for a plurality of different settlement information related to the transaction, sends any of the input settlement information to the transaction communication terminal in a case where communication between the transaction processing apparatus and the settlement-side apparatus is in a state of unavailability. The transaction communication terminal, in a case where the settlement information sent from the transaction processing apparatus is sent to the settlement-side apparatus, sends to the transaction processing apparatus a screen that prompts input of the settlement information corresponding to the subsequent input process. The transaction processing apparatus sends to the transaction communication terminal a settlement process request that includes any of the settlement information input in the last input process. The transaction communication terminal, in a case where the settlement process request sent from the transaction processing apparatus is sent to the settlement-side apparatus, sends to the transaction processing apparatus a settlement completion notification that is sent from the settlement-side apparatus. The transaction processing apparatus prints a slip copy related to a transaction in a case where the settlement completion notification is received.

A transaction processing method of the present disclosure is a transaction processing method in a transaction processing system to which a settlement-side apparatus, a transaction processing apparatus, and a transaction communication terminal are connected. The transaction communication terminal, in each input process for a plurality of different settlement information related to a transaction using a card, sends any of the input settlement information to the transaction processing apparatus. The transaction processing apparatus, in a case where the settlement information sent from the transaction communication terminal is sent to the settlement-side apparatus, sends to the transaction communication terminal a screen that prompts input of the settlement information corresponding to the subsequent input process. The transaction communication terminal sends to the transaction processing apparatus a settlement process request that includes any of the settlement information input in the last input process. The transaction processing apparatus, in a case where the settlement process request sent from the transaction communication terminal is sent to the settlement-side apparatus, sends to the transaction communication terminal a settlement completion notification that is sent from the settlement-side apparatus, and prints a slip copy related to the transaction.

A transaction processing method of the present disclosure is a transaction processing method in a transaction processing system to which a settlement-side apparatus, a transaction processing apparatus of a thin client, and a transaction communication terminal are connected. The transaction processing apparatus, in a case where communication between the transaction processing apparatus and the settlement-side apparatus is in a state of availability, performs a step of making connection related to settlement of a transaction using an IC card to the settlement-side apparatus to which settlement of a transaction using the IC card is connected. The transaction processing apparatus, in a case where communication between the transaction processing apparatus and the settlement-side apparatus is in a state of unavailability, performs a step of sending to the transaction communication terminal transaction settlement information that includes brand information of the IC card, a transaction sum, a method of payment, the number of payments, and authentication information of a customer which are input, and includes a card number and an expiration date which are read from the IC card. The transaction communication terminal performs a step of sending to the settlement-side apparatus a settlement request that includes the transaction settlement information sent from the transaction processing apparatus. The transaction communication terminal, in a case where a settlement request that includes the transaction settlement information is sent to the settlement-side apparatus, performs a step of sending a sending completion notification for the settlement request including the transaction settlement information to the transaction processing apparatus. The transaction processing apparatus performs a step of printing a predetermined slip copy in a case where the sending completion notification is received.

A transaction processing method of the present disclosure is a transaction processing method in a transaction processing system to which a settlement-side apparatus, a transaction processing apparatus of a thin client, and a transaction communication terminal are connected. The transaction communication terminal performs a step of receiving input of the transaction settlement information that includes brand information, a card number, and an expiration date of a card used in settlement of a transaction, a transaction sum, a method of payment, and the number of payments. The transaction communication terminal performs a step of sending the input transaction settlement information to the transaction processing apparatus. The transaction processing apparatus performs a step of receiving the transaction settlement information sent from the transaction communication terminal and sending to the settlement-side apparatus a settlement request that includes the received transaction settlement information. The transaction processing apparatus performs a step of printing a predetermined slip copy in a case where the settlement request including the transaction settlement information is sent to the settlement-side apparatus.

A transaction processing apparatus of the present disclosure includes a first transceiver that makes connection related to settlement of a transaction using an IC card to a settlement-side apparatus to which settlement of a transaction using the IC card is connected, a second transceiver that communicates with a transaction communication terminal which makes connection related to settlement of a transaction using the IC card to the settlement-side apparatus, an obtainer that obtains a plurality of different settlement information related to the transaction through the second transceiver, and a printing unit that prints a slip copy related to the transaction. The second transceiver, in each input process for the settlement information, sends any of the input settlement information to the transaction communication terminal in a case where communication between the first transceiver and the settlement-side apparatus is in a state of unavailability, and sends to the transaction communication terminal a settlement process request that includes any of the settlement information input in the last input process. The second transceiver, in a case where the settlement information is sent to the settlement-side apparatus, receives a screen that prompts input of the settlement information corresponding to the subsequent input process. The printing unit prints the slip copy related to the transaction in a case where a settlement completion notification for the transaction is received by the second transceiver.

A transaction processing apparatus of the present disclosure includes a first transceiver that makes connection related to settlement of a transaction to a settlement-side apparatus to which settlement of a transaction using a card is connected, a second transceiver that communicates with a transaction communication terminal of a portable type, an obtainer that obtains a plurality of different settlement information input by the transaction communication terminal and related to the transaction through the second transceiver, and a printing unit that prints a slip copy related to the transaction. The first transceiver, in each input process for the settlement information, sends any of the input settlement information to the settlement-side apparatus and sends to the settlement-side apparatus a settlement process request that includes any of the settlement information input in the last input process. The second transceiver, in a case where the settlement information is sent to the settlement-side apparatus, receives a screen that prompts input of the settlement information corresponding to the subsequent input process. The printing unit prints the slip copy related to the transaction in a case where a settlement completion notification for the transaction is received by the first transceiver.

A transaction processing apparatus of the present disclosure includes a first transceiver that makes connection related to settlement of a transaction using an IC card to a settlement-side apparatus to which settlement of a transaction using the IC card is connected, a second transceiver that communicates with a transaction communication terminal which makes connection related to settlement of a transaction using the IC card to the settlement-side apparatus, an obtainer that obtains through the second transceiver transaction settlement information which includes brand information, a card number, and an expiration date of the IC card, a transaction sum, a method of payment, the number of payments, and authentication information of a customer, and a printing unit that prints a predetermined slip copy. The second transceiver, in a case where communication between the first transceiver and the settlement-side apparatus is in a state of unavailability, sends the transaction settlement information obtained by the obtainer to the transaction communication terminal. The printing unit, in a case where the transaction communication terminal sends to the settlement-side apparatus a settlement request that includes the transaction settlement information, prints the predetermined slip copy in response to a sending completion notification, from the transaction communication terminal, for the settlement request including the transaction settlement information.

A transaction processing apparatus of the present disclosure includes a first transceiver that makes connection related to settlement of a transaction using a card to a settlement-side apparatus to which settlement of a transaction using the card is connected, a second transceiver that communicates with a transaction communication terminal of a portable type, an obtainer that obtains through the second transceiver transaction settlement information which includes brand information, a card number, and an expiration date of the card, a transaction sum, a method of payment, and the number of payments input by the transaction communication terminal, and a printing unit that prints a predetermined slip copy. The first transceiver sends to the settlement-side apparatus a settlement request that includes the transaction settlement information obtained by the obtainer, and the printing unit prints the predetermined slip copy in a case where the settlement request including the transaction settlement information is sent to the settlement-side apparatus.

A transaction communication terminal of the present disclosure includes a third transceiver that makes connection related to settlement of a transaction using an IC card to a settlement-side apparatus to which settlement of a transaction using the IC card is connected, a fourth transceiver that communicates with a transaction processing apparatus which makes connection related to settlement of a transaction using the IC card to the settlement-side apparatus, and an input into which a plurality of different settlement information related to the transaction is input. The third transceiver, in each input process for the plurality of different settlement information related to the transaction, sends any of the settlement information input by the input to the settlement-side apparatus in a case where communication between the transaction processing apparatus and the settlement-side apparatus is in a state of unavailability, and sends to the settlement-side apparatus a settlement process request that includes any of the settlement information input in the last input process. The fourth transceiver, in a case where the settlement information sent from the transaction processing apparatus is sent to the settlement-side apparatus, sends to the transaction processing apparatus a screen that prompts input of the settlement information corresponding to the subsequent input process, and in a case where the settlement process request sent from the transaction processing apparatus is sent to the settlement-side apparatus, sends to the transaction processing apparatus a settlement completion notification that is sent from the settlement-side apparatus.

A transaction communication terminal of the present disclosure includes a third transceiver that communicates with a transaction processing apparatus which makes connection related to settlement of a transaction using a card, an input into which a plurality of different settlement information related to the transaction is input, and a display that displays a screen which prompts input of the settlement information. The third transceiver sends any of the settlement information input by the input to the transaction processing apparatus in each input process for the plurality of different settlement information related to the transaction. The display, in a case where the settlement information is sent by the transaction processing apparatus to a settlement-side apparatus to which settlement of the transaction is connected, displays the screen that is sent from the settlement-side apparatus through the transaction processing apparatus and prompts input of the settlement information corresponding to the subsequent input process. The third transceiver sends to the transaction processing apparatus a settlement process request that includes any of the settlement information input in the last input process, and in a case where the settlement process request is sent by the transaction processing apparatus to the settlement-side apparatus, instructs the transaction processing apparatus to print a slip copy related to the transaction in response to a settlement completion notification that is sent from the settlement-side apparatus through the transaction processing apparatus and is related to settlement of the transaction.

A transaction communication terminal of the present disclosure includes a third transceiver that makes connection related to settlement of a transaction using an IC card to a settlement-side apparatus to which settlement of a transaction using the IC card is connected, a fourth transceiver that communicates with a transaction processing apparatus which makes connection related to settlement of a transaction using the IC card to the settlement-side apparatus, an input into which brand information of the IC card, a transaction sum, a method of payment, the number of payments, and authentication information of a customer are input, and a reading unit that reads a card number and an expiration date of the IC card from the IC card. The fourth transceiver sends to the transaction processing apparatus transaction settlement information that includes the brand information of the IC card, the transaction sum, the method of payment, the number of payments, and the authentication information of the customer input by the input and the card number and the expiration date of the IC card read by the reading unit. The third transceiver, in response to an instruction from the transaction processing apparatus, sends to the settlement-side apparatus a settlement request that includes the transaction settlement information. The fourth transceiver sends a sending completion notification for the settlement request including the transaction settlement information to the transaction processing apparatus.

A transaction communication terminal of the present disclosure includes a third transceiver that communicates with a transaction processing apparatus which makes connection related to settlement of a transaction using a card to a settlement-side apparatus to which settlement of a transaction using the card is connected, and an input into which transaction settlement information that includes brand information, a card number, and an expiration date of the card, a transaction sum, a method of payment, and the number of payments is input. The third transceiver sends the transaction settlement information input by the input to the transaction processing apparatus and, in a case where a settlement request that includes the transaction settlement information is sent from the transaction processing apparatus to the settlement-side apparatus, receives a printing completion notification for a predetermined slip copy that is printed by the transaction processing apparatus.

According to the present disclosure, degradation of security of authentication information in an offline state can be prevented, and settlement using a card can be smoothly performed in a settlement scheme in which information required for authentication of a card used in a settlement process is sent and received between the card and a settlement-side apparatus.

Furthermore, according to the present disclosure, settlement using an IC credit card can be smoothly performed, and an increase in a wait time of a customer for card settlement can be avoided by using an additional apparatus in communication between a transaction processing apparatus and a settlement center in a case where the number of transaction processing apparatuses provided in a store is not sufficient enough to process card settlement for visitors (customers).

### BRIEF DESCRIPTION OF DRAWINGS

FIG. 1 is a diagram illustrating one example of a system configuration of a transaction processing system of a first exemplary embodiment.

FIG. 2 is a diagram illustrating one example of a hardware configuration of a transaction processing apparatus (master device) of each exemplary embodiment.

FIG. 3 is a diagram illustrating one example of a hardware configuration of an additional apparatus (slave device) of the first exemplary embodiment.

FIG. 4 is a diagram illustrating one example of a software block configuration of the transaction processing apparatus and the additional apparatus of each exemplary embodiment.

FIG. 5 is a diagram illustrating one example of a connection path of the transaction processing apparatus, the additional apparatus, and a settlement center in an offline state.

FIG. 6 is a flowchart describing a first example of the process flow of the transaction processing apparatus and the additional apparatus of the first exemplary embodiment in the offline state.

FIG. 7 is a flowchart describing a second example of the process flow of the transaction processing apparatus and the additional apparatus of the first exemplary embodiment in the offline state.

FIG. 8 is a flowchart describing a third example of the process flow of the transaction processing apparatus and the additional apparatus of the first exemplary embodiment in the offline state.

FIG. 9 is a flowchart describing one example of an operation procedure of communication between the additional apparatus and a settlement relay center.

FIG. 10A is a diagram illustrating one example of various screens displayed on the additional apparatus.

FIG. 10B is a diagram illustrating one example of various screens displayed on the additional apparatus.

FIG. 10C is a diagram illustrating one example of various screens displayed on the additional apparatus.

FIG. 10D is a diagram illustrating one example of various screens displayed on the additional apparatus.

FIG. 10E is a diagram illustrating one example of various screens displayed on the additional apparatus.

FIG. 10F is a diagram illustrating one example of various screens displayed on the additional apparatus.

FIG. 10G is a diagram illustrating one example of various screens displayed on the additional apparatus.

FIG. 10H is a diagram illustrating one example of various screens displayed on the additional apparatus.

FIG. 11 is a diagram illustrating one example of a system configuration of a transaction processing system of a second exemplary embodiment.

FIG. 12 is a diagram illustrating one example of a hardware configuration of an additional apparatus of the second exemplary embodiment.

FIG. 13 is a diagram illustrating one example of a connection path of a transaction processing apparatus, the additional apparatus, and a settlement center in an offline state.

FIG. 14 is a flowchart describing one example of the process flow of the transaction processing apparatus and the additional apparatus of the second exemplary embodiment in a typical online state.

FIG. 15 is a flowchart describing one example of the process flow of the transaction processing apparatus and the additional apparatus of the second exemplary embodiment in the offline state.

FIG. 16 is a flowchart illustrating one example of the process flow of the transaction processing apparatus of the second exemplary embodiment in a case where restoration to the typical online state is made.

FIG. 17A is a diagram illustrating one example of various screens displayed on the transaction processing apparatus in a case where restoration to the typical online state is made.

FIG. 17B is a diagram illustrating one example of various screens displayed on the transaction processing apparatus in a case where restoration to the typical online state is made.

FIG. 18 is a diagram illustrating one example of a software block configuration of a transaction processing apparatus and an additional apparatus of a third exemplary embodiment.

FIG. 19 is a diagram illustrating one example of a connection path of the transaction processing apparatus, the additional apparatus, and a settlement relay center in an offline state.

FIG. 20 is a flowchart describing a first example of the process flow of the additional apparatus of the third exemplary embodiment as an input apparatus for settlement information in the offline state.

FIG. 21 is a flowchart describing one example of an operation procedure of communication between the transaction processing apparatus and the settlement relay center via the additional apparatus.

FIG. 22 is a flowchart describing one example of the process flow of the additional apparatus of the third exemplary embodiment as a relay apparatus for the settlement information in the offline state.

FIG. 23 is a flowchart describing one example of a printing process in the transaction processing apparatus.

FIG. 24 is a flowchart describing a second example of the process flow of the additional apparatus of the third exemplary embodiment as an input apparatus for the settlement information in the offline state.

FIG. 25 is a flowchart describing a third example of the process flow of the additional apparatus of the third exemplary embodiment as an input apparatus for the settlement information in the offline state.

FIG. 26 is a diagram illustrating one example of a connection path of a transaction processing apparatus, an additional apparatus, and a settlement relay center of a fourth exemplary embodiment in a typical online state.

FIG. 27 is a diagram illustrating one example of a connection path of the transaction processing apparatus, the additional apparatus, and the settlement relay center of the fourth exemplary embodiment in an offline state.

FIG. 28 is a diagram illustrating one example of a software block configuration of the transaction processing apparatus and the additional apparatus of the fourth exemplary embodiment.

FIG. 29 is a flowchart describing one example of the process flow of the additional apparatus of the fourth exemplary embodiment in the typical online state.

FIG. 30 is a flowchart describing one example of the process flow of the transaction processing apparatus of the fourth exemplary embodiment in the typical online state.

FIG. 31 is a flowchart describing one example of the process flow of the additional apparatus of the fourth exemplary embodiment as an input apparatus for settlement information in the offline state.

FIG. 32 is a flowchart describing one example of an operation procedure of communication between the transaction processing apparatus and the settlement relay center.

FIG. 33 is a flowchart describing one example of the process flow of the additional apparatus of the fourth exemplary embodiment as a relay apparatus for the settlement information in the offline state.

FIG. 34 is a diagram illustrating one example of a connection path of the transaction processing apparatus and the additional apparatus in a case where a tanking process is performed in an extended offline state.

FIG. 35 is a diagram illustrating one example of a connection path of the transaction processing apparatus, the additional apparatus, and the settlement relay center after restoration to the typical online state is made.

FIG. 36 is a diagram illustrating one example of a software block configuration of the transaction processing apparatus and the additional apparatus of the fourth exemplary embodiment in a case where a tanking process is performed in the offline state.

FIG. 37 is a flowchart describing one example of an operation procedure of the additional apparatus and the transaction processing apparatus of the fourth exemplary embodiment in a case where a tanking process is performed in the extended offline state.

FIG. 38 is a flowchart describing one example of an operation procedure of the transaction processing apparatus of the fourth exemplary embodiment in a case where a tanking process is performed in the extended offline state.

### DESCRIPTION OF EMBODIMENTS

Hereinafter, each exemplary embodiment in which a transaction processing system, a transaction processing method, a transaction processing apparatus, a transaction communication terminal, and a program according to the present invention are specifically disclosed will be described with reference to the drawings. The transaction processing apparatus (hereinafter, referred to as “master device” as well) according to the present invention will be described in each exemplary embodiment below as a settlement terminal apparatus that has a function of performing a transaction (for example, purchase of a product or provision of a service) settlement process using a card (for example, an IC credit card) and that is installed in a store (a store that has a franchise contract with an acquirer or an issuer (a company that issues cards) to provide card settlement; referred to as “franchise” as well). The transaction communication terminal (hereinafter, referred to as “slave device” as well) according to the present invention will be described as a communication terminal that can execute general-purpose applications and has a function replacing the function of performing a settlement process by the transaction processing apparatus in a case where an offline state is brought about between the transaction processing apparatus and a settlement relay center or a settlement center (refer to the description provided later).

### First Exemplary Embodiment

A typical transaction processing apparatus that is not equipped with the technology disclosed in the first exemplary embodiment cannot perform an online settlement service (hereinafter, “online settlement”) in a case where a line to a settlement-side apparatus is disconnected. Online settlement cannot be performed not only in a case of line disconnection but also in a case where the line of a store in which the transaction processing apparatus is installed has a failure such as a break and a short circuit, in a case where a line network goes down, and in a case where the settlement-side apparatus goes down (that is, in a case where the settlement-side apparatus is in a state of unavailability). The typical transaction processing apparatus can perform an offline settlement service (hereinafter, “offline settlement”) in a case where online settlement cannot be performed. That is, the typical transaction processing apparatus can perform offline settlement without communicating with the settlement-side apparatus if the sales sum does not exceed a predetermined upper limit of a transaction sum that is determined in advance based on a franchise contract between the store and an acquirer (or a third-party settlement processor or an issuer).

The transaction processing apparatus in the related art, in order to perform settlement using an IC credit card function, compares a personal identification number (PIN) that is input by a customer using, for example, a PINPAD included in the transaction processing apparatus or a subordinate apparatus, with card information that is read by a reading device included in the transaction processing apparatus or the subordinate apparatus. Comparison of the PIN is performed in the transaction processing apparatus. Settlement using the IC credit card function is available in a case where the comparison results in a match (authentication).

Meanwhile, in a new settlement scheme (for example, a settlement scheme using an IC credit card function of EMV Level 2 in the EMV specification that is an international unified standard for financial transaction IC cards) in which information required for authentication of a card used in a settlement process is sent and received between the card and the settlement-side apparatus through the transaction processing apparatus, the transaction processing apparatus installed in the store has a problem that not only online settlement but also offline settlement using the IC credit card function cannot be performed in a case where the line to the settlement center is disconnected and in a case where the line network goes down (that is, in an offline state). The offline settlement using the IC credit card function is settlement that is performed between the transaction processing apparatus and the IC credit card without the use of the settlement center.

In other words, in the new settlement scheme described above, while the transaction processing apparatus can access a memory in a chip incorporated in the IC credit card, various types of information stored in the memory (for example, a card number and an expiration date) are encrypted and can be initially decoded by the settlement-side apparatus and cannot be decoded by the transaction processing apparatus. Thus, authentication of the IC credit card is performed by the settlement-side apparatus and not by the transaction processing apparatus. In the new settlement scheme, the transaction processing apparatus sends to the settlement-side apparatus the encrypted card information that is read by the reading device included in the transaction processing apparatus or the subordinate apparatus, and the PIN that is input by the customer using the PINPAD included in the transaction processing apparatus or the subordinate apparatus. Authentication of the IC credit card (for example, comparison of the PIN) is performed by the settlement-side apparatus and not by the transaction terminal apparatus. Therefore, in order to perform settlement using the IC credit card function in the offline state, an operator is required to perform offline settlement using a magnetic credit card function that uses information recorded in a magnet stripe provided on the IC credit card.

Settlement using the magnetic credit card function of the IC credit card can be performed since the IC credit card includes the magnet stripe. However, various types of information recorded in the magnet stripe are not encrypted, and security is degraded compared with settlement using the IC credit card function. Furthermore, since settlement using the magnetic credit card function is restrained by the predetermined upper limit of a transaction sum that is determined in advance based on the franchise contract between the store and the acquirer (or the third-party settlement processor or an issuer), the store cannot sell products beyond the upper limit, and it is difficult for the acquirer or the issuer to expect an increase in a commission of the store.

Therefore, hereinafter, the first exemplary embodiment will be described in examples of a transaction processing system, a transaction processing method, a transaction processing apparatus, a transaction communication terminal, and a program that prevent degradation of security of authentication information and smoothly perform settlement using a card in an offline state including when a line to a settlement-side apparatus is unavailable and when a failure occurs, in a settlement scheme in which information required for authentication of a card used in a settlement process is sent and received between the card and the settlement-side apparatus.

The first exemplary embodiment will be described in an example in which, in a new settlement scheme (for example, a settlement scheme in which a settlement relay center has an IC credit card function of EMV Level 2 in the EMV specification that is an international unified standard for financial transaction IC cards) in which information required for authentication of a card used in a settlement process is sent and received between the card and the settlement relay center through the transaction processing apparatus, settlement is performed by using the transaction processing apparatus and the transaction communication terminal (additional apparatus) provided in the store in a case where a line between the transaction processing apparatus of a thin client and a settlement relay center is disconnected and in a case where a line network goes down (hereinafter, referred to as “offline state”). A typical state in a case where the line between the transaction processing apparatus of a thin client and the settlement relay center is available and when the line network does not go down will be referred to as “online state”.

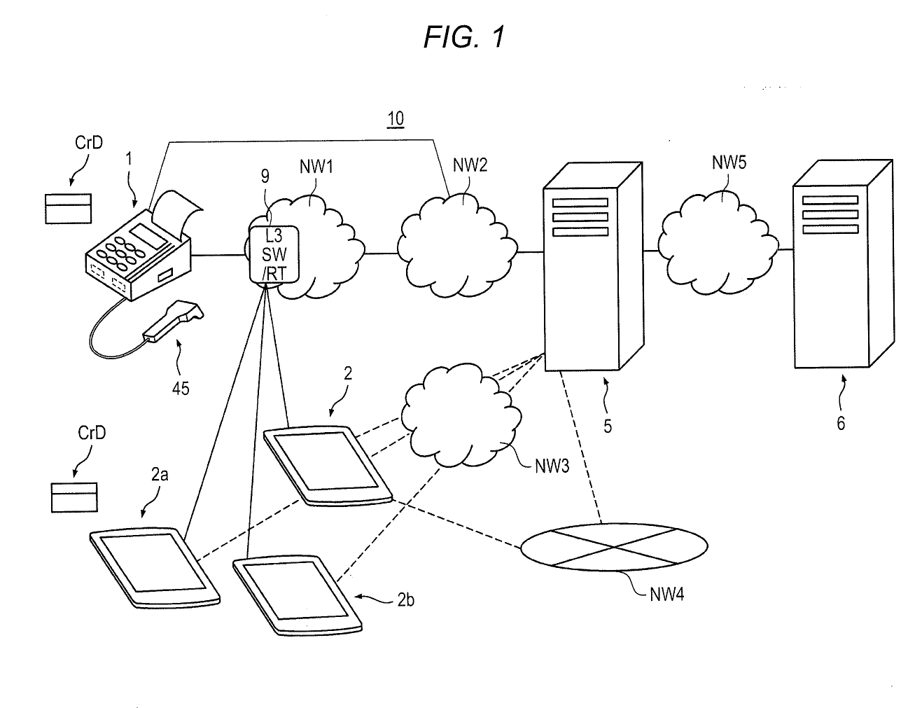

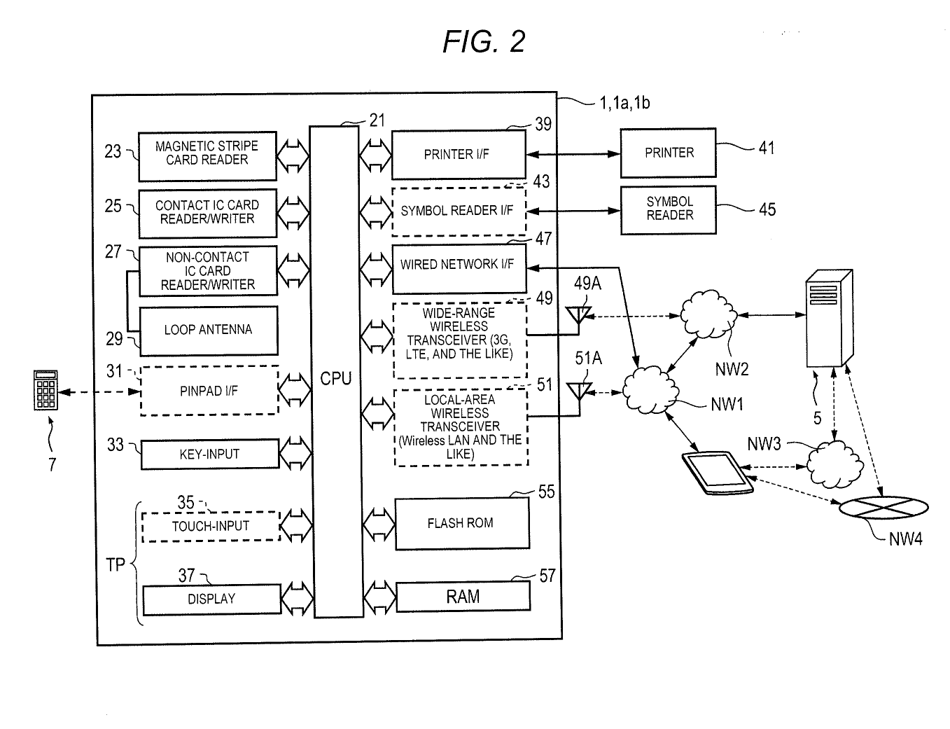

FIG. 1 is a diagram illustrating one example of a system configuration of transaction processing system 10 of the first exemplary embodiment. In transaction processing system 10 illustrated in FIG. 1, transaction processing apparatus 1 of a thin client to which symbol reader 45 (refer to FIG. 2) is connected and settlement relay center 5 as one example of a predetermined settlement-side apparatus are connected through a network (intranet NW1 and Internet NW2), and transaction processing apparatus 1 and additional apparatuses 2, 2a, and 2b of portable types are connected through layer 3 switch or router (L3SW/RT) 9 that is provided in intranet NW1. Additional apparatuses 2, 2a, and 2b and settlement relay center 5 are connected through mobile communication network NW3 or public switched telephone network NW4, and settlement relay center 5 and settlement center 6 are connected through Internet NW5. Transaction processing apparatus 1 and symbol reader 45 are connected by, for example, a cable in a wired manner.

Intranet NW1 is, for example, a wireless or wired local area network in a store in which transaction processing apparatus 1 is provided. Internet NW2 and Internet NW5 are networks that are connected by using a wireless network or a wired network as an interface. The wireless network is, for example, a wireless local area network (LAN), a wireless wide area network (WAN), 3G, High Speed Packet Access (HSPA), Long Term Evolution (LTE), or Wireless Gigabit (WiGig). The wired network is, for example, IEEE 802.3/Ethernet (registered trademark).

Mobile communication network NW3 is a wide area network that is configured by using, for example, 3G, HSPA, or LTE. Public switched telephone network NW4 is a network that is configured by using, for example, an existing telephone line. Other connection networks such as an Internet connection network through an access point that is a Wi-Fi (registered trademark) spot may be used instead of mobile communication network NW3 and public switched telephone network NW4. Other connection networks such as an intranet and a dedicated line may be used instead of Internet NW5.

Transaction processing apparatus 1 is a settlement terminal apparatus of a thin client type in which information including various items related to a transaction settlement process using card CrD (refer to transaction settlement information described later) is input by a user (for example, a staff member of the store or a customer) into touch panel TP and that reads a card number and an expiration date of card CrD. In a settlement scheme in which settlement relay center 5 has the IC credit card function of EMV Level 2 in the EMV specification, information including the card number and the expiration date of card CrD is encrypted in card CrD and, even if read by the transaction processing apparatus 1, cannot be decoded and remains encrypted. The information can be decoded in settlement relay center 5. Transaction processing apparatus 1 communicates with settlement relay center 5 through Intranet NW1 and Internet NW2 or through Internet NW2 in the online state regarding a transaction settlement process that is performed with card (IC credit card) CrD by using the IC credit card function of EMV Level 2 in the EMV specification. Transaction processing apparatus 1 communicates with settlement relay center 5 through additional apparatus 2 (the same applies to additional apparatuses 2a and 2b) and mobile communication network NW3 or through public switched telephone network NW4 in the offline state regarding a transaction settlement process that is performed with card (IC credit card) CrD by using the IC credit card function of EMV Level 2 in the EMV specification. A specific configuration of transaction processing apparatus 1 will be described with reference to FIG. 2.

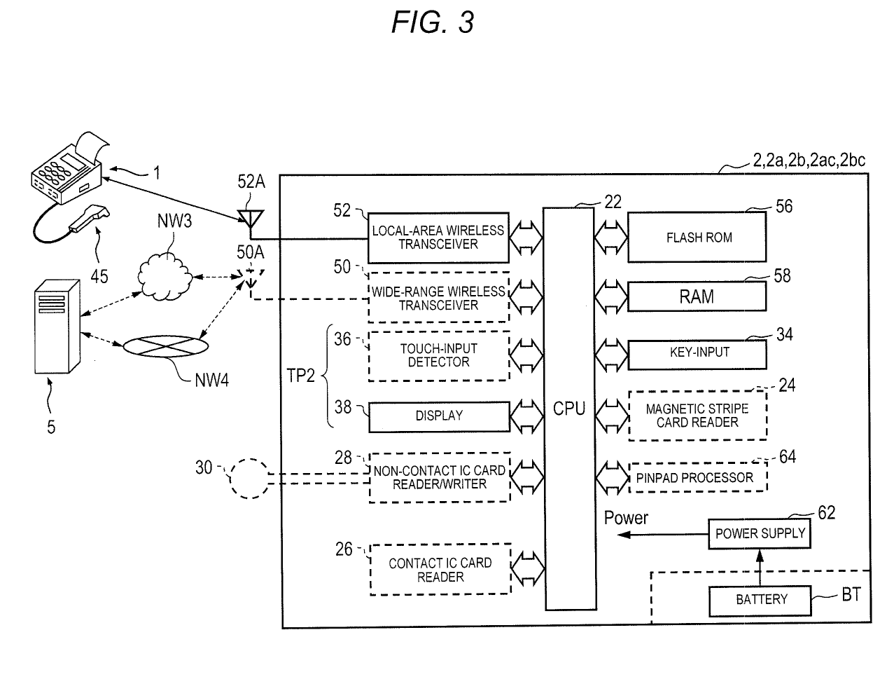

Additional apparatuses 2, 2a, and 2b are communication terminals (for example, smartphones or tablet terminals) that include transportable casings of portable types and can perform wired or wireless data communication, and are connected to transaction processing apparatus 1 through layer 3 switch or router 9. Additional apparatuses 2, 2a, and 2b communicate with settlement relay center 5 through mobile communication network NW3 or public switched telephone network NW4 regarding a transaction settlement process in response to an instruction from transaction processing apparatus 1. A specific configuration of additional apparatuses 2, 2a, and 2b will be described with reference to FIG. 3.

Settlement relay center 5 is a server apparatus for settlement relay processes (settlement relay center) in a third-party processor (that is, a company that is entrusted with business operations by an issuer (a company that issues cards) or an acquirer (a company that recruits franchises providing specific card transaction and manages sales information based on card transaction of the franchises) and relays a settlement process from each franchise on behalf of the issuer or the acquirer). Settlement relay center 5 can decode information in which the card number and the expiration date read from card CrD by transaction processing apparatus 1 or additional apparatuses 2, 2a, and 2b are encrypted. Settlement relay center 5 receives a credit inquiry request or a sales registration request for a transaction settlement process from transaction processing apparatus 1 or additional apparatuses 2, 2a, and 2b through intranet NW1 and Internet NW2, Internet NW2, mobile communication network NW3, or public switched telephone network NW4 and asks settlement center 6 to inquire a determination as to whether or not to give credit and requests settlement center 6 to process sales registration.

Settlement center 6 is, for example, a server apparatus for settlement processes (settlement center) operated by the issuer or the acquirer that directly has a franchise contract with franchises. Settlement center 6, in response to settlement relay center 5 asking for a determination, responds with a credit result, a result of determination of the credit inquiry, or a result of processing of sales registration to transaction processing apparatus 1 or additional apparatuses 2, 2a, and 2b through settlement relay center 5.

FIG. 2 is a diagram illustrating one example of a hardware configuration of transaction processing apparatus (master device) 1 of each exemplary embodiment. Transaction processing apparatus 1 illustrated in FIG. 2 is configured to include central processing unit (CPU) 21, magnet stripe card reader 23, contact IC card reader/writer 25, non-contact IC card reader/writer 27, loop antenna 29, PINPAD I/F 31, key-input 33, touch-input 35, display 37, printer I/F 39, printer 41, symbol reader I/F 43, symbol reader 45, wired network I/F 47, wide-range wireless transceiver 49 to which wide-range wireless antenna 49A is connected, local-area wireless transceiver 51 to which local-area wireless antenna 51A is connected, flash read-only memory (ROM) 55, and random access memory (RAM) 57.

CPU 21 performs a control process to manage overall operation of each unit of transaction processing apparatus 1, a data input and output process with other units, a data operation (calculation) process, and a data storing process. For example, CPU 21 performs each process in accordance with codes defined in the program according to the present invention and thereby performs a transaction settlement process using card CrD with settlement relay center 5 by using any of wired network I/F 47, wide-range wireless transceiver 49, and local-area wireless transceiver 51 in the online state. CPU 21 instructs additional apparatuses 2, 2a, and 2b through local-area wireless transceiver 51 to perform a transaction settlement process using card CrD in the offline state. Details of other operations of CPU 21 will be described later.

Magnet stripe card reader 23 is disposed inside of a slit (not illustrated) that is provided on a side surface side of a casing of transaction processing apparatus 1, has a function of reading a magnet stripe provided on card (for example, an IC credit card) CrD, reads various types of information registered in card CrD from the read magnet stripe, and outputs the information to CPU 21.

Contact IC card reader/writer 25 is disposed inside of a contact IC card insertion port (not illustrated) that is provided on a side surface of the casing of transaction processing apparatus 1 (for example, on the lower left side of transaction processing apparatus 1 illustrated in FIG. 1), and reads or writes card information recorded in a chip (not illustrated) in a contact IC card through an electrode of the contact IC card (for example, card CrD) inserted in the insertion port. The card information read by contact IC card reader/writer 25 is input into CPU 21.

Non-contact IC card reader/writer 27, for example, is connected to loop antenna 29 that is disposed approximately parallel to display 37 of transaction processing apparatus 1, wirelessly communicates with card CrD (for example, an IC credit card) in a non-contact manner using predetermined short-range wireless communication (for example, near field communication (NFC)), and reads or writes the card information recorded in card CrD. The card information read by non-contact IC card reader/writer 27 is input into CPU 21.

PINPAD I/F 31, for example, is connected to PINPAD 7 that is a numeric keypad device used when a purchaser of products inputs a personal identification number (PIN; password) as one example of authentication information, obtains PIN information input by the purchaser, and outputs the PIN information to CPU 21.

Key-input 33 is, for example, a push-type button provided in the casing of transaction processing apparatus 1 and, for example, is used in an input operation in which various types of information related to the card used in a settlement process (for example, a card brand) and various types of information required for a settlement process (for example, a method of payment and the number of payments) are input by the staff member when a settlement process is performed. Key-input 33 may be used when a holder of the card used in a settlement process inputs the PIN.

Touch-input 35 has a function of detecting a touch input on touch panel TP of transaction processing apparatus 1.

Display 37 is configured by using, for example, a liquid crystal display (LCD) or organic electroluminescence (EL) and has a function of controlling display of touch panel TP of transaction processing apparatus 1. Touch-input 35 and display 37 constitute touch panel TP of transaction processing apparatus 1 in the present exemplary embodiment.

Printer I/F 39, for example, obtains from CPU 21 data of predetermined slip copies (for example, a customer copy and a store copy) that indicate that a transaction settlement process is normally ended, and outputs the data to printer 41.

Printer 41 as one example of a printing unit is stored in the casing of transaction processing apparatus 1 and prints the predetermined slip copies by using the data of the predetermined slip copies (for example, a customer copy and a store copy) output from printer I/F 39.

Symbol reader I/F 43 obtains encrypted data of one-dimensional barcode or two-dimensional barcode BD1 that is read by symbol reader 45 (refer to FIG. 1), and outputs the data to CPU 21. The data of the one-dimensional barcode or the two-dimensional barcode is decoded in CPU 21.

Symbol reader 45 reads a one-dimensional barcode or a two-dimensional barcode and outputs data related to a result of reading (encrypted information) to symbol reader I/F 43.

Wired network I/F 47 is connected to Internet NW2 or intranet NW1 of the store which is a wired network, and communicates with settlement relay center 5 through Internet NW2 or communicates with settlement relay center 5 through intranet NW1 and Internet NW2.

Wide-range wireless transceiver 49 is connected to wide-range wireless antenna 49A and has a function of performing communication through Internet NW2 or a wide-range wireless communication path (for example, wide area network (WAN)) such as a form of connection by a telephone line through an access point (not illustrated) that an operator who operates settlement relay center 5 deploys independently. Communication on the wide-range wireless communication path may be performed by using mobile communication such as Wideband Code Division Multiple Access (W-CDMA), Universal Mobile Telecommunications System (UMTS), Code Division Multiple Access (CDMA) 2000, and Long Term Evolution (LTE).

Local-area wireless transceiver 51 is connected to local-area wireless antenna 51A and has a function of performing, for example, wireless LAN communication with additional apparatuses 2, 2a, and 2b that are provided in the store for introduction of products, through a relay device such as layer 3 switch or router 9 provided in intranet NW1. Local-area wireless transceiver 51 may perform communication other than wireless LAN communication (for example, Bluetooth (registered trademark) communication).

Flash ROM 55 has a function of storing various types of data. The data stored may be, for example, program codes and data of an application used in a settlement process performed with settlement relay center 5 (settlement process application), program codes and data of applications related to various business operations (applications for each business operation), or other programs and data for controlling each unit of transaction processing apparatus 1.

RAM 57 as one example of a storage unit is a memory used to temporarily store process data that is generated during operation processes when operation processes accompanied by operation of CPU 21 are performed. For example, RAM 57 temporarily retains transaction settlement information (refer to the description provided later) and the like sent from additional apparatuses 2, 2a, and 2b.

FIG. 3 is a diagram illustrating one example of a hardware configuration of additional apparatus (slave device) 2 of the first exemplary embodiment. Additional apparatuses 2, 2a, and 2b illustrated in FIG. 1 have the same configuration. Hereinafter, additional apparatus 2 will be illustratively described. Additional apparatus 2 illustrated in FIG. 3 is configured to include CPU 22, magnet stripe card reader 24, contact IC card reader 26, non-contact IC card reader/writer 28, loop antenna 30, key-input 34, touch-input 36, display 38, wide-range wireless transceiver 50 to which wide-range wireless antenna 50A is connected, local-area wireless transceiver 52 to which local-area wireless antenna 52A is connected, flash ROM 56, RAM 58, battery BT, power supply 62, and PINPAD processor 64.

CPU 22 performs a control process to manage overall operation of each unit of additional apparatus 2, a data input and output process with other units, a data operation (calculation) process, and a data storing process. For example, CPU 22 performs each process in accordance with codes defined in the program according to the present invention and thereby instructs wide-range wireless transceiver 50 to send a settlement request including the transaction settlement information sent from transaction processing apparatus 1 to settlement relay center 5, in response to an instruction from transaction processing apparatus 1 in the offline state. Details of other operations of CPU 22 will be described later.

Magnet stripe card reader 24 is disposed inside of a slit (not illustrated) that is provided on a side surface side of the casing of additional apparatus 2, has a function of reading a magnet stripe provided on card (for example, an IC credit card) CrD, reads various types of information registered in card CrD from the read magnet stripe, and outputs the information to CPU 22. Magnet stripe card reader 24 may not be provided in additional apparatus 2.

Contact IC card reader 26 is disposed inside of a contact IC card insertion port (not illustrated) that is provided on a side surface of the casing of additional apparatus 2 (for example, on the lower left side of transaction processing apparatus 1 illustrated in FIG. 1), and reads or writes card information recorded in a chip (not illustrated) in a contact IC card through an electrode of the contact IC card (for example, card CrD) inserted in the insertion port. The card information read by contact IC card reader 26 is input into CPU 22. Contact IC card reader 26 may not be provided in additional apparatus 2.

Non-contact IC card reader/writer 28, for example, is connected to loop antenna 30 that is disposed approximately parallel to display 38 of additional apparatus 2, wirelessly communicates with card CrD (for example, an IC credit card) in a non-contact manner using predetermined short-range wireless communication (for example, NFC), and reads or writes the card information recorded in card CrD. The card information read by non-contact IC card reader/writer 28 is input into CPU 22. Non-contact IC card reader/writer 28 may not be provided in additional apparatus 2.

Key-input 34 is, for example, a software keyboard displayed on display 38 or a push-type button provided in the casing of additional apparatus 2 and, for example, is used in an input operation in which various types of information related to the card used in a settlement process (for example, a card brand) and various types of information required for a settlement process (for example, a method of payment and the number of payments) are input by the staff member when a settlement process is performed. Key-input 34 may be used when a holder of the card used in a settlement process inputs the PIN.

Touch-input 36 has a function of detecting a touch input on touch panel TP2 of additional apparatus 2.

Display 38 is configured by using, for example, an LCD or organic EL and has a function of controlling display of touch panel TP2 of additional apparatus 2. Touch-input 36 and display 38 constitute touch panel TP2 of additional apparatus 2 in the present exemplary embodiment.

Wide-range wireless transceiver 50 is connected to wide-range wireless antenna 50A and has a function of performing wireless communication using a wide-range wireless communication path (for example, a wide area network (WAN)) through mobile communication network NW3 or public switched telephone network NW4. Communication on the wide-range wireless communication path may be performed by using mobile communication such as W-CDMA, UMTS, CDMA 2000, and LTE.

Local-area wireless transceiver 52 is connected to local-area wireless antenna 52A and has a function of performing, for example, wireless LAN communication with transaction processing apparatus 1 provided in the store through a relay device such as layer 3 switch or router 9 provided in intranet NW1. Local-area wireless transceiver 52 may perform communication other than wireless LAN communication (for example, Bluetooth (registered trademark) communication).

Flash ROM 56 has a function of storing various types of data. The data stored may be, for example, program codes and data of an application used in a settlement process performed with settlement relay center 5 (settlement process application), program codes and data of applications related to various business operations (applications for each business operation), or other programs and data for controlling each unit of additional apparatus 2.

RAM 58 as one example of a storage unit is a memory used to temporarily store process data that is generated during operation processes when operation processes accompanied by operation of CPU 22 are performed. For example, RAM 58 temporarily retains the transaction settlement information (refer to the description provided later) and the like sent from transaction processing apparatus 1.

Battery BT is a rechargeable secondary battery. Electricity that is stored in battery BT is supplied to power supply 62.

Power supply 62 supplies electricity required for operation of each unit of additional apparatus 2 to each unit by using electricity supplied from battery BT.

PINPAD processor 64 is, for example, a software keyboard configured by displaying on display 38 a numeric keypad that is used when a purchaser of products inputs the PIN (password) as one example of authentication information. PINPAD processor 64 may not be provided in additional apparatus 2.

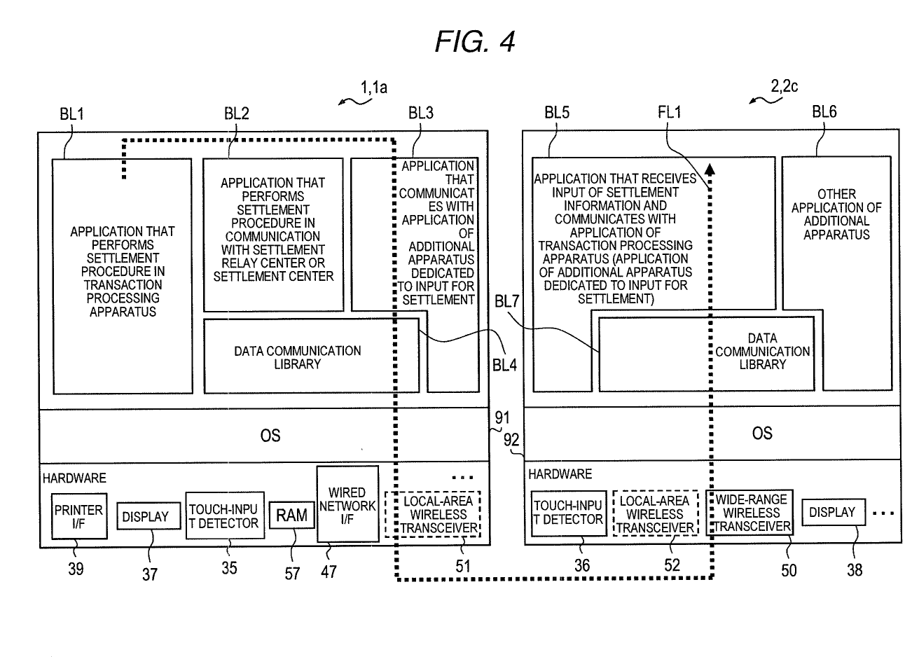

FIG. 4 is a diagram illustrating one example of a software block configuration of transaction processing apparatuses 1 and 1a and additional apparatuses 2 and 2c of each exemplary embodiment. In FIG. 4, only a part of each unit illustrated in FIG. 2 is illustrated as hardware of transaction processing apparatuses 1 and 1a, and not all of the hardware is illustrated. Similarly, only a part of each unit illustrated in FIG. 3 is illustrated as hardware of additional apparatuses 2 and 2c, and not all of the hardware is illustrated.

Transaction processing apparatuses 1 and 1a are operated by cooperation of one or more software modules (that is, components constituting an application) on operating software (OS) 91 that is base software, when an application installed in transaction processing apparatuses 1 and 1a is executed. In FIG. 4, the software modules include, for example, at least application BL1 that performs a settlement procedure in transaction processing apparatuses 1 and 1a, application BL2 that performs a settlement procedure in communication with settlement relay center 5 or settlement center 6, application BL3 that communicates with a dedicated settlement input application of additional apparatus 2, and data communication application BL4.

Additional apparatuses 2 and 2c are operated by cooperation of one or more software modules (that is, components constituting an application) on OS 92 that is base software, when an application installed in additional apparatuses 2 and 2c is executed. In FIG. 4, the software modules include, for example, at least application (the dedicated settlement input application of the additional apparatus) BL5 that receives input of settlement information and communicates with the application of transaction processing apparatuses 1 and 1a, and other application BL6 and data communication library BL7 of additional apparatus 2.

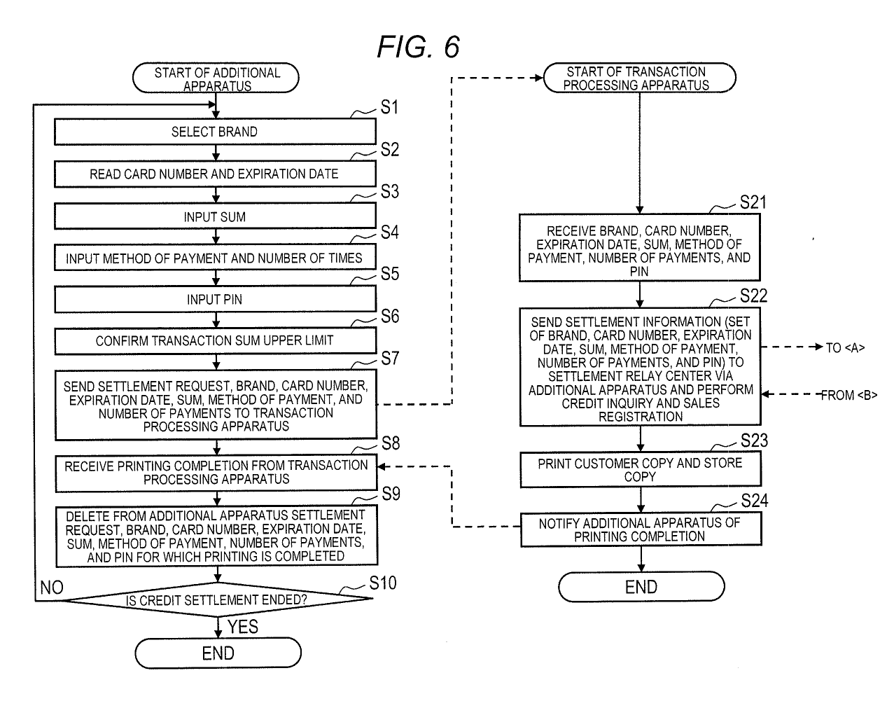

Transaction processing apparatus 1 cannot directly communicate with settlement relay center 5 in the offline state in the present exemplary embodiment. Thus, information required for settlement of a transaction (transaction settlement information) is input and read in, for example, additional apparatus 2 by instruction FL1 from transaction processing apparatus 1 (refer to FIG. 6 to FIG. 8). Additional apparatus 2 sends to settlement relay center 5 a settlement request that includes the transaction settlement information obtained by input and reading. The transaction settlement information is information required for settlement of a transaction and is information that includes, for example, information input in additional apparatus 2 (for example, brand information of card CrD, a transaction sum, a method of payment, the number of payments, and the PIN of the purchaser (customer)) and information including the card number and the expiration date of card CrD read in additional apparatus 2 (encrypted in card CrD).

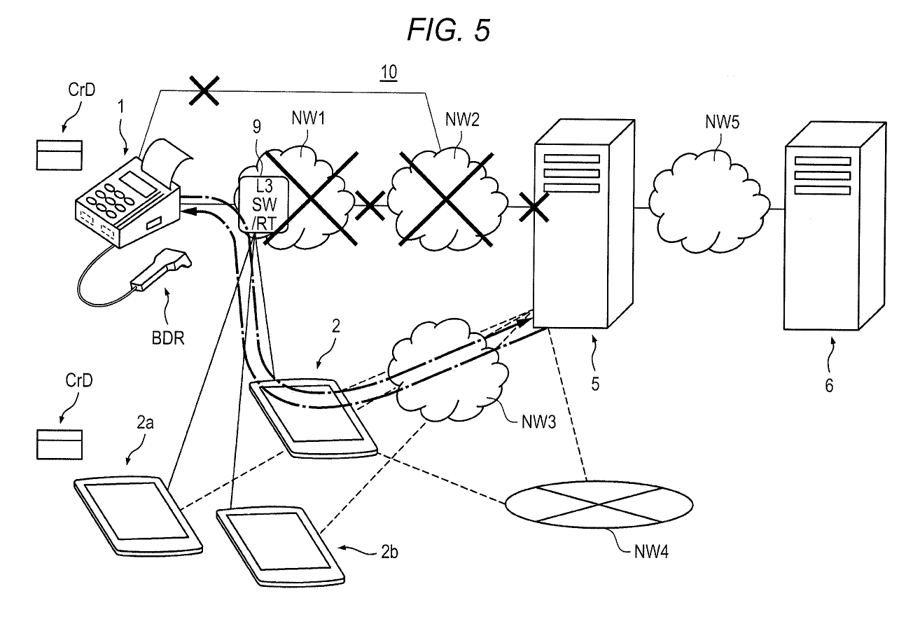

FIG. 5 is a diagram illustrating one example of a connection path of transaction processing apparatus 1, additional apparatuses 2, 2a, and 2b, and settlement center 6 in the offline state. In FIG. 5, if transaction processing apparatus 1 cannot communicate with settlement relay center 5 in a state where, for example, all of intranet NW1, Internet NW2, and an input port of settlement relay center 5 corresponding to Internet NW2 are unavailable, all of intranet NW1, Internet NW2, and the input port of settlement relay center 5 corresponding to Internet NW2 may be in a state of unavailability.

Transaction processing apparatus 1 cannot directly communicate with settlement relay center 5 in the offline state illustrated in FIG. 5 as described in detail in FIG. 6 to FIG. 9. Thus, transaction processing apparatus 1 instructs additional apparatuses 2, 2a, and 2b to send to settlement relay center 5 a settlement request that includes the transaction settlement information obtained by input and reading in transaction processing apparatus 1 or additional apparatuses 2, 2a, and 2b. Additional apparatus 2, in response to the instruction from transaction processing apparatus 1, sends to settlement relay center 5 a settlement request that includes the transaction settlement information obtained by input and reading in transaction processing apparatus 1 or additional apparatus 2, by using a wide-range wireless communication path (that is, mobile communication network NW3 or public switched telephone network NW4) that can be used by additional apparatus 2.

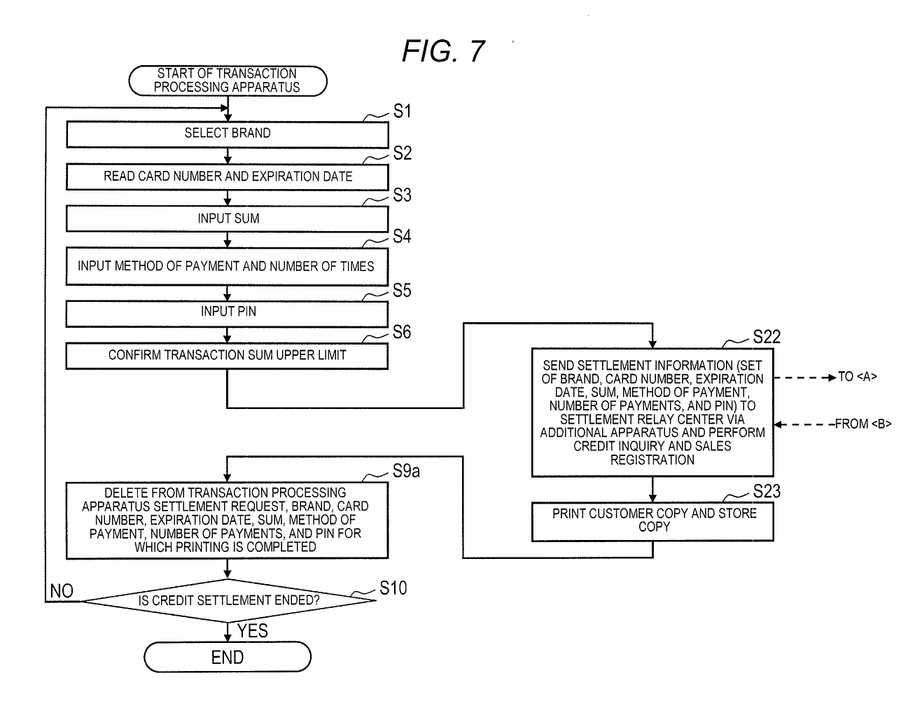

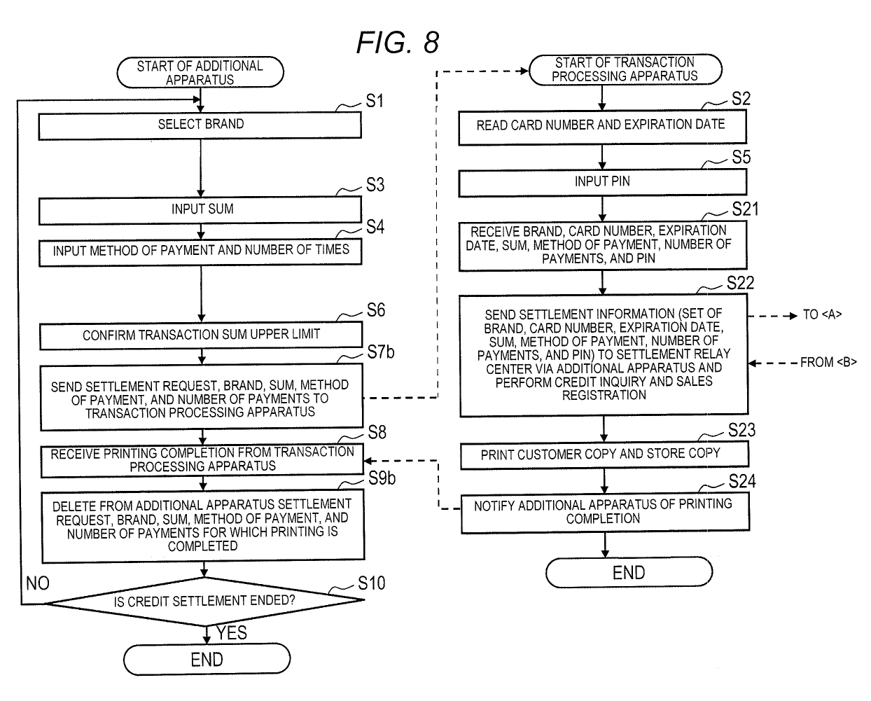

Next, details of operation procedures of transaction processing apparatus 1 and additional apparatus 2 of transaction processing system 10 of the present exemplary embodiment will be described with reference to FIG. 6 to FIG. 9. FIG. 6 is a flowchart describing a first example of the process flow of transaction processing apparatus 1 and additional apparatus 2 of the first exemplary embodiment in the offline state. FIG. 7 is a flowchart describing the first example of the process flow of transaction processing apparatus 1 and additional apparatus 2 of the first exemplary embodiment in the offline state. FIG. 8 is a flowchart describing the first example of the process flow of transaction processing apparatus 1 and additional apparatus 2 of the first exemplary embodiment in the offline state. The same process as in the description of FIG. 6 will be designated by the same step number in description of FIG. 7 and FIG. 8 and will be described in a simplified manner or will not be described.

In FIG. 6, transaction processing apparatus 1 in the offline state waits until the transaction settlement information obtained by input and reading in additional apparatus 2 is obtained.

First, CPU 22 of additional apparatus 2 displays on display 38 of touch panel TP2 a prompt (card scan prompt) that prompts the staff member to perform a reading operation on the card (for example, an IC credit card), in order to launch the settlement process application.

Then, the staff member of the store performs on touch panel TP2 an operation of inputting information related to a transaction content of a settlement process target, while asking the customer confirmation. CPU 22 detects the input operation through touch-input 36.

A card brand of a contact IC credit card or a non-contact IC credit card displayed on display 38 is selected by an input operation of the staff member using additional apparatus 2 after the prompt is displayed, and information related to the selected card brand is input into CPU 22 (S1).

Next, when the staff member performs a reading operation on the IC credit card held by the customer, contact IC card reader 26 or non-contact IC card reader/writer 28 reads information recorded in the contact IC credit card or the non-contact IC credit card (S2). As described above, the information read in Step S2 (that is, information including the card number and the expiration date) is encrypted in card CrD and cannot be decoded by CPU 22. CPU 22 displays on display 38 of touch panel TP2 an input screen for the transaction content of a settlement process target in the settlement process application when CPU 22 receives the encrypted information read by contact IC card reader 26 or non-contact IC card reader/writer 28.

Next, a transaction sum is input by an input operation of the staff member, and information related to the input transaction sum is input into CPU 21 (S3). Furthermore, a method of payment (for example, one-time payment and split payment) is selected, and the number of payments is input. Information related to the selected method of payment and the input number of payments is input into CPU 22 (S4).

Card CrD used in the present exemplary embodiment is a contact IC credit card or a non-contact IC credit card. Thus, after information including the method of payment and the number of payments is input in Step S4, the customer inputs the PIN (password) into PINPAD processor 64 (for example, a numeric keypad of “0” to “9”) that is displayed as a software keyboard on display 38 of touch panel TP2, in response to an instruction from the staff member (S5). Accordingly, the transaction settlement information in one transaction is obtained in additional apparatus 2.

CPU 22 determines whether or not the transaction sum input in Step S3 exceeds an offline state transaction sum upper limit that is defined in advance by the franchise contract between the acquirer or the issuer and the franchise (store) (S6). Information related to the transaction sum upper limit (for example, an upper limit of one transaction sum is 100,000 yen) is stored in, for example, CPU 22 or flash ROM 56 and may be appropriately updated in response to revision made to the franchise contract. CPU 22 sends a settlement request including the transaction settlement information (that is, the brand information, the card number, the expiration date, the transaction sum, the method of payment, the number of payments, and the PIN) to transaction processing apparatus 1 in a case where the transaction sum is determined not to exceed the transaction sum upper limit (S7). Then, additional apparatus 2 waits until a printing completion notification is received from transaction processing apparatus 1.

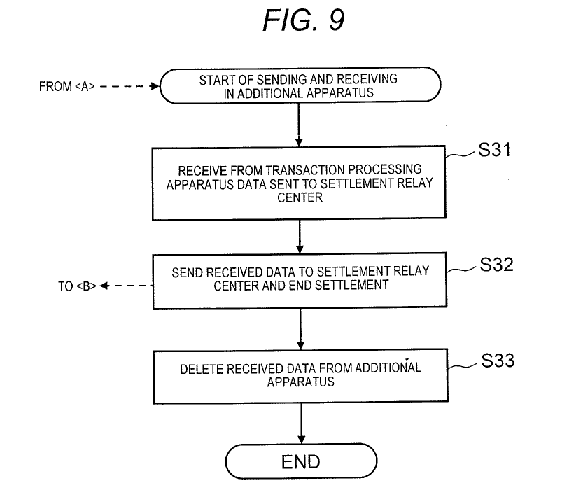

Transaction processing apparatus 1 receives the settlement request including the transaction settlement information sent in Step S7 (S21) and sends the settlement request including the transaction settlement information (in other words, each request for a credit inquiry process and a sales registration process in a case where credit is determined to be given) to settlement relay center 5 via additional apparatus 2 (S22). That is, in a sending and receiving process of additional apparatus 2 illustrated in FIG. 9, additional apparatus 2 receives the settlement request including the transaction settlement information sent from transaction processing apparatus 1 (that is, data sent to settlement relay center 5 by transaction processing apparatus 1) (S31) and sends the data received in Step S31 to settlement relay center 5 (S32). Settlement relay center 5 sends to settlement center 6 the data sent from additional apparatus 2, and in a case where settlement is normally ended in settlement center 6 (that is, in a case where a determination indicating no problem in the credit inquiry is made and sales registration is performed), settlement relay center 5 receives from settlement center 6 a response indicating the case, and responds (sends) to additional apparatus 2. Accordingly, additional apparatus 2 can receive a response indicating that settlement is normally ended, and sends the response indicating that settlement is normally ended to transaction processing apparatus 1 (S32). Then, additional apparatus 2 deletes data received in Step 31 (refer to the above description) (S33).

Transaction processing apparatus 1, in a case where transaction processing apparatus 1 receives from additional apparatus 2 a response indicating that settlement is normally ended, prints predetermined slip copies (for example, a customer copy and a store copy) that indicate that settlement is normally ended (S23), and generates and sends to additional apparatus 2 a printing completion notification that indicates that printing of the slip copies is completed (S24).

Additional apparatus 2 receives the printing completion notification for the slip copies sent from transaction processing apparatus 1 (S8). Additional apparatus 2 deletes the transaction settlement information (that is, the brand information, the card number, the expiration date, the transaction sum, the method of payment, the number of payments, and the PIN) related to the transaction printed on the slip copies after additional apparatus 2 receives the printing completion notification for the slip copies (S9). A return is made to the process of Step S1 if settlement of a transaction using card CrD (IC credit card) is continued (NO in S10). The flow illustrated in FIG. 6 is ended in a case where settlement of a transaction using card CrD (IC credit card) is not continued (YES in S10).

Next, in FIG. 7, the transaction settlement information is obtained by input and reading in transaction processing apparatus 1. Specifically, first, CPU 21 of transaction processing apparatus 1 displays on display 37 of touch panel TP a prompt (card scan prompt) that prompts the staff member to perform a reading operation on the card (for example, an IC credit card), in order to launch the settlement process application.

Then, the staff member of the store performs on touch panel TP an operation of inputting information related to a transaction content of a settlement process target, while asking the customer confirmation. CPU 21 detects the input operation through touch-input 35.

A card brand of a contact IC credit card or a non-contact IC credit card displayed on display 37 is selected by an input operation of the staff member using transaction processing apparatus 1 after the prompt is displayed, and information related to the selected card brand is input into CPU 21 (S1).

Next, when the staff member performs a reading operation on the IC credit card held by the customer, contact IC card reader/writer 25 or non-contact IC card reader/writer 27 reads information recorded in the contact IC credit card or the non-contact IC credit card (S2). As described above, the information read in Step S2 (that is, information including the card number and the expiration date) is encrypted in card CrD and cannot be decoded by CPU 21. CPU 21 displays on display 37 of touch panel TP an input screen for the transaction content of a settlement process target in the settlement process application when CPU 21 receives the encrypted information read by contact IC card reader/writer 25 or non-contact IC card reader/writer 27.

Next, a transaction sum is input by an input operation of the staff member, and information related to the input transaction sum is input into CPU 21 (S3). Furthermore, a method of payment (for example, one-time payment and split payment) is selected, and the number of payments is input. Information related to the selected method of payment and the input number of payments is input into CPU 22 (S4).

Card CrD used in the present exemplary embodiment is a contact IC credit card or a non-contact IC credit card. Thus, after information including the method of payment and the number of payments is input in Step S4, the customer inputs the PIN (password) into PINPAD 7 (for example, a numeric keypad of “0” to “9”) that is displayed as a software keyboard on display 37 of touch panel TP, in response to an instruction from the staff member (S5). Accordingly, the transaction settlement information in one transaction is obtained in transaction processing apparatus 1.

CPU 21 determines whether or not the transaction sum input in Step S3 exceeds the offline state transaction sum upper limit that is defined in advance by the franchise contract between the acquirer or the issuer and the franchise (store) (S6). Information related to the transaction sum upper limit (for example, an upper limit of one transaction sum is 100,000 yen) is stored in, for example, CPU 21 or flash ROM 55 and may be appropriately updated in response to revision made to the franchise contract. CPU 21 sends a settlement request (in other words, each request for a credit inquiry process and a sales registration process in a case where credit is determined to be given) including the transaction settlement information (that is, the brand information, the card number, the expiration date, the transaction sum, the method of payment, the number of payments, and the PIN) to settlement relay center 5 via additional apparatus 2 in a case where the transaction sum is determined not to exceed the transaction sum upper limit (S22).

Transaction processing apparatus 1, after Step S22, deletes the transaction settlement information (that is, the brand information, the card number, the expiration date, the transaction sum, the method of payment, the number of payments, and the PIN) related to the transaction printed on the slip copies after printing on the predetermined slip copies is completed (S9a). A return is made to the process of Step S1 if settlement of a transaction using card CrD (IC credit card) is continued (NO in S10). The flow illustrated in FIG. 7 is ended in a case where settlement of a transaction using card CrD (IC credit card) is not continued (YES in S10).

Next, in FIG. 8, the transaction settlement information is obtained by input and reading in transaction processing apparatus 1 and by input in additional apparatus 2. In other words, information related to the brand information of card CrD input in Step S1 illustrated in FIG. 6, the transaction sum input in Step S3, and the method of payment and the number of payments input in Step S4 is input into CPU 22 of additional apparatus 2.

First, when the staff member performs a reading operation on the IC credit card held by the customer, contact IC card reader/writer 25 or non-contact IC card reader/writer 27 in transaction processing apparatus 1 reads information recorded in the contact IC credit card or the non-contact IC credit card (S2). As described above, the information read in Step S2 (that is, information including the card number and the expiration date) is encrypted in card CrD and cannot be decoded by CPU 21. CPU 21 displays on display 37 of touch panel TP a screen for input of the PIN of the purchaser (customer) in the settlement process application when CPU 21 receives the encrypted information read by contact IC card reader/writer 25 or non-contact IC card reader/writer 27. The customer inputs the PIN (password) into PINPAD 7 (for example, a numeric keypad device of “0” to “9”) in response to an instruction from the staff member (S5).

CPU 22 in additional apparatus 2 determines whether or not the transaction sum input in Step S3 exceeds the offline state transaction sum upper limit that is defined in advance by the franchise contract between the acquirer or the issuer and the franchise (store) (S6). CPU 22 sends various types of input information (that is, the brand information, the transaction sum, the method of payment, and the number of payments) to transaction processing apparatus 1 in a case where the transaction sum is determined not to exceed the transaction sum upper limit (S7b). Then, additional apparatus 2 waits until a printing completion notification is received from transaction processing apparatus 1.

Transaction processing apparatus 1 receives various types of information (that is, information related to the transaction sum, the method of payment, and the number of payments) sent in Step S7b (S21). Accordingly, the transaction settlement information in one transaction is obtained in additional apparatus 2 along with the information obtained in Step S2 and Step S5.

The processes of Step S22 to Step S24 are the same as in FIG. 6 and thus will not be described. Additional apparatus 2 receives the printing completion notification for the slip copies sent from transaction processing apparatus 1 (S8). Additional apparatus 2 deletes a part of the transaction settlement information (that is, the brand information, the transaction sum, the method of payment, and the number of payments) related to the transaction printed on the slip copies after additional apparatus 2 receives the printing completion notification for the slip copies (S9b). A return is made to the process of Step S1 if settlement of a transaction using card CrD (IC credit card) is continued (NO in S10). The flow illustrated in FIG. 6 is ended in a case where settlement of a transaction using card CrD (IC credit card) is not continued (YES in S10).

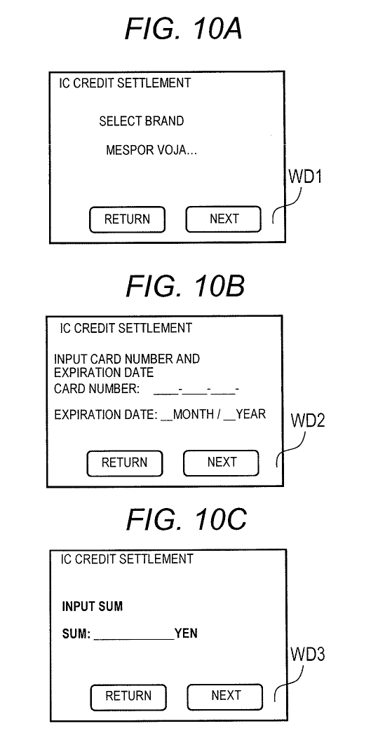

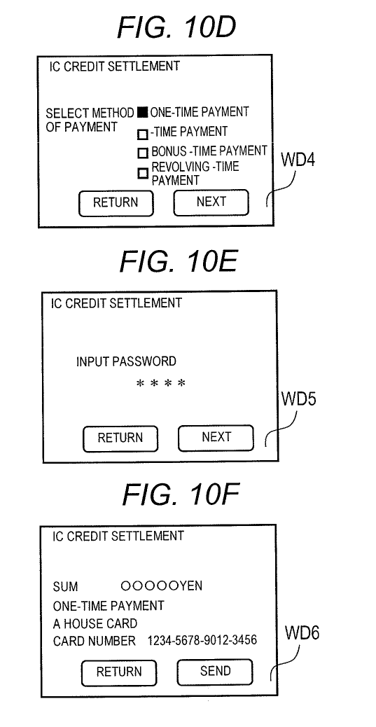

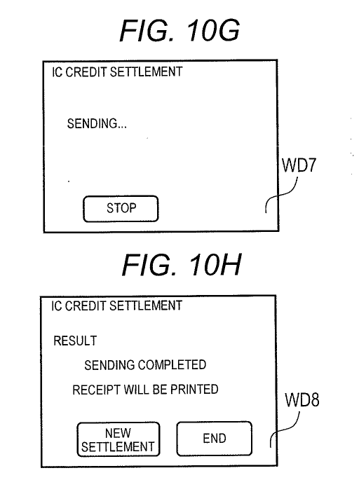

FIG. 10A to FIG. 10H are diagrams illustrating one example of various screens displayed on additional apparatus 2. While each screen illustrated in FIG. 10A to FIG. 10H will be described as being displayed on additional apparatus 2 for simplification of description, the screens may be displayed on transaction processing apparatus 1 as in the example illustrated in FIG. 7 or may be displayed on additional apparatus 2 or transaction processing apparatus 1 as in the example illustrated in FIG. 8. In this case, corresponding screens are displayed in corresponding processes illustrated in FIG. 7 or FIG. 8.

FIG. 10A is selection screen WD1 for the brand information of card CrD and is displayed on display 38 in Step S1 of FIG. 6. FIG. 10B is display screen WD2 for the card number and the expiration date of card CrD and is displayed on display 38 in Step S2 of FIG. 6. Since the card number and the expiration date cannot be decoded by additional apparatus 2 and transaction processing apparatus 1 and can be decoded in settlement relay center 5 in the present exemplary embodiment, the card number and the expiration date are displayed on the screen illustrated in FIG. 10B in an encrypted manner or with asterisks (*) so as not to be seen by a third person.

FIG. 10C is input screen WD3 for a transaction sum of a transaction using card CrD and is displayed on display 38 in Step S3 of FIG. 6. FIG. 10D is input screen WD4 for a method of payment and the number of payments and is displayed on display 38 in Step S4 of FIG. 6. FIG. 10E is input screen WD5 for the PIN and is displayed on display 38 in Step S5 of FIG. 6.

FIG. 10F is screen WD6 on which the transaction settlement information (a part thereof is illustrated) is displayed in transaction processing apparatus 1, and is displayed on display 37 in Step S22 of FIG. 6. FIG. 10G is screen WD7 that is displayed on each of displays 37 and 38 of transaction processing apparatus 1 and additional apparatus 2 when additional apparatus 2 sends a settlement request including the transaction settlement information to settlement relay center 5. FIG. 10H is display screen WD8 for a sending notification that indicates that a settlement request including the transaction settlement information is sent to settlement relay center 5.

In transaction processing system 10 of the present exemplary embodiment described heretofore, transaction processing apparatus 1 sends to additional apparatus 2 the transaction settlement information that includes the brand information of the IC credit card, the transaction sum, the method of payment, the number of payments, and the authentication information of the customer input by additional apparatus 2 and includes the card number and the expiration date read from the IC credit card, in a case where communication between transaction processing apparatus 1 and settlement relay center 5 is in a state of unavailability (offline state). Additional apparatus 2 sends a sending completion notification for a settlement request including the transaction settlement information to transaction processing apparatus 1 in a case where additional apparatus 2 sends to settlement relay center 5 a settlement request including the transaction settlement information sent from transaction processing apparatus 1. Transaction processing apparatus 1 prints predetermined slip copies (for example, a customer copy and a store copy related to settlement of a transaction using an IC credit card) in a case where transaction processing apparatus 1 receives the sending completion notification.

Accordingly, transaction processing system 10, in a settlement scheme in which information required for authentication of the IC credit card used in a settlement process is sent and received between the IC credit card and settlement relay center 5, smoothly performs settlement using the IC credit card by using additional apparatus 2 in communication between transaction processing apparatus 1 and settlement relay center 5 in the offline state including when a line to settlement relay center 5 is unavailable and when a failure occurs. Transaction processing system 10, in the offline state including when a line to settlement relay center 5 is unavailable and when a failure occurs, may not use settlement by the magnetic credit card function that uses information recorded in the magnet stripe of the IC credit card, or can use settlement by the IC credit card function. Thus, degradation of security of the authentication information of the customer can be prevented.

In transaction processing system 10, the brand information of the IC credit card, the transaction sum, the method of payment, the number of payments, the authentication information of the customer are input by additional apparatus 2. The card number and the expiration date of the IC credit card are read by additional apparatus 2 from the IC credit card. Transaction processing apparatus 1 sends a printing completion notification for predetermined slip copies to additional apparatus 2. Additional apparatus 2 deletes the brand information, the card number, and the expiration date of the IC credit card, the transaction sum, the method of payment, the number of payments, and the authentication information of the customer after additional apparatus 2 receives the printing completion notification.

Accordingly, transaction processing system 10 can temporarily use additional apparatus 2 as settlement means that replaces transaction processing apparatus 1 (that is, an input tool for input of the transaction settlement information and a wide-range wireless communication tool for communication with settlement relay center 5) in the offline state including when a line between transaction processing apparatus 1 and settlement relay center 5 is unavailable and when a failure occurs. Furthermore, a printing completion notification for predetermined slip copies that indicates that settlement of a transaction using the IC credit card is normally ended allows transaction processing system 10 to delete the transaction settlement information remaining in additional apparatus 2. Thus, security of personal information of a settlement target customer can be securely guaranteed when, for example, an application for general purposes other than settlement (for example, a mail application and a website browsing application) is used.

In transaction processing system 10, the brand information of the IC credit card, the transaction sum, the method of payment, the number of payments, and the authentication information of the customer are input by transaction processing apparatus 1. The card number and the expiration date of the IC credit card are read by transaction processing apparatus 1 from the IC credit card. Transaction processing apparatus 1 deletes the brand information, the card number, and the expiration date of the IC credit card, the transaction sum, the method of payment, the number of payments, and the authentication information of the customer after transaction processing apparatus 1 prints predetermined slip copies.

Accordingly, transaction processing system 10 can temporarily use additional apparatus 2 as settlement means that replaces transaction processing apparatus 1 (that is, a wide-range wireless communication tool for communication with settlement relay center 5) in the offline state including when a line between transaction processing apparatus 1 and settlement relay center 5 is unavailable and when a failure occurs. Furthermore, a printing completion notification for predetermined slip copies that indicates that settlement of a transaction using the IC credit card is normally ended allows transaction processing system 10 to delete the transaction settlement information remaining in transaction processing apparatus 1. Thus, security of personal information of a settlement target customer can be securely guaranteed.

In transaction processing system 10, the brand information of the IC credit card, the transaction sum, the method of payment, and the number of payments are input by additional apparatus 2. The authentication information of the customer is input by transaction processing apparatus 1. The card number and the expiration date of the IC credit card are read by transaction processing apparatus 1 from the IC credit card. Transaction processing apparatus 1 sends a printing completion notification for predetermined slip copies to additional apparatus 2. Additional apparatus 2 deletes the brand information of the IC credit card, the transaction sum, the method of payment, and the number of payments after additional apparatus 2 receives the printing completion notification.

Accordingly, transaction processing system 10 can temporarily use additional apparatus 2 as settlement means that replaces transaction processing apparatus 1 (that is, an input tool for input of a part of the transaction settlement information and a wide-range wireless communication tool for communication with settlement relay center 5) in the offline state including when a line between transaction processing apparatus 1 and settlement relay center 5 is unavailable and when a failure occurs. Furthermore, a printing completion notification for predetermined slip copies that indicates that settlement of a transaction using the IC credit card is normally ended allows transaction processing system 10 to delete the transaction settlement information remaining in additional apparatus 2. Thus, security of personal information of a settlement target customer can be securely guaranteed when, for example, an application for general purposes other than settlement (for example, a mail application and a website browsing application) is used.

Transaction processing apparatus 1 of the present exemplary embodiment sends the transaction settlement information including the brand information, the card number, and the expiration date of the IC credit card, the transaction sum, the method of payment, the number of payments, and the authentication information of the customer to additional apparatus 2 in a case where communication between transaction processing apparatus 1 and settlement relay center 5 is in a state of unavailability (offline state), and prints predetermined slip copies (for example, a customer copy and a store copy related to settlement of a transaction using the IC credit card) in response to a sending completion notification for a settlement request including the transaction settlement information from additional apparatus 2 in a case where additional apparatus 2 sends a settlement request including the transaction settlement information to settlement relay center 5.

Accordingly, transaction processing apparatus 1, in a settlement scheme in which information required for authentication of the IC credit card is sent and received between the IC credit card and settlement relay center 5, has a simple thin client type apparatus configuration and smoothly performs settlement using the IC credit card by using additional apparatus 2 in communication between transaction processing apparatus 1 and settlement relay center 5 in the offline state including when a line to settlement relay center 5 is unavailable and when a failure occurs.

Additional apparatus 2 of the present exemplary embodiment, in a case where communication between transaction processing apparatus 1 and settlement relay center 5 is in a state of unavailability (offline state), sends to transaction processing apparatus 1 the transaction settlement information that includes the brand information of the IC credit card, the transaction sum, the method of payment, the number of payments, the authentication information of the customer, and the card number and the expiration date of the IC credit card. Additional apparatus 2 sends a settlement request including the transaction settlement information to settlement relay center 5 by using wide-range wireless communication between additional apparatus 2 and settlement relay center 5 and sends a sending completion notification for the settlement request including the transaction settlement information to transaction processing apparatus 1 in response to an instruction from transaction processing apparatus 1.

Accordingly, additional apparatus 2 not only can use an application for general purposes other than settlement (for example, a mail application and a website browsing application) but also can be temporarily used as settlement means (that is, an input tool for input of the transaction settlement information and a wide-range wireless communication tool for communication with settlement relay center 5) that replaces transaction processing apparatus 1 related to settlement of a transaction using the IC credit card.

### Background of Second Exemplary Embodiment

### Second Exemplary Embodiment

Next, the background of a transaction processing system of a second exemplary embodiment will be simply described before an example of the transaction processing system of the second exemplary embodiment is described. Settlement processes may not be sufficiently processed by only the transaction processing apparatus provided in advance in the store when the store is crowded (for example, in a case where purchasers are temporarily increased at a weekend and the like and in a case where purchasers are suddenly increased due to some campaign or limited time sales service hosted by the store). In that case, purchasers form a long line in the store, and purchasers wait for a long amount of time. Thus, convenience of use for purchasers is decreased.

Therefore, the second exemplary embodiment will be described in an example of transaction processing system 10A that can smoothly perform settlement using an IC credit card and can avoid an increase in a wait time of a customer for card settlement by using additional apparatus 2 in communication between transaction processing apparatus 1 and settlement relay center 5 in a case where the number of transaction processing apparatuses 1a provided in a store is not sufficient enough to process card settlement for visitors (customers).

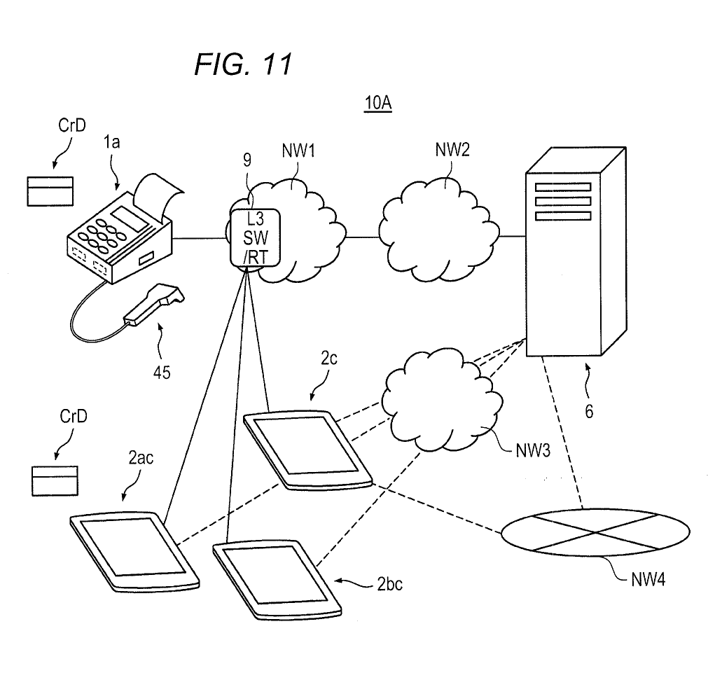

FIG. 11 is a diagram illustrating one example of a system configuration of transaction processing system 10A of the second exemplary embodiment. The same description as transaction processing system 10 illustrated in FIG. 1 in the first exemplary embodiment will be simplified or will not be provided in description of FIG. 11, and different contents will be described. In transaction processing system 10A illustrated in FIG. 11, transaction processing apparatus 1a of a thin client to which symbol reader 45 (refer to FIG. 2) is connected and settlement center 6 as one example of a predetermined settlement-side apparatus are connected through a network (intranet NW1 and Internet NW2), and transaction processing apparatus 1a and additional apparatuses 2c, 2ca, and 2cb of portable types are connected through layer 3 switch or router (L3SW/RT) 9 that is provided in intranet NW1. Additional apparatuses 2c, 2ca, and 2cb and settlement center 6 are connected through mobile communication network NW3 or public switched telephone network NW4. Transaction processing apparatus 1 and symbol reader 45 are connected by, for example, a cable in a wired manner.

Transaction processing apparatus 1a is a settlement terminal apparatus of a thin client type in which information including various items related to a transaction settlement process using card CrD (refer to transaction settlement information described later) is input by a user (for example, a staff member of the store or a customer) into touch panel TP and that reads a card number and an expiration date of card CrD. The card number and the expiration date read may be encrypted in card CrD or not encrypted in the present exemplary embodiment.

Additional apparatuses 2c, 2ca, and 2cb are communication terminals (for example, smartphones or tablet terminals) that include transportable casings of portable types and can perform wired or wireless data communication, and are connected to transaction processing apparatus 1a through layer 3 switch or router 9. Additional apparatuses 2c, 2ca, and 2cb may communicate with settlement center 6 through mobile communication network NW3 or public switched telephone network NW4 regarding a transaction settlement process in response to an instruction from transaction processing apparatus 1a. A specific configuration of additional apparatuses 2, 2a, and 2b is described with reference to FIG. 3.

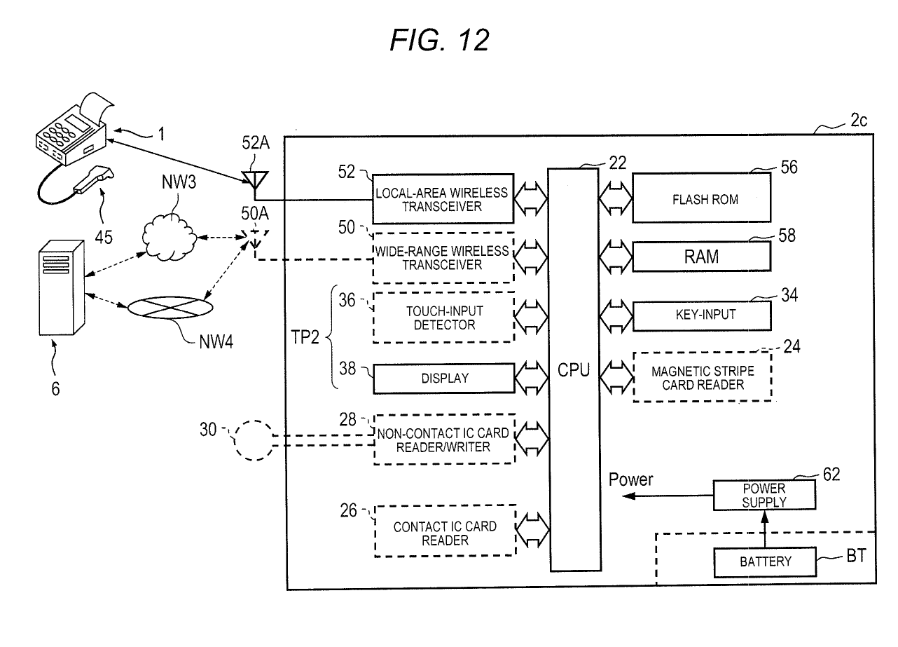

FIG. 12 is a diagram illustrating one example of a hardware configuration of additional apparatuses (slave device) 2c, 2ca, and 2cb of the second exemplary embodiment. Additional apparatuses 2c, 2ca, and 2cb illustrated in FIG. 12 have the same configuration. Hereinafter, additional apparatus 2c will be illustratively described. Additional apparatus 2c illustrated in FIG. 12 has a configuration obtained by removing PINPAD processor 64 from additional apparatus 2 illustrated in FIG. 3, and other configurations are the same as additional apparatus 2. Thus, a detailed description will not be provided. The difference from additional apparatus 2 in the first exemplary embodiment is that additional apparatus 2c of the present exemplary embodiment can communicate with settlement center 6.

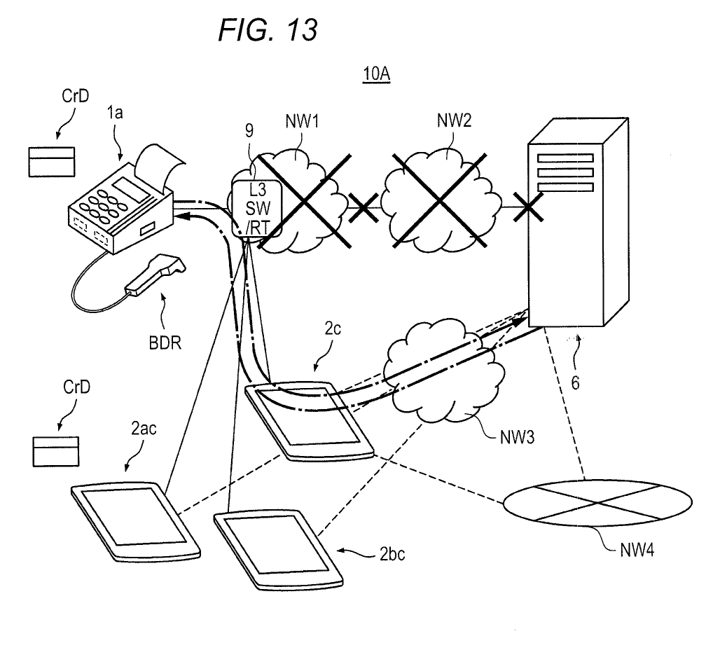

FIG. 13 is a diagram illustrating one example of a connection path of transaction processing apparatus 1a, additional apparatuses 2c, 2ca, and 2cb, and settlement center 6 in the offline state. A duplicate content of the description of FIG. 5 will be described in a simplified manner or will not be described in description of FIG. 13, and different contents will be described. In FIG. 13, if transaction processing apparatus 1a cannot communicate with settlement center 6 in a state where, for example, all of intranet NW1, Internet NW2, and an input port of settlement center 6 corresponding to Internet NW2 are unavailable, all of intranet NW1, Internet NW2, and the input port of settlement center 6 corresponding to Internet NW2 may be in a state of unavailability.

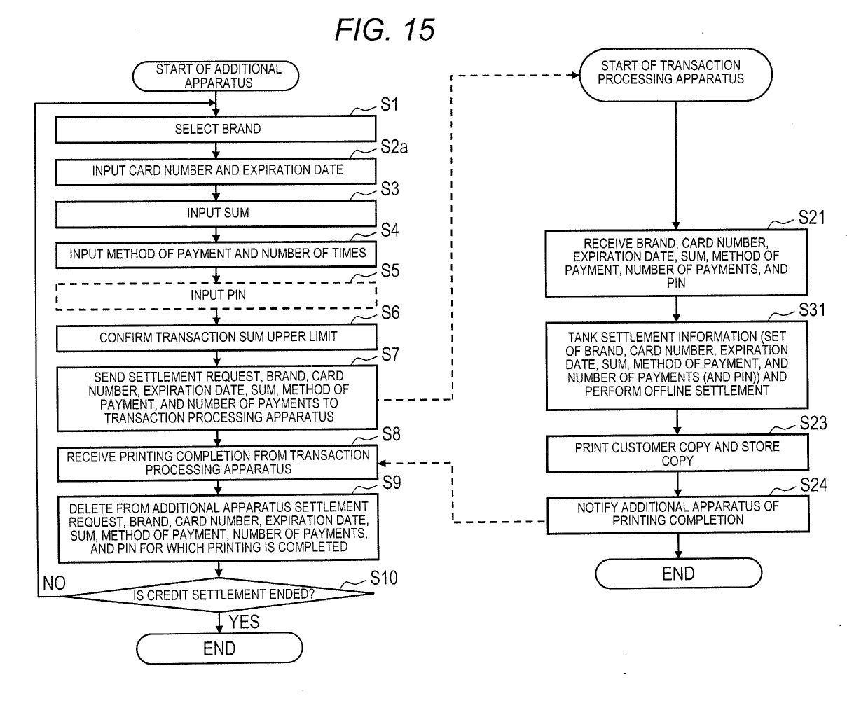

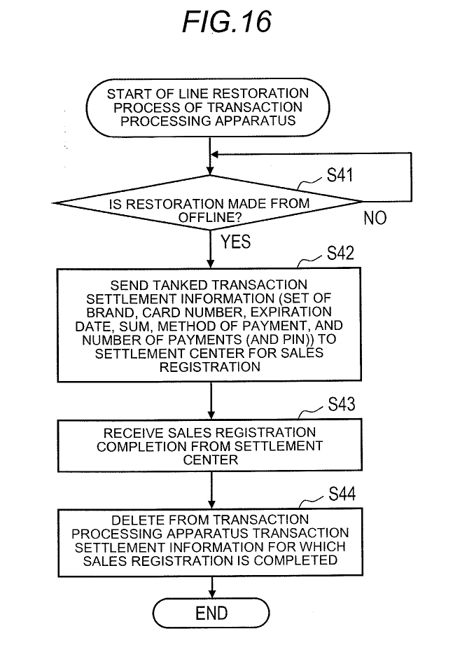

In the offline state illustrated in FIG. 13, as described in detail in FIG. 15 and FIG. 16, transaction processing apparatus 1a cannot directly communicate with settlement center 6, and transaction processing apparatus 1a accumulates (tanking), in the transaction processing apparatus 1a, transaction settlement information (the same as the transaction settlement information of the first exemplary embodiment) that is input in additional apparatuses 2c, 2ca, and 2cb, and prints predetermined slip copies (that is, a customer copy and a store copy) after conditional settlement using the transaction settlement information (that is, offline settlement) is performed between transaction processing apparatus 1a and card CrD.

Transaction processing apparatus 1a, in the offline state illustrated in FIG. 13, may instruct additional apparatuses 2c, 2ca, and 2cb to send to settlement center 6 a settlement request that includes the transaction settlement information obtained by input in additional apparatuses 2c, 2ca, and 2cb. In this case, additional apparatuses 2c, 2ca, and 2cb, in response to the instruction from transaction processing apparatus 1a, sends to settlement center 6 a settlement request that includes the transaction settlement information obtained by input in additional apparatuses 2c, 2ca, and 2cb, by using a wide-range wireless communication path (that is, mobile communication network NW3 or public switched telephone network NW4) that can be used by additional apparatuses 2c, 2ca, and 2cb.

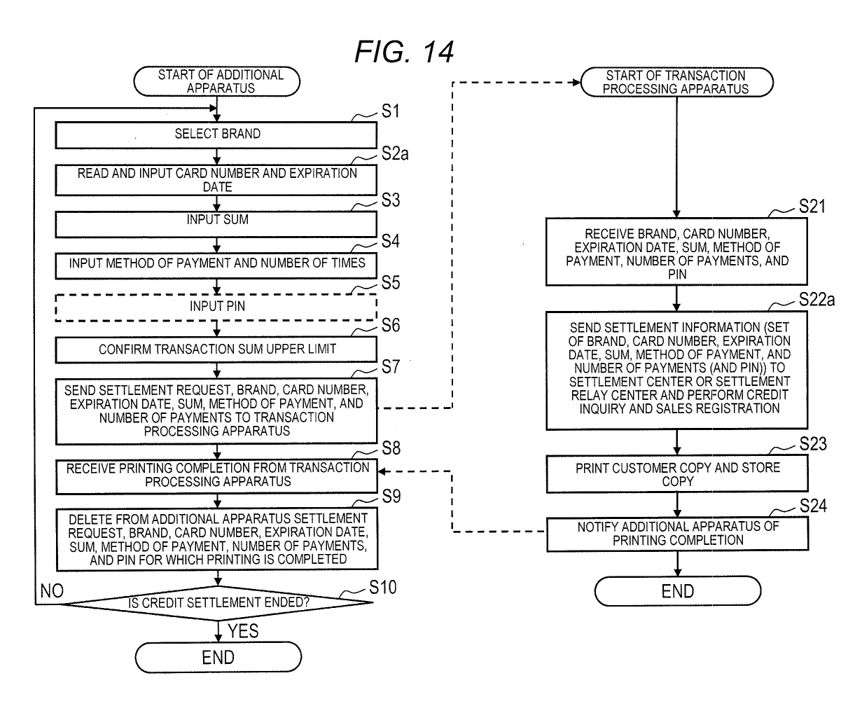

Next, details of operation procedures of transaction processing apparatus 1a and additional apparatus 2c of transaction processing system 10A of the present exemplary embodiment will be described with reference to FIG. 14 to FIG. 16. FIG. 14 is a flowchart describing one example of the process flow of transaction processing apparatus 1a and additional apparatus 2c of the second exemplary embodiment in a typical online state. FIG. 15 is a flowchart describing one example of the process flow of transaction processing apparatus 1a and additional apparatus 2c of the second exemplary embodiment in the offline state. FIG. 16 is a flowchart illustrating one example of the process flow of transaction processing apparatus 1a of the second exemplary embodiment in a case where restoration to the typical online state is made. A duplicate content of the description of FIG. 6 corresponding to the first exemplary embodiment will be described in a simplified manner or will not be described in description of FIG. 14. A duplicate content of the description of FIG. 14 will be described in a simplified manner or will not be described in description of FIG. 15. Different contents will be described.

In FIG. 14, transaction processing apparatus 1a in the typical online state waits until the transaction settlement information obtained by input in additional apparatus 2c is obtained.

In additional apparatus 2c, after Step S1, when the staff member performs a reading operation on the IC credit card held by the customer, contact IC card reader 26 or non-contact IC card reader/writer 28 reads information recorded in the contact IC credit card or the non-contact IC credit card and inputs the information into CPU 22 (S2a). The information that is read in Step S2 in the same manner as the first exemplary embodiment (that is, information including the card number and the expiration date) is encrypted in card CrD in Step S2 and may not be decoded or may be decoded by CPU 22. The input of the PIN in Step S5 in FIG. 14 is omitted in a case where a magnetic credit card is used and where a contact IC credit card or a non-contact IC credit card is not used.

CPU 22 sends a settlement request including the transaction settlement information (that is, the brand information, the card number, the expiration date, the transaction sum, the method of payment, and the number of payments) to transaction processing apparatus 1a in a case where the transaction sum is determined not to exceed the transaction sum upper limit in Step S6 (S7). The transaction settlement information includes the PIN in a case where the PIN is input in Step S5. In that case, the PIN as well is sent to transaction processing apparatus 1a. Then, additional apparatus 2c waits until a printing completion notification is received from transaction processing apparatus 1a.

Transaction processing apparatus 1a, in a tanking process of transaction processing apparatus 1a illustrated in FIG. 15, receives the settlement request including the transaction settlement information in Step S21 (S21) and sends the settlement request including the transaction settlement information (in other words, each request for a credit inquiry process and a sales registration process in a case where credit is determined to be given) to settlement center 6 (S22a). Accordingly, a sales registration process is performed in a case where a determination indicating no problem in the credit inquiry is made, and settlement center 6 sends to transaction processing apparatus 1a a response indicating that sales registration is performed.

Transaction processing apparatus 1a, in a case where transaction processing apparatus 1a receives from settlement center 6 a response indicating that sales registration is performed, prints predetermined slip copies (for example, a customer copy and a store copy) that indicate that sales registration is performed (S23), and generates and sends to additional apparatus 2 a printing completion notification that indicates that printing of the slip copies is completed (S24). Transaction processing apparatus 1a prints a signature slip as well in Step S24 in order for the customer to write a signature thereon in a case where a magnetic credit card is used.

Operation of additional apparatus 2c is the same as in FIG. 6 after a printing completion notification for the slip copies is sent from transaction processing apparatus 1a, and thus will not be described.

Next, in FIG. 15, transaction processing apparatus 1a in the offline state as well waits until the transaction settlement information obtained by input in additional apparatus 2c is obtained.

Each of the processes including a process of inputting each information of the transaction settlement information in additional apparatus 2c (Step S1 to Step S5), a determination as to whether or not the transaction sum exceeds the transaction sum upper limit in Step S6, and sending of a settlement request including the transaction settlement information in Step S7 is the same as in FIG. 14 and thus will not be described.

Transaction processing apparatus 1a receives a settlement request including the transaction settlement information in Step S21 (S21). Since transaction processing apparatus 1a is in the offline state, transaction processing apparatus 1a tanks the transaction settlement information included in the settlement request sent from additional apparatus 2c (S31) and performs conditional settlement (that is, offline settlement) using the transaction settlement information between transaction processing apparatus 1a and card CrD (S31). The processes of transaction processing apparatus 1a and additional apparatus 2c after Step S31 are the same as Step S23 and the subsequent process in FIG. 14 and thus will not be described.

In a line restoration process of transaction processing apparatus 1a illustrated in FIG. 16, transaction processing apparatus 1a sends a settlement request including the transaction settlement information (that is, the brand information, the card number, the expiration date, the transaction sum, the method of payment, and the number of payments (furthermore, the PIN if necessary)) tanked in Step S31 to settlement center 6 for sales registration (S42) in a case where restoration is made from the offline state to the typical online state (YES in S41).

Transaction processing apparatus 1a receives from settlement center 6 a response indicating that sales registration is performed, in a case where sales registration is performed in settlement center 6 (S43). Transaction processing apparatus 1a deletes the transaction settlement information for which sales registration is completed, when transaction processing apparatus 1a receives a response indicating that sales registration is performed (S44).

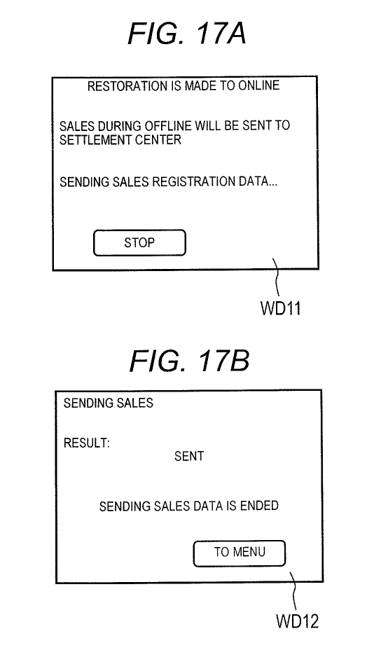

FIG. 17A and FIG. 17B are diagrams illustrating one example of various screens displayed on transaction processing apparatus 1a in a case where restoration to the typical online state is made. FIG. 17A is screen WD11 that is displayed on display 37 while transaction processing apparatus 1a sends a settlement request including the transaction settlement information tanked in the offline state to settlement center 6 after restoration is made from the offline state to the typical online state. FIG. 17B is screen WD12 that is displayed on display 37 when the settlement request including the tanked transaction settlement information is sent to settlement center 6.

In transaction processing system 10A of the present exemplary embodiment described heretofore, additional apparatus 2c sends to transaction processing apparatus 1a the transaction settlement information that includes the input brand information, the card number, and the expiration date of the card (for example, an IC credit card), the transaction sum, the method of payment, and the number of payments, and transaction processing apparatus 1a receives the transaction settlement information sent from additional apparatus 2c and sends a settlement request including the received transaction settlement information to settlement center 6. Transaction processing apparatus 1a prints predetermined slip copies in a case where transaction processing apparatus 1a sends the settlement request including the transaction settlement information to settlement center 6.

Accordingly, transaction processing system 10A can smoothly perform settlement using the IC credit card and can avoid an increase in the wait time of the customer for card settlement by using additional apparatus 2 in communication between transaction processing apparatus 1 and settlement relay center 5 in a case where the number of transaction processing apparatuses 1a provided in a store is not sufficient enough to process card settlement for visitors (customers). Therefore, transaction processing system 10A can effectively prevent a decrease in sales opportunities for customers and can reduce a decrease in sales of the store and a decrease in income based on the commission of the acquirer.

In transaction processing system 10A, transaction processing apparatus 1a sends a printing completion notification for predetermined slip copies to additional apparatus 2c, and additional apparatus 2c deletes the brand information, the card number, and the expiration date of the card, the transaction sum, the method of payment, and the number of payments after additional apparatus 2c receives the printing completion notification.

Accordingly, a printing completion notification for predetermined slip copies that indicates that settlement of a transaction using the card is normally ended allows transaction processing system 10A to delete the transaction settlement information remaining in additional apparatus 2. Thus, security of personal information of a settlement target customer can be securely guaranteed when, for example, an application for general purposes other than settlement (for example, a mail application and a website browsing application) is used.

In transaction processing system 10A, transaction processing apparatus 1a accumulates the transaction settlement information in transaction processing apparatus 1a in a case where communication between transaction processing apparatus 1a and settlement center 6 is in a state of unavailability, and prints predetermined slip copies after conditional settlement (that is offline settlement) using the transaction settlement information is performed between transaction processing apparatus 1a and the card.

Accordingly, transaction processing system 10A performs a settlement process in the offline state including when a line between transaction processing apparatus 1a and settlement center 6 is unavailable and when a failure occurs, by performing offline settlement between transaction processing apparatus 1a and the card.

In transaction processing system 10A, transaction processing apparatus 1a requests settlement center 6 to perform sales registration for conditional settlement (that is, offline settlement) using the accumulated transaction settlement information in a case where communication between transaction processing apparatus 1a and settlement center 6 is restored to the online state.

Accordingly, transaction processing system 10A can perform, in settlement center 6, a sales registration process for offline settlement performed in the offline state, in a case where communication between transaction processing apparatus 1a and settlement center 6 is restored to the online state.

Transaction processing apparatus 1a of the present exemplary embodiment obtains the transaction settlement information including the brand information, the card number, and the expiration date of the card, the transaction sum, the method of payment, and the number of payments input by additional apparatus 2c of a portable type, and sends a settlement request including the obtained transaction settlement information to settlement center 6 to which connection is made for settlement of a transaction using the card. Transaction processing apparatus 1a prints predetermined slip copies in a case where the settlement request including the transaction settlement information is sent to settlement center 6.

Accordingly, using additional apparatus 2 in communication between transaction processing apparatus 1a and settlement center 6 allows transaction processing apparatus 1a to smoothly perform settlement using the IC credit card, to print predetermined slip copies indicating that settlement is normally ended, and to avoid an increase in the wait time of the customer for card settlement, in a case where the number of transaction processing apparatuses 1a provided in the store is not sufficient enough to process card settlement for visitors (customers).

Additional apparatus 2c of the present exemplary embodiment sends the transaction settlement information including the brand information, the card number, and the expiration date of the card, the transaction sum, the method of payment, and the number of payments to transaction processing apparatus 1a and receives a printing completion notification for predetermined slip copies printed by transaction processing apparatus 1a in a case where a settlement request including the transaction settlement information is sent from transaction processing apparatus 1a to settlement center 6.

Accordingly, additional apparatus 2c not only can use an application for general purposes other than settlement (for example, a mail application and a website browsing application) but also can be temporarily used as settlement means (that is, an input tool for input of the transaction settlement information and a wide-range wireless communication tool for communication with settlement center 6) that replaces transaction processing apparatus 1a related to settlement of a transaction using the card (for example, an IC credit card).

### Background of Third Exemplary Embodiment

Next, the background of a transaction processing system of a third exemplary embodiment will be simply described before an example of the transaction processing system of the third exemplary embodiment is described. In the first exemplary embodiment described above, additional apparatus 2 displays an input screen (for example, refer to FIG. 10A to FIG. 10H) for the transaction settlement information that is generated by settlement relay center 5 using a script and the like, and sends to transaction processing apparatus 1 of a thin client a settlement request that includes the transaction settlement information input by the staff member or the customer. Therefore, input processes on the input screen for the transaction settlement information are continuously performed in additional apparatus 2 by input processes by the staff member or the customer. However, transaction processing apparatus 1 or additional apparatus 2, in a case where the input screen for the transaction settlement information (hereinafter, simply referred to as “settlement information) is not described in such a manner that a procedure of “input prompt-input-input confirmation screen” can be performed a plurality of times in one page, for example, in a case where such a continuous input process is not described by using a script language such as JavaScript (registered trademark) or a software component such as ActiveX (registered trademark) (hereinafter, referred to as a case where the input screen is not generated in a script format and the like), requests and obtains the input screen for the settlement information from settlement relay center 5 in each input process for the settlement information and is required to supply the input screen in input processes by the customer or the staff member.

Therefore, hereinafter, the third exemplary embodiment will be described in an example of transaction processing system 10 in which transaction processing apparatus 1 or additional apparatus 2 requests and obtains the input screen for the settlement information from settlement relay center 5 and causes the customer or the staff to provide input in each input process for the settlement information in a case where the input screen for the settlement information in the first exemplary embodiment is not generated in a script format and the like.

### Third Exemplary Embodiment

A system configuration example of transaction processing system 10 of the third exemplary embodiment is the same as the system configuration example of transaction processing system 10 of the first exemplary embodiment. Thus, the same configurations will be designated by the same reference signs and will not be described, and different contents will be described. An internal configuration of transaction processing apparatus 1 and additional apparatuses 2, 2a, and 2b of the present exemplary embodiment is the same as the internal configuration of transaction processing apparatus 1 illustrated in FIG. 2 and additional apparatus 2 illustrated in FIG. 3 and thus will not be described in detail.

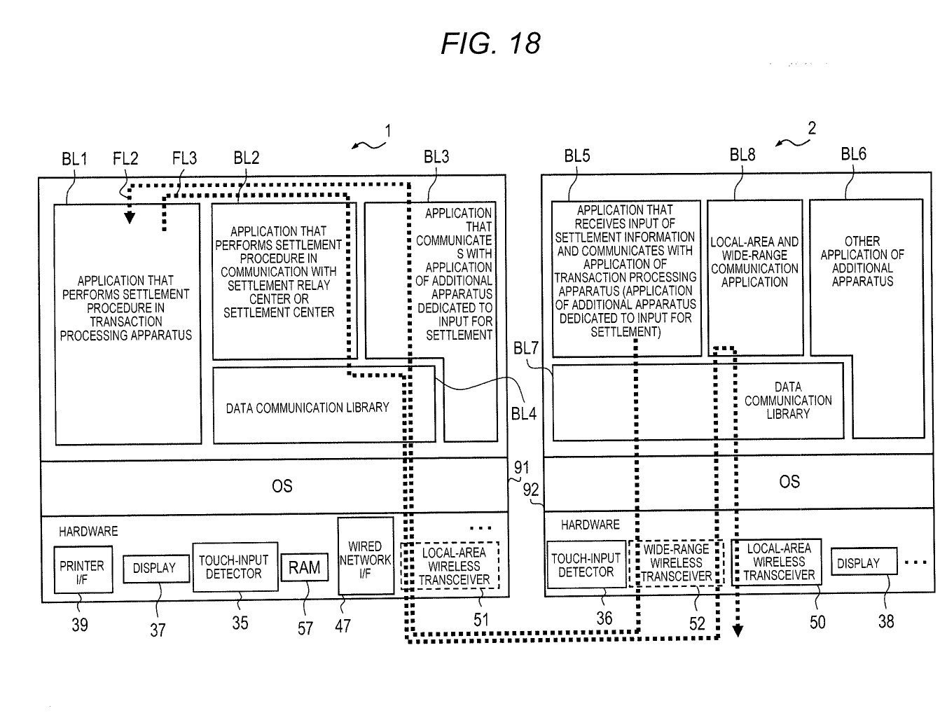

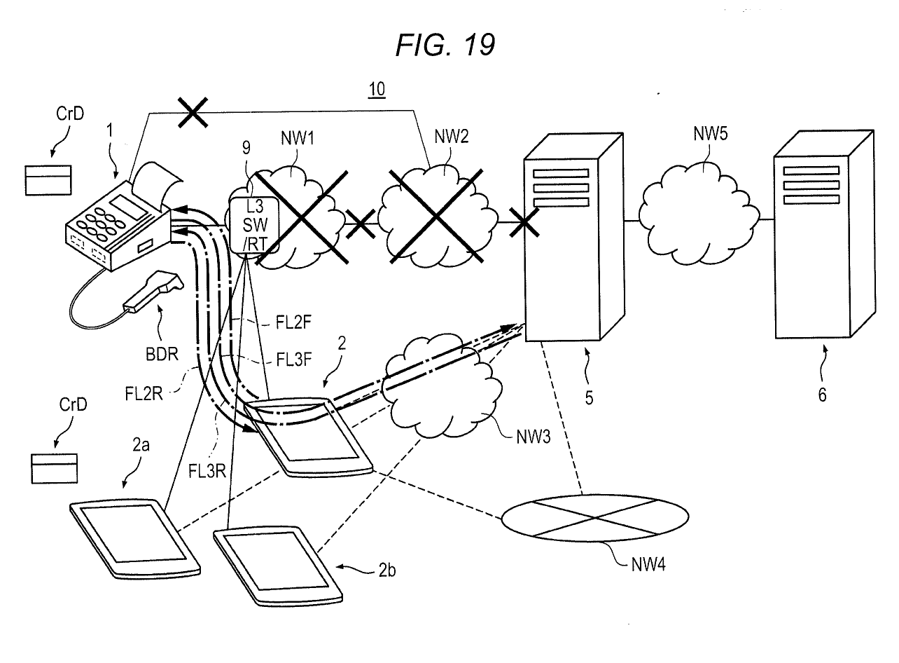

FIG. 18 is a diagram illustrating one example of a software block configuration of transaction processing apparatus 1 and additional apparatus 2 of the third exemplary embodiment. FIG. 19 is a diagram illustrating one example of a connection path of transaction processing apparatus 1, additional apparatus 2, and settlement relay center 5 in the offline state. FIG. 18 illustrates the flow of a process (instructions FL2 and FL3) between transaction processing apparatus 1 and settlement relay center 5 through additional apparatus 2 in the offline state illustrated in FIG. 19.

In FIG. 18, only a part of each unit illustrated in FIG. 2 is illustrated as hardware of transaction processing apparatus 1, and not all of the hardware is illustrated. Similarly, only a part of each unit illustrated in FIG. 3 is illustrated as hardware of additional apparatus 2, and not all of the hardware is illustrated. Furthermore, the same content as in the description of FIG. 4 will not be described in description of FIG. 18, and different contents will be described.

In FIG. 18, additional apparatus 2 is operated by cooperation of one or more software modules (that is, components constituting an application) on OS 92 that is base software, when an application installed in additional apparatus 2 is executed. In FIG. 18, the software modules include, for example, at least application (the dedicated settlement input application of additional apparatus 2) BL5 that receives input of settlement information and communicates with the application of transaction processing apparatus 1, and other application BL6, data communication library BL7, and local-area and wide-range communication application BL8 of additional apparatus 2.

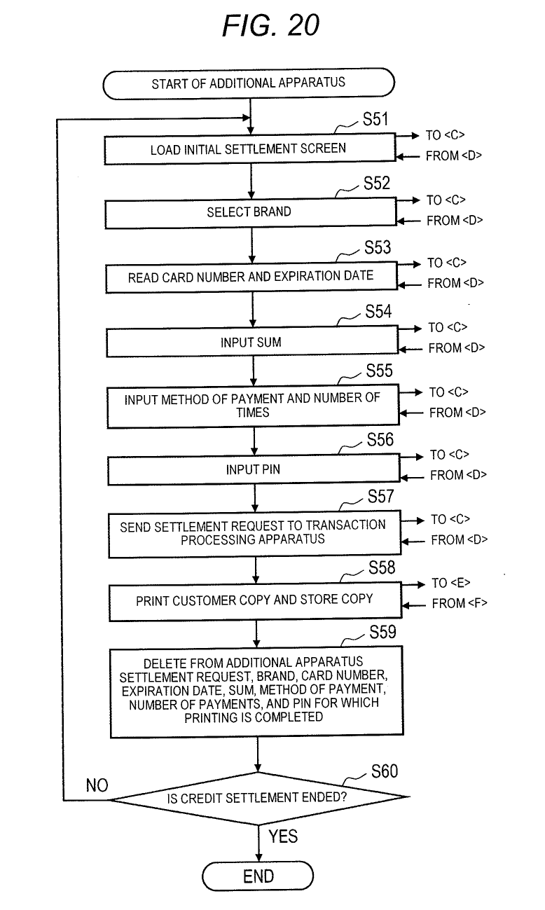

Transaction processing apparatus 1 cannot directly communicate with settlement relay center 5 in the offline state in the present exemplary embodiment. Thus, an input process (hereinafter, includes a reading process as a part of the input process) for information required for settlement of a transaction (settlement information) is performed by instruction FL1 (refer to FIG. 4; that is, reference in the backward direction of instruction FL2 illustrated in FIG. 18) from transaction processing apparatus 1 in, for example, additional apparatus 2 (refer to FIG. 20 to FIG. 25). The settlement information is information required for settlement of a transaction and is information that includes, for example, information input in additional apparatus 2 (for example, brand information of card CrD, a transaction sum, a method of payment, the number of payments, and the PIN of the purchaser (customer)) and information including the card number and the expiration date of card CrD read in additional apparatus 2 (encrypted in card CrD).

In FIG. 18, additional apparatus 2 sends to transaction processing apparatus 1 an obtaining request for screen data that includes the settlement information and prompts input of the settlement information in a subsequent input process, each time an input process is performed (reference in the forward direction of instruction FL2 illustrated in FIG. 18 (instruction FL2F illustrated in FIG. 19)). Transaction processing apparatus 1 sends an obtaining request in each input process to settlement relay center 5 through application BL1 that performs a settlement procedure in transaction processing apparatus 1, application BL2 that performs a settlement procedure in communication with settlement relay center 5 or settlement center 6, data communication library BL4, local-area wireless transceiver 51, local-area wireless transceiver 52, data communication library BL7, local-area and wide-range communication application BL8, and wide-range wireless transceiver 50 (reference in the forward direction of instruction FL3 illustrated in FIG. 18 (instruction FL3F illustrated in FIG. 19)). The obtaining request in each input process may not be required to be an obtaining request for the screen data that includes the settlement information input in the input process and prompts input of the settlement information in a subsequent input. For example, the settlement information that is input in the input process may be sent to settlement relay center 5 without an obtaining request. The same applies in each exemplary embodiment described below. Settlement relay center 5, in response to the obtaining request in each input process, sends to additional apparatus 2 a reception response (process result) that indicates that the corresponding settlement information is input, and the screen data that prompts input of the required settlement information in a subsequent input process. The screen data that prompts input of the settlement information is sent in the opposite direction to the obtaining request for the screen data (that is, in order of instruction FL3R and instruction FL2R). Accordingly, additional apparatus 2, when communication between the transaction processing apparatus 1 and settlement relay center 5 is in the offline state, can send the input settlement information to settlement relay center 5 instead of transaction processing apparatus 1 and can display the screen data that prompts input of the settlement information in a subsequent input process, each time an input process for the settlement information is performed on additional apparatus 2 by the staff member or the customer.

Additional apparatus 2 sends to transaction processing apparatus 1 a settlement request that includes the settlement information input in the last input process (reference in the forward direction of instruction FL2 illustrated in FIG. 18 (instruction FL2F illustrated in FIG. 19)). Transaction processing apparatus 1 sends the settlement request to settlement relay center 5 through application BL1 that performs a settlement procedure in transaction processing apparatus 1, application BL2 that performs a settlement procedure in communication with settlement relay center 5 or settlement center 6, data communication library BL4, local-area wireless transceiver 51, local-area wireless transceiver 52, data communication library BL7, local-area and wide-range communication application BL8, and wide-range wireless transceiver 50 (reference in the forward direction of instruction FL3 illustrated in FIG. 18 (instruction FL3F illustrated in FIG. 19)). Settlement relay center 5, in response to the settlement request, performs a settlement process using all of the settlement information sent from additional apparatus 2 and, in a case where the settlement process is normally ended, sends a settlement completion notification indicating the case to additional apparatus 2. The settlement completion notification is sent in the opposite direction to the settlement request (that is, in order of instruction FL3R and instruction FL2R). Accordingly, additional apparatus 2 can obtain, instead of transaction processing apparatus 1, a settlement completion notification for settlement using the settlement information that is input into additional apparatus 2 by the staff member or the customer, and can send the settlement completion notification to transaction processing apparatus 1 when communication between transaction processing apparatus 1 and settlement relay center 5 is in the offline state.

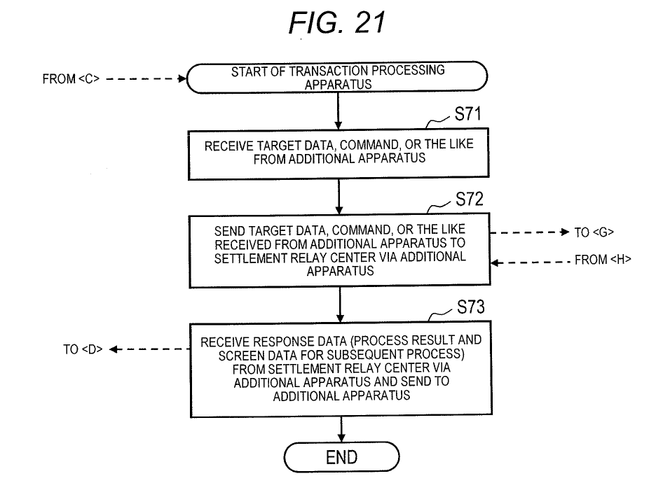

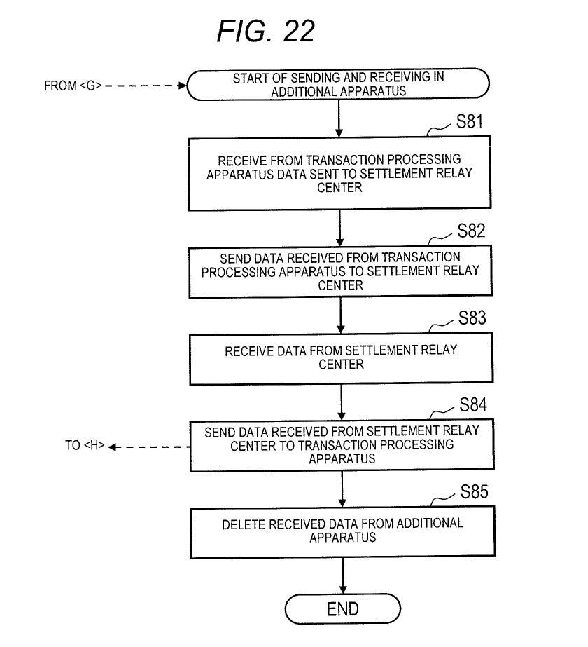

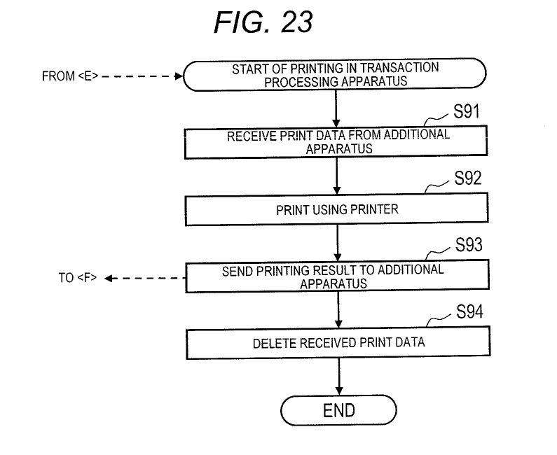

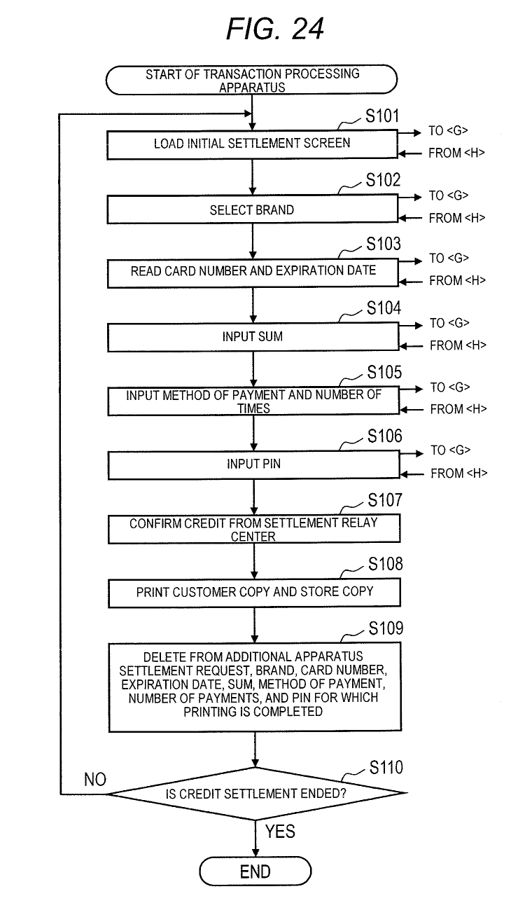

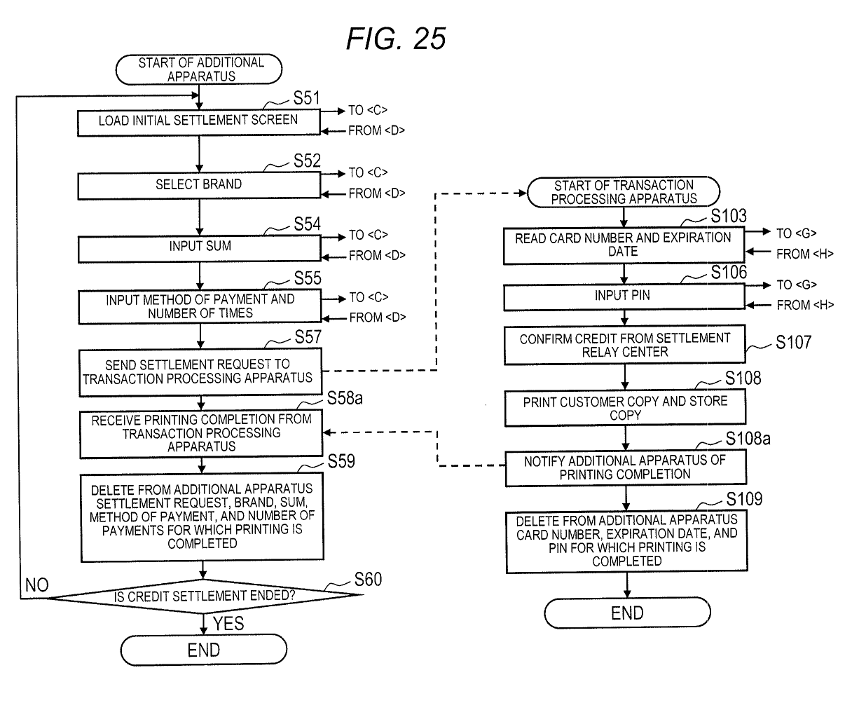

Next, details of operation procedures of transaction processing apparatus 1 and additional apparatus 2 of transaction processing system 10 of the present exemplary embodiment will be described with reference to FIG. 20 to FIG. 25. FIG. 20 is a flowchart describing a first example of the process flow of additional apparatus 2 of the third exemplary embodiment as an input apparatus for the settlement information in the offline state. FIG. 21 is a flowchart describing one example of an operation procedure of communication between transaction processing apparatus 1 and settlement relay center 5 via additional apparatus 2. FIG. 22 is a flowchart describing one example of the process flow of additional apparatus 2 of the third exemplary embodiment as a relay apparatus for the settlement information in the offline state. FIG. 23 is a flowchart describing one example of a printing process in transaction processing apparatus 1. FIG. 24 is a flowchart describing a second example of the process flow of additional apparatus 2 of the third exemplary embodiment as an input apparatus for the settlement information in the offline state. FIG. 25 is a flowchart describing a third example of the process flow of the additional apparatus of the third exemplary embodiment as an input apparatus for the settlement information in the offline state.

In FIG. 20, additional apparatus 2 that has a role as an input apparatus for the settlement information, for example, launches the settlement process application in response to operation by the staff member and displays an initial screen of the settlement process application (for example, a screen on which a plurality of menus related to a settlement process is lined up) on display 38 of touch panel TP2 (S51). Additional apparatus 2 sends to transaction processing apparatus 1 an obtaining request for the screen data that includes data indicating that the initial screen is displayed and that prompts input of the settlement information corresponding to a subsequent input process (for example, “select brand” in Step S52) (refer to “C” in FIG. 20).

In FIG. 21, by this sending, transaction processing apparatus 1 receives target data, a command, or the like (for example, the obtaining request described above) sent from additional apparatus 2 (S71) and sends the target data, the command, or the like (for example, the obtaining request described above) to settlement relay center 5 via additional apparatus 2 (S72; refer to “G” in FIG. 21).

In FIG. 22, by this sending, additional apparatus 2 that has a role as a relay apparatus for the settlement information receives the target data, the command, or the like (for example, the obtaining request described above) sent from transaction processing apparatus 1 (S81) and sends the target data, the command, or the like (for example, the obtaining request described above) to settlement relay center 5 (S82). Additional apparatus 2 receives response data (for example, the screen data that prompts input of the settlement information corresponding to a subsequent input process (for example, “select brand” in Step S52) in response to the obtaining request described above) from settlement relay center 5 (S83). Additional apparatus 2 sends the response data from settlement relay center 5 to transaction processing apparatus 1 (S84; refer to “H” in FIG. 21) and deletes the response data after sending (S85).

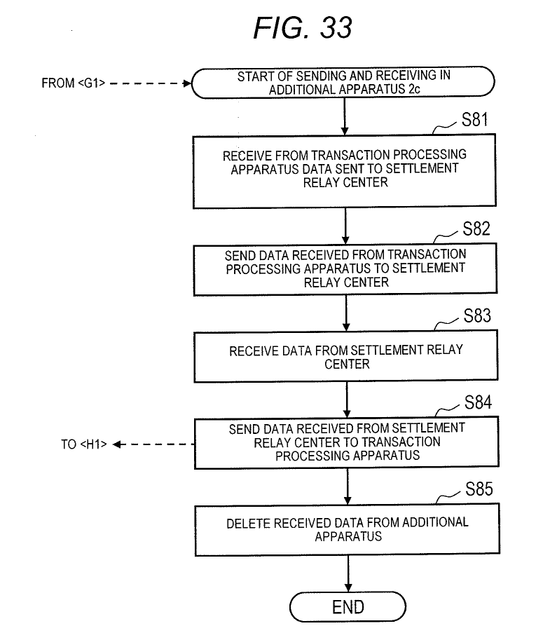

In Step S81 to Step S85 illustrated in FIG. 22 and FIG. 33 (described later), additional apparatuses 2 and 2c as an information and data relay apparatus send and receive simple data strings regardless of the content of data even if additional apparatuses 2 and 2c actually send and receive settlement application data (for example, the target data or the command received from additional apparatuses 2 and 2c, the process result received from settlement relay center 5, or the screen data that prompts input of the settlement information corresponding to a subsequent input process).

In FIG. 21, by sending in Step S84, transaction processing apparatus 1 sends to additional apparatus 2 the response data that is sent from additional apparatus 2 as an information and data relay apparatus (S73; refer to “D” in FIG. 20). Additional apparatus 2 receives the response data and displays on display 38 of touch panel TP2 the screen data that is included in the response data and prompts input of the settlement information in a subsequent input process (for example, “select brand” in Step S52).

By sending in Step S73, regarding “load initial settlement screen” in Step S51 illustrated in FIG. 20, an input process for the settlement information is performed between additional apparatus 2 and settlement relay center 5 through transaction processing apparatus 1 in an order of additional apparatus 2 (refer to FIG. 20)→transaction processing apparatus 1 (refer to FIG. 21)→additional apparatus 2 (refer to FIG. 22)→settlement relay center 5→additional apparatus 2 (refer to FIG. 22)→transaction processing apparatus 1 (refer to FIG. 21)→additional apparatus 2.

Hereinafter, “select brand” in step S52, “read card number and expiration date” in Step S53, “input sum” in Step S54, “input method of payment and number of times” in Step S55, “input PIN” in Step S56, and “send settlement request” in Step S57 illustrated in FIG. 20 will be performed in the same order described in Step S51.

As described above in the first exemplary embodiment, information related to a card brand of a card (for example, an IC credit card) selected by an input operation of the staff member is input into CPU 22 of additional apparatus 2 in “select brand” (S52), and screen data related to “read card number and expiration date” in Step S53 is displayed on display 38 as a result of the process of Step S52.

Information that is read by contact IC card reader 26 or non-contact IC card reader/writer 28 is input into CPU 22 of additional apparatus 2 in “read card number and expiration date” (S53), and screen data related to “input sum” in Step S54 is displayed on display 38 as a result of the process of Step S53.

Information as to the transaction sum is input into CPU 22 of additional apparatus 2 by an input operation of the staff member in “input sum” (S54), and screen data related to “input method of payment and number of times” in Step S55 is displayed on display 38 as a result of the process of Step S54.

Information as to each of the method of payment and the number of payments is input into CPU 22 of additional apparatus 2 by an input operation of the staff member in “input method of payment and number of times” (S55), and screen data related to “input PIN” in Step S56 is displayed on display 38 as a result of the process of Step S55.

The PIN of the customer is input into CPU 22 of additional apparatus 2 by an input operation of the customer in “input PIN” that is an input process for the settlement information (S56), and screen data related to “settlement request” in Step S57 is displayed on display 38 as a result of the process of Step S56.

A settlement request (settlement process request) is generated by CPU 22 of additional apparatus 2 by an input operation of the staff member in “send settlement request” that is the last input process (S57), and is processed in the same order described in Step S51, and additional apparatus 2 receives a settlement completion notification sent from settlement relay center 5 in a case where settlement is normally ended in settlement relay center 5. In this case, additional apparatus 2, in response to the settlement completion notification, sends to transaction processing apparatus 1 a printing instruction that includes print data of slip copies (for example, a customer copy and a store copy) related to settlement of a transaction using the card (for example, an IC credit card) (S58; refer to “E” in FIG. 23).

In FIG. 23, by this sending, transaction processing apparatus 1 receives the printing instruction including the print data of the slip copies (S91) and prints the slip copies in printer 41 (S92). Transaction processing apparatus 1 sends data of the result of printing of the slip copies (for example, the print data of the slip copies or data indicating that the slip copies are printed; the same applies hereinafter) to additional apparatus 2 (S93, refer to “F” in FIG. 23) and then deletes the data of the result of printing of the slip copies (S94). Additional apparatus 2 receives the data of the result of printing of the slip copies sent from transaction processing apparatus 1. If necessary, additional apparatus 2 may display the data of the result of printing of the slip copies on display 38 of touch panel TP2.

Additional apparatus 2 deletes the settlement information (that is, the brand information, the card number, the expiration date, the transaction sum, the method of payment, the number of payments, the PIN, and the settlement request) related to the transaction printed on the slip copies after additional apparatus 2 receives the data of result of printing of the slip copies (S59). A return is made to the process of Step S51 if settlement of a transaction using card CrD (IC credit card) is continued (NO in S60). The flow illustrated in FIG. 20 is ended in a case where settlement of a transaction using card CrD (IC credit card) is not continued (YES in S60).

Next, in FIG. 24, additional apparatus 2, unlike in FIG. 20, does not have a role as an input apparatus for the settlement information and has only a role as a relay apparatus for the settlement information. In other words, in FIG. 24, instruction FL2F illustrated in FIG. 19 is not present, and transaction processing apparatus 1 has a role as an input apparatus for the settlement information. That is, input of the settlement information is performed by transaction processing apparatus 1 that is on the starting point side of instruction FL3F illustrated in FIG. 19. Instruction FL2F illustrated in FIG. 19 indicates the forward direction of instruction FL2 illustrated in FIG. 18, and instruction FL3F indicates the forward direction of instruction FL3 illustrated in FIG. 18. Instruction FL2R illustrated in FIG. 19 indicates the backward direction of instruction FL2F, and instruction FL3R illustrated in FIG. 19 indicates the backward direction of instruction FL3F. The same applies in exemplary embodiments below.

Specifically, in FIG. 24, transaction processing apparatus 1, for example, launches the settlement process application in response to operation by the staff member and displays the initial screen of the settlement process application (for example, a screen on which a plurality of menus related to a settlement process is lined up) on display 37 of touch panel TP1 (S101). Transaction processing apparatus 1 sends to additional apparatus 2 an obtaining request for the screen data that includes data indicating that the initial screen is displayed and that prompts input of the settlement information corresponding to a subsequent input process (for example, “select brand” in Step S102) (refer to “G” in FIG. 22).

In FIG. 22, by this sending, additional apparatus 2 that has a role as a relay apparatus for the settlement information receives the target data, the command, or the like (for example, the obtaining request described above) sent from transaction processing apparatus 1 (S81) and sends the target data, the command, or the like (for example, the obtaining request described above) to settlement relay center 5 (S82). Additional apparatus 2 receives response data (for example, the data indicating that the initial screen is displayed in transaction processing apparatus 1 and the screen data that prompts input of the settlement information corresponding to a subsequent input process (for example, “select brand” in Step S102) in response to the obtaining request described above) from settlement relay center 5 (S83). Additional apparatus 2 sends the response data from settlement relay center 5 to transaction processing apparatus 1 (S84; refer to “H” in FIG. 21) and deletes the response data after sending (S85).

In FIG. 24, by sending and receiving in Step S81 to Step S84, transaction processing apparatus 1 receives the response data sent from additional apparatus 2 as an information and data relay apparatus and displays on display 37 of touch panel TP1 the screen data that is included in the response data and prompts input of the settlement information in a subsequent input process (for example, “select brand” in Step S102).

By sending in Step S84, regarding “load initial settlement screen” in Step S101 illustrated in FIG. 24, an input process for the settlement information is performed between transaction processing apparatus 1 and settlement relay center 5 through additional apparatus 2 in an order of transaction processing apparatus 1 (refer to FIG. 24)→additional apparatus 2 (refer to FIG. 22)→settlement relay center 5→additional apparatus 2 (refer to FIG. 22)→transaction processing apparatus 1 (refer to FIG. 24).

Hereinafter, “select brand” in step S102, “read card number and expiration date” in Step S103, “input sum” in Step S104, “input method of payment and number of times” in Step S105, “input PIN” in Step S106, and “send settlement request” in Step S107 illustrated in FIG. 24 will be performed in the same order described in Step S101.

Information related to a card brand of a card (for example, an IC credit card) selected by an input operation of the staff member is input into CPU 21 of transaction processing apparatus 1 in “select brand” (S102), and screen data related to “read card number and expiration date” in Step S103 is displayed on display 37 as a result of the process of Step S102.

Information that is read by contact IC card reader/writer 25 or non-contact IC card reader/writer 27 is input into CPU 21 of transaction processing apparatus 1 in “read card number and expiration date” (S103), and screen data related to “input sum” in Step S104 is displayed on display 37 as a result of the process of Step S103.

Information as to the transaction sum is input into CPU 21 of transaction processing apparatus 1 by an input operation of the staff member in “input sum” (S104), and screen data related to “input method of payment and number of times” in Step S105 is displayed on display 37 as a result of the process of Step S104.

Information as to each of the method of payment and the number of payments is input into CPU 21 of transaction processing apparatus 1 by an input operation of the staff member in “input method of payment and number of times” (S105), and screen data related to “input PIN” in Step S106 is displayed on display 37 as a result of the process of Step S105.

The PIN of the customer is input into CPU 21 of transaction processing apparatus 1 by an input operation of the customer in “input PIN” that is the last input process in FIG. 24 (S106), and a settlement request including the PIN is sent to settlement relay center 5 through additional apparatus 2. Transaction processing apparatus 1, in a case where a settlement completion notification that indicates that settlement is normally ended in settlement relay center 5 is obtained as a credit result, receives the settlement completion notification sent from settlement relay center 5 through additional apparatus 2. That is, screen data related to “confirm credit result from settlement relay center 5” in Step S107 is displayed on display 37 as a result of the process of Step S106.

Screen data of the settlement completion notification sent from settlement relay center 5 is displayed on display 37 of transaction processing apparatus 1 in “confirm credit result from settlement relay center 5” (S107). In this case, transaction processing apparatus 1, in response to the settlement completion notification, performs printing in printer 41 by using print data of slip copies (for example, a customer copy and a store copy) that are related to settlement of a transaction using the card (for example, an IC credit card) (S108).

Transaction processing apparatus 1 deletes the settlement information (that is, the brand information, the card number, the expiration date, the transaction sum, the method of payment, the number of payments, the PIN, and the settlement request) printed on the slip copies after printing (S109). A return is made to the process of Step S101 if settlement of a transaction using card CrD (IC credit card) is continued (NO in S110). The flow illustrated in FIG. 24 is ended in a case where settlement of a transaction using card CrD (IC credit card) is not continued (YES in S110).

Next, in FIG. 25, additional apparatus 2, unlike in FIG. 20 and FIG. 24, has a role as an input apparatus for a part of the settlement information, and transaction processing apparatus 1 has a role as an input apparatus for the remaining settlement information. Furthermore, additional apparatus 2 has a role as a relay apparatus for the settlement information. In other words, in FIG. 25, input of a part of the settlement information is performed by additional apparatus 2 that is on the starting point side of instruction FL2F illustrated in FIG. 19, and input of the remaining settlement information is performed by transaction processing apparatus 1 that is on the starting point side of instruction FL3F illustrated in FIG. 19.

That is, in FIG. 25, additional apparatus 2 performs “load initial settlement screen” in Step S51, “select brand” in Step S52, “input sum” in Step S54, and “input method of payment and number of times” in Step S55 in FIG. 25 in the same manner as Step S51, Step S52, Step S54, and Step S55 illustrated in FIG. 20. A detailed description related to these processes is described with reference to FIG. 20 and thus will not be described here. When additional apparatus 2 sends a settlement request to transaction processing apparatus 1 in Step S57, transaction processing apparatus 1 receives the settlement request sent from additional apparatus 2. Transaction processing apparatus 1 performs “read card number and expiration date in Step S103, “input PIN” in Step S106, and “confirm credit result from settlement relay center 5” in Step S107 in FIG. 25 in the same manner as Step S103, Step S106, and Step S107 illustrated in FIG. 24. A detailed description related to these processes is described with reference to FIG. 24 and thus will not be described here.

Transaction processing apparatus 1, in a case where screen data of a settlement completion notification from settlement relay center 5 is displayed on display 37 of transaction processing apparatus 1, performs printing in printer 41 in “confirm credit result from settlement relay center 5” in response to the settlement completion notification by using print data of slip copies (for example, a customer copy and a store copy) that are related to settlement of a transaction using the card (for example, an IC credit card) (S108).

Transaction processing apparatus 1 notifies additional apparatus 2 that printing of the slip copies is completed (S108a), and after printing, deletes the settlement information (that is, the card number, the expiration date, and the PIN) input in transaction processing apparatus 1 (S109).

Additional apparatus 2 receives the notification that printing of the slip copies is completed (S58a) and deletes the settlement information (that is, the brand information, the transaction sum, the method of payment, the number of payments, and the settlement request) input in additional apparatus 2 (S59). A return is made to the process of Step S51 if settlement of a transaction using card CrD (IC credit card) is continued (NO in S60). The flow illustrated in FIG. 25 is ended in a case where settlement of a transaction using card CrD (IC credit card) is not continued (YES in S60).

In transaction processing system 10 of the present exemplary embodiment described heretofore, transaction processing apparatus 1 makes connection related to settlement of a transaction using the IC credit card to settlement relay center 5 to which settlement of a transaction using the IC credit card is connected, and performs a settlement process in a case where communication between transaction processing apparatus 1 and settlement relay center 5 is in a state of availability (typical online state). Transaction processing apparatus 1, in each input process for a plurality of different settlement information related to a transaction, sends to additional apparatus 2 an obtaining request for a screen that includes any settlement information input and prompts input of the settlement information corresponding to a subsequent input process, in a case where communication between transaction processing apparatus 1 and settlement relay center 5 is in a state of unavailability (offline state). Additional apparatus 2 sends to transaction processing apparatus 1 screen data corresponding to the obtaining request in a case where additional apparatus 2 sends to settlement relay center 5 the obtaining request sent from transaction processing apparatus 1. Transaction processing apparatus 1 prompts input of the settlement information on the screen data in a case where transaction processing apparatus 1 receives the screen data. Transaction processing apparatus 1 sends to additional apparatus 2 a settlement process request that includes any settlement information input in the last input process. Additional apparatus 2 sends to transaction processing apparatus 1 the settlement completion notification sent from settlement relay center 5 in a case where additional apparatus 2 sends to settlement relay center 5 the settlement process request sent from transaction processing apparatus 1. Transaction processing apparatus 1 prints slip copies related to a transaction in a case where transaction processing apparatus 1 receives the settlement completion notification.

Accordingly, transaction processing system 10, in a settlement scheme in which information required for authentication of the IC credit card used in a settlement process is sent and received between the IC credit card and settlement relay center 5, can obtain and display the input screen for the settlement information in each input process for the settlement information by using additional apparatus 2 in communication between transaction processing apparatus 1 and settlement relay center 5 in the offline state including when a line to settlement relay center 5 is unavailable and when a failure occurs, and thus smoothly and accurately performs settlement using the IC credit card while confirming the settlement using the IC credit card in order. Transaction processing system 10, in the offline state including when a line to settlement relay center 5 is unavailable and when a failure occurs, may not use settlement by the magnetic credit card function that uses information recorded in the magnet stripe of the IC credit card, or can use settlement by the IC credit card function. Thus, degradation of security of the authentication information of the customer can be prevented.

In transaction processing system 10, for example, the brand information of the IC credit card, the transaction sum, the method of payment, the number of payments, and the authentication information of the customer are input as the settlement information by additional apparatus 2. The card number and the expiration date of the IC credit card are read by additional apparatus 2 from the IC credit card. Transaction processing apparatus 1 sends a printing completion notification for slip copies to additional apparatus 2. Additional apparatus 2 deletes the brand information, the card number, and the expiration date of the IC credit card, the transaction sum, the method of payment, the number of payments, and the authentication information of the customer after additional apparatus 2 receives the printing completion notification.

Accordingly, transaction processing system 10 can temporarily use additional apparatus 2 as settlement means that replaces transaction processing apparatus 1 (that is, an input tool for input of the transaction settlement information and a wide-range wireless communication tool for communication with settlement relay center 5) in the offline state including when a line between transaction processing apparatus 1 and settlement relay center 5 is unavailable and when a failure occurs. Furthermore, a printing completion notification for slip copies that indicates that settlement of a transaction using the IC credit card is normally ended allows transaction processing system 10 to delete the transaction settlement information remaining in additional apparatus 2. Thus, security of personal information of a settlement target customer can be securely guaranteed when, for example, an application for general purposes other than settlement (for example, a mail application and a website browsing application) is used.

In transaction processing system 10, for example, the brand information of the IC credit card, the transaction sum, the method of payment, the number of payments, and the authentication information of the customer are input as the settlement information by transaction processing apparatus 1. The card number and the expiration date of the IC credit card are read by transaction processing apparatus 1 from the IC credit card. Transaction processing apparatus 1 deletes the brand information, the card number, and the expiration date of the IC credit card, the transaction sum, the method of payment, the number of payments, and the authentication information of the customer after transaction processing apparatus 1 prints slip copies.

Accordingly, transaction processing system 10 can temporarily use additional apparatus 2 as settlement means that replaces transaction processing apparatus 1 (that is, a wide-range wireless communication tool for communication with settlement relay center 5) in the offline state including when a line between transaction processing apparatus 1 and settlement relay center 5 is unavailable and when a failure occurs. Furthermore, a printing completion notification for slip copies that indicates that settlement of a transaction using the IC credit card is normally ended allows transaction processing system 10 to delete the transaction settlement information remaining in transaction processing apparatus 1. Thus, security of personal information of a settlement target customer can be securely guaranteed.

In transaction processing system 10, for example, the brand information of the IC credit card, the transaction sum, the method of payment, and the number of payments are input as the settlement information by additional apparatus 2. The authentication information of the customer is input by transaction processing apparatus 1. The card number and the expiration date of the IC credit card are read by transaction processing apparatus 1 from the IC credit card. Transaction processing apparatus 1 sends a printing completion notification for slip copies to additional apparatus 2. Additional apparatus 2 deletes the brand information of the IC credit card, the transaction sum, the method of payment, and the number of payments after additional apparatus 2 receives the printing completion notification.

Accordingly, transaction processing system 10 can temporarily use additional apparatus 2 as settlement means that replaces transaction processing apparatus 1 (that is, an input tool for input of a part of the transaction settlement information and a wide-range wireless communication tool for communication with settlement relay center 5) in the offline state including when a line between transaction processing apparatus 1 and settlement relay center 5 is unavailable and when a failure occurs. Furthermore, a printing completion notification for slip copies that indicates that settlement of a transaction using the IC credit card is normally ended allows transaction processing system 10 to delete the transaction settlement information remaining in additional apparatus 2. Thus, security of personal information of a settlement target customer can be securely guaranteed when, for example, an application for general purposes other than settlement (for example, a mail application and a website browsing application) is used.

Transaction processing apparatus 1 of the present exemplary embodiment, in a case where communication between transaction processing apparatus 1 and settlement relay center 5 is in a state of unavailability (offline state), sends to additional apparatus 2, in each input process for the settlement information, an obtaining request for the screen data that includes any settlement information input and prompts input of the settlement information corresponding to a subsequent input process, and sends to additional apparatus 2 a settlement process request that includes any settlement information input in the last input process. Transaction processing apparatus 1 prompts input of the settlement information on the screen data in a case where transaction processing apparatus 1 receives the screen data, and prints slip copies (for example, a customer copy and a store copy related to settlement of a transaction using the IC credit card) related to a transaction in a case where transaction processing apparatus 1 receives a settlement completion notification for a transaction.

Accordingly, transaction processing apparatus 1, in a settlement scheme in which information required for authentication of the IC credit card is sent and received between the IC credit card and settlement relay center 5, can obtain and display the input screen for the settlement information in each input process for the settlement information by using additional apparatus 2 in communication between transaction processing apparatus 1 and settlement relay center 5 in the offline state including when a line to settlement relay center 5 is unavailable and when a failure occurs, and thus has a simple apparatus configuration of a thin client type and smoothly and accurately performs settlement using the IC credit card while confirming the settlement using the IC credit card in order.

Additional apparatus 2 of the present exemplary embodiment, in each input process for a plurality of different settlement information related to a transaction, sends to settlement relay center 5 an obtaining request for the screen data that includes any settlement information input and prompts input of the settlement information corresponding to a subsequent input process, and sends to settlement relay center 5 a settlement process request that includes any settlement information input in the last input process. Additional apparatus 2 sends to transaction processing apparatus 1 screen data corresponding to the obtaining request in a case where additional apparatus 2 sends to settlement relay center 5 the obtaining request sent from transaction processing apparatus 1, and sends to transaction processing apparatus 1 a settlement completion notification sent from settlement relay center 5 in a case where additional apparatus 2 sends to settlement relay center 5 the settlement process request sent from transaction processing apparatus 1.

Accordingly, additional apparatus 2 not only can use an application for general purposes other than settlement (for example, a mail application and a website browsing application) but also can be temporarily used as settlement means (that is, an input tool for input of the transaction settlement information and a wide-range wireless communication tool for communication with settlement relay center 5) that replaces transaction processing apparatus 1 related to settlement of a transaction using the IC credit card.

### Background of Fourth Exemplary Embodiment

Next, the background of a transaction processing system of a fourth exemplary embodiment will be simply described before an example of the transaction processing system of the fourth exemplary embodiment is described. In the second exemplary embodiment described above, additional apparatus 2c displays an input screen (for example, refer to FIG. 10A to FIG. 10H) for the transaction settlement information that is generated in a script format and the like by settlement relay center 5, and sends to transaction processing apparatus 1 of a thin client a settlement request that includes the settlement information input by the staff member or the customer. Therefore, input on the input screen for the settlement information can be continuously performed in additional apparatus 2 by input processes by the staff member or the customer. However, transaction processing apparatus 1 or additional apparatus 2, in a case where the input screen for the settlement information is not generated in a script format and the like, is required to request and obtain the input screen for the settlement information from settlement relay center 5 in each input process for the settlement information and to supply the input screen in the input processes performed by the customer or the staff member in the typical online state or the offline state.

Therefore, hereinafter, the fourth exemplary embodiment will be described in an example of transaction processing system 10A in which transaction processing apparatus 1 or additional apparatus 2, in a case where the input screen for the settlement information is not generated in a script format and the like in the second exemplary embodiment, requests and obtains the input screen for the settlement information from settlement relay center 5 and causes the customer or the staff member to provide input in each input process for the settlement information in the typical online state or the offline state.

### Fourth Exemplary Embodiment

A system configuration example of transaction processing system 10A of the fourth exemplary embodiment is the same as the system configuration example of transaction processing system 10 of the first exemplary embodiment. Thus, the same configurations will be designated by the same reference signs and will not be described, and different contents will be described. An internal configuration of transaction processing apparatus 1a and additional apparatuses 2c, 2ac, and 2bc of the present exemplary embodiment is the same as the internal configuration of transaction processing apparatus 1 illustrated in FIG. 2 and additional apparatus 2 illustrated in FIG. 3 and thus will not be described in detail.

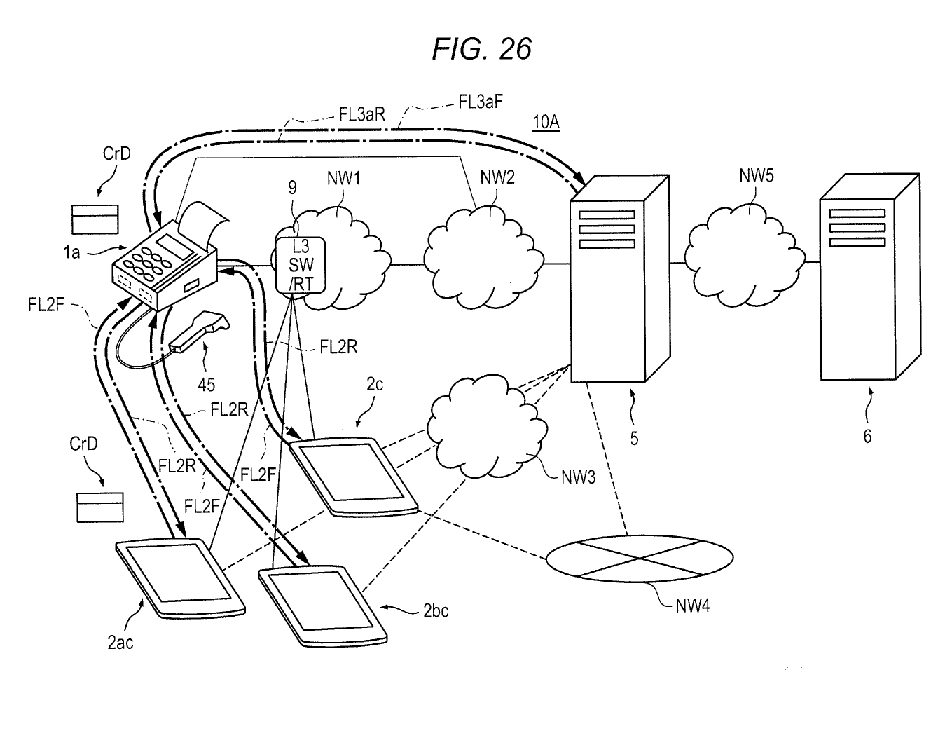

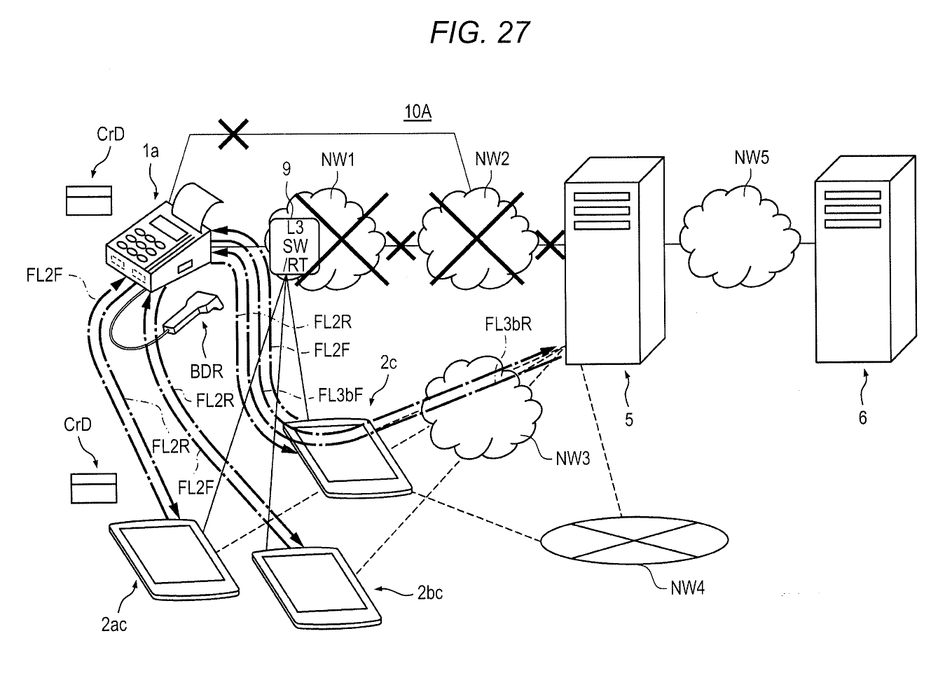

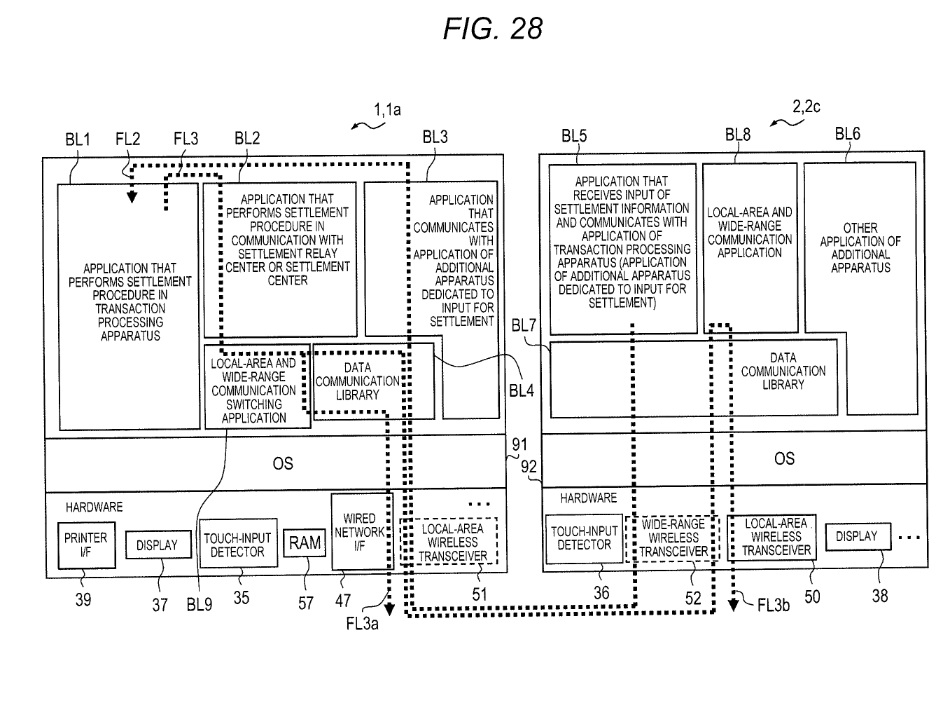

FIG. 26 is a diagram illustrating one example of a connection path of transaction processing apparatus 1a, additional apparatuses 2c, 2ac, and 2bc, and settlement relay center 5 of the fourth exemplary embodiment in the typical online state. FIG. 27 is a diagram illustrating one example of a connection path of transaction processing apparatus 1a, additional apparatuses 2c, 2ac, and 2bc, and settlement relay center 5 of the fourth exemplary embodiment in the offline state. FIG. 28 is a diagram illustrating one example of a software block configuration of transaction processing apparatus 1a and additional apparatus 2c of the fourth exemplary embodiment. FIG. 28 illustrates the flow of a process between transaction processing apparatus 1a and additional apparatuses 2c, 2ac, and 2bc in the typical online state illustrated in FIG. 26 (refer to instructions FL2F, FL2R, FL3aF, and FL3aR) and the flow of a process between transaction processing apparatus 1a and settlement relay center 5 through additional apparatus 2c in the offline state (refer to instructions FL2F, FL2R, FL3bF, and FL3bR).

In FIG. 28, only a part of each unit illustrated in FIG. 2 is illustrated as hardware of transaction processing apparatus 1a, and not all of the hardware is illustrated. Similarly, only a part of each unit illustrated in FIG. 3 is illustrated as hardware of additional apparatus 2c, and not all of the hardware is illustrated. Furthermore, the same content as in the description of FIG. 4 or FIG. 18 will not be described in description of FIG. 28, and different contents will be described.

In FIG. 28, additional apparatus 2c is operated by cooperation of one or more software modules (that is, components constituting an application) on OS 92 that is base software, when an application installed in additional apparatus 2c is executed. In FIG. 28, the software modules include, for example, at least application (the dedicated settlement input application of additional apparatus 2) BL5 that receives input of settlement information and communicates with the application of transaction processing apparatus 1, and other application BL6, data communication library BL7, and local-area and wide-range communication application BL8 of additional apparatus 2.

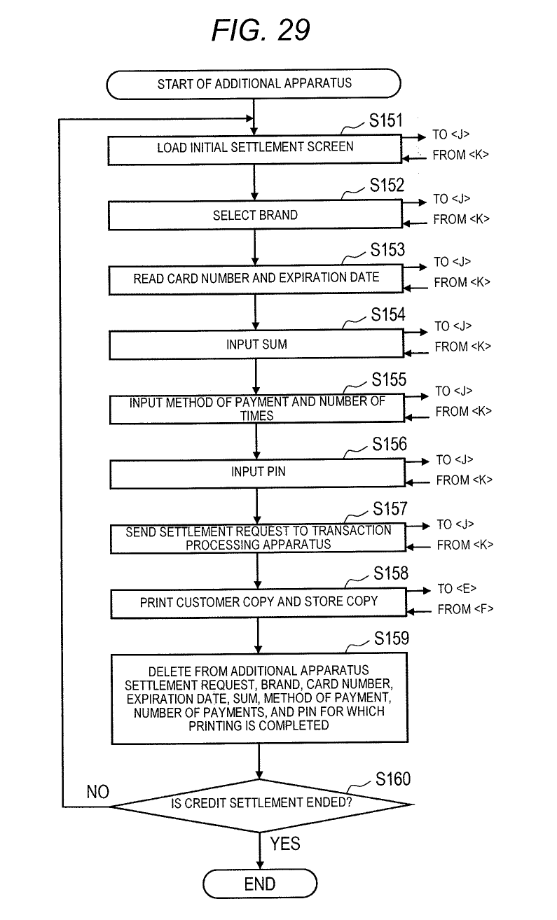

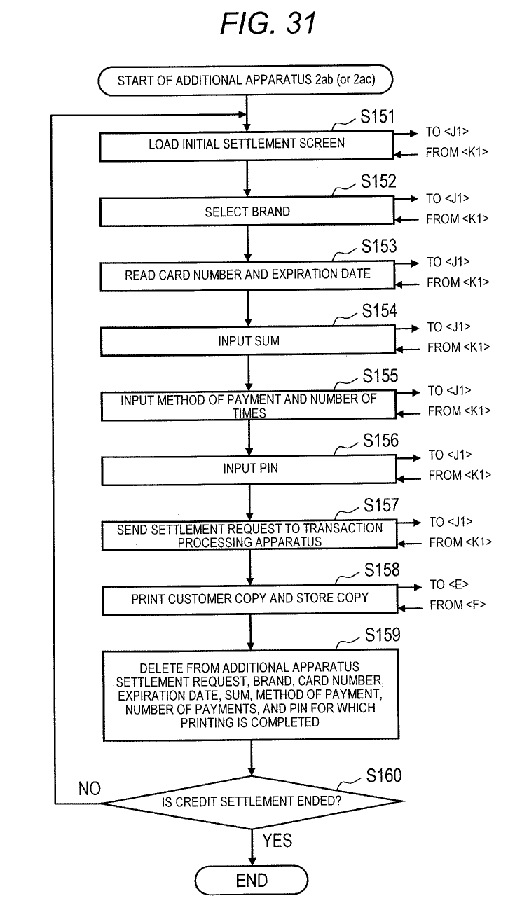

An input process for information required for settlement of a transaction (settlement information) is performed in, for example, additional apparatus 2c by instruction FL1 (refer to FIG. 4; that is, reference in the backward direction of instruction FL2 illustrated in FIG. 28) from transaction processing apparatus 1a either in the typical online state or in the offline state in the present exemplary embodiment (refer to FIG. 29 to FIG. 33). An input process for information required for settlement of a transaction (settlement information) may be performed by additional apparatuses 2ac and 2bc (refer to FIG. 31).

In FIG. 28, additional apparatuses 2c, 2ac, and 2bc send to transaction processing apparatus 1a an obtaining request screen data that includes the input settlement information and prompts input of the settlement information in a subsequent input process, each time an input process is performed (reference in the forward direction of instruction FL2 illustrated in FIG. 28 (instruction FL2F illustrated in FIG. 26 or FIG. 27)). Transaction processing apparatus 1a, in the typical online state, sends an obtaining request in each input process to settlement relay center 5 through application BL1 that performs a settlement process in transaction processing apparatus 1a, application BL2 that performs a settlement procedure in communication with settlement relay center 5 or settlement center 6, local-area and wide-range communication switching application BL9, data communication library BL4, and wired network I/F 47 (reference in the forward direction of instruction FL3a illustrated in FIG. 28 (instruction FL3aF illustrated in FIG. 26)). Settlement relay center 5, in response to the obtaining request in each input process, sends to transaction processing apparatus 1a a reception response (process result) that indicates that the corresponding settlement information is input, and the screen data that prompts input of the required settlement information in a subsequent input process. The screen data that prompts input of the settlement information is sent in the opposite direction to the obtaining request for the screen data (that is, in order of instruction FL3aR and instruction FL2R). Accordingly, transaction processing apparatus 1a, in the typical online state, can send the input settlement information to settlement relay center 5 instead of transaction processing apparatus 1 and can display the screen data that prompts input of the settlement information in a subsequent input process, each time an input process for the settlement information is performed on additional apparatus 2c by the staff member or the customer, and additional apparatus 2c can be used as an input apparatus for the settlement information.

In FIG. 28, transaction processing apparatus 1a, in the offline state, sends an obtaining request in each input process to settlement relay center 5 through application BL1 that performs a settlement process in transaction processing apparatus 1a, application BL2 that performs a settlement procedure in communication with settlement relay center 5 or settlement center 6, local-area and wide-range communication switching application BL9, data communication library BL4, local-area wireless transceiver 51, local-area wireless transceiver 52, data communication library BL7, local-area and wide-range communication application BL8, and wide-range wireless transceiver 50 (reference in the forward direction of instruction FL3b illustrated in FIG. 28 (instruction FL3bF illustrated in FIG. 27)). Settlement relay center 5, in response to the obtaining request in each input process, sends to additional apparatus 2c a reception response (process result) that indicates that the corresponding settlement information is input, and the screen data that prompts input of the required settlement information in a subsequent input process. The screen data that prompts input of the settlement information is sent in the opposite direction to the obtaining request for the screen data (that is, in order of instruction FL3bR and instruction FL2R). Accordingly, additional apparatus 2c, when communication between transaction processing apparatus 1a and settlement relay center 5 is in the offline state, can send the input settlement information to settlement relay center 5 instead of transaction processing apparatus 1a and can display the screen data that prompts input of the settlement information in a subsequent input process, each time an input process for the settlement information is performed on additional apparatus 2c by the staff member or the customer, and additional apparatus 2c can be used as an input apparatus and a relay apparatus for the settlement information. Additional apparatuses 2ac and 2bc have a role as an input apparatus for the settlement information but do not have a role as a relay apparatus for the settlement information. The same applies hereinafter.

Additional apparatus 2c, in the typical online state, sends to transaction processing apparatus 1a a settlement request that includes the settlement information input in the last input process (reference in the forward direction of instruction FL2 illustrated in FIG. 28 (instruction FL2F illustrated in FIG. 26)). Transaction processing apparatus 1a sends a settlement request to settlement relay center 5 through application BL1 that performs a settlement process in transaction processing apparatus 1a, application BL2 that performs a settlement procedure in communication with settlement relay center 5 or settlement center 6, local-area and wide-range communication switching application BL9, data communication library BL4, and wired network I/F FL3a (reference in the forward direction of instruction FL3a illustrated in FIG. 28 (instruction FL3aR illustrated in FIG. 26)). Settlement relay center 5, in response to the settlement request, performs a settlement process using all of the settlement information sent from transaction processing apparatus 1a and, in a case where the settlement process is normally ended, sends a settlement completion notification indicating the case to transaction processing apparatus 1a. Data indicating the settlement completion notification is sent in the opposite direction to the settlement request (that is, in order of instruction FL3aR and instruction FL2R). Accordingly, transaction processing apparatus 1a, in the typical online state, can obtain the settlement completion notification for settlement using the settlement information that is input by the staff member or the customer into additional apparatus 2c.

Additional apparatus 2c, in the offline state, sends to transaction processing apparatus 1a a settlement request that includes the settlement information input in the last input process (reference in the forward direction of instruction FL2 illustrated in FIG. 28 (instruction FL2F illustrated in FIG. 27)). Transaction processing apparatus 1a sends a settlement request to settlement relay center 5 through application BL1 that performs a settlement process in transaction processing apparatus 1a, application BL2 that performs a settlement procedure in communication with settlement relay center 5 or settlement center 6, local-area and wide-range communication switching application BL9, data communication library BL4, local-area wireless transceiver 51, local-area wireless transceiver 52, data communication library BL7, local-area and wide-range communication application BL8, and wide-range wireless transceiver 50 (reference in the forward direction of instruction FL3b illustrated in FIG. 28 (instruction FL3bF illustrated in FIG. 27)). Settlement relay center 5, in response to the settlement request, performs a settlement process using all of the settlement information sent from additional apparatus 2c and, in a case where the settlement process is normally ended, sends a settlement completion notification indicating the case to additional apparatus 2c. Data indicating the settlement completion notification is sent in the opposite direction to the settlement request (that is, in order of instruction FL3bR and instruction FL2R). Accordingly, additional apparatus 2c can obtain, instead of transaction processing apparatus 1a, a settlement completion notification for settlement using the settlement information that is input into additional apparatus 2c by the staff member or the customer, and can send the settlement completion notification to transaction processing apparatus 1a when communication between transaction processing apparatus 1a and settlement relay center 5 is in the offline state. Instruction FL3aF illustrated in FIG. 26 is in the forward direction of instruction FL3a illustrated in FIG. 28, and instruction FL3aR illustrated in FIG. 26 is in the backward direction of instruction FL3a illustrated in FIG. 28. Instruction FL3bF illustrated in FIG. 27 is in the forward direction of instruction FL3b illustrated in FIG. 28, and instruction FL3bR illustrated in FIG. 27 is in the backward direction of instruction FL3b illustrated in FIG. 28.

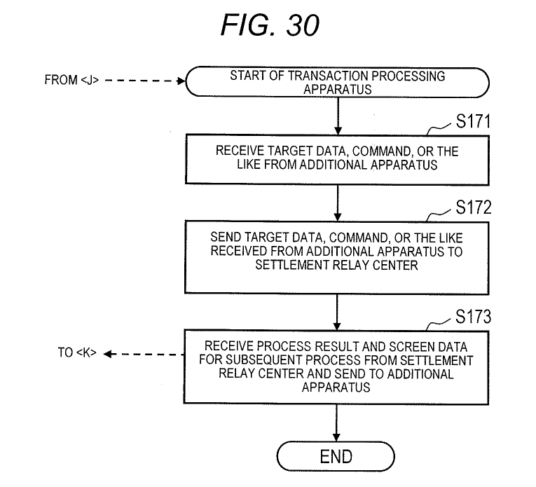

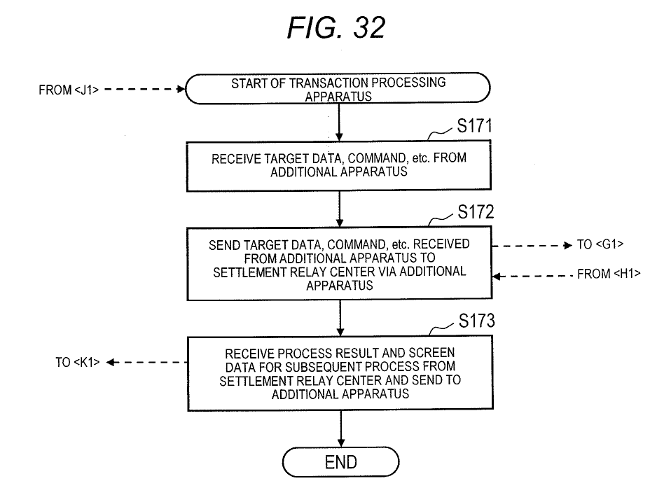

Next, details of operation procedures of transaction processing apparatus 1a and additional apparatuses 2c, 2ac, and 2bc of transaction processing system 10A of the present exemplary embodiment will be described with reference to FIG. 29 to FIG. 33. FIG. 29 is a flowchart describing one example of the process flow of additional apparatuses 2c, 2ac, and 2bc of the fourth exemplary embodiment in the typical online state. FIG. 30 is a flowchart describing one example of the process flow of transaction processing apparatus 1a of the fourth exemplary embodiment in the typical online state. FIG. 31 is a flowchart describing one example of the process flow of additional apparatuses 2ac and 2bc of the fourth exemplary embodiment as an input apparatus for the settlement information in the offline state. FIG. 32 is a flowchart describing one example of an operation procedure of communication between transaction processing apparatus 1a and settlement relay center 5. FIG. 33 is a flowchart describing one example of the process flow of additional apparatus 2c of the fourth exemplary embodiment as a relay apparatus for the settlement information in the offline state.

In FIG. 29 (that is, the typical online state), additional apparatuses 2c, 2ac, and 2bc that have a role as an input apparatus for the settlement information, for example, launch the settlement process application in response to operation by the staff member and display an initial screen of the settlement process application (for example, a screen on which a plurality of menus related to a settlement process is lined up) on display 38 of touch panel TP2 (S151). Additional apparatuses 2c, 2ac, and 2bc send to transaction processing apparatus 1a an obtaining request for the screen data that includes data indicating that the initial screen is displayed and that prompts input of the settlement information corresponding to a subsequent input process (for example, “select brand” in Step S152) (refer to “J” in FIG. 30).

In FIG. 30, by this sending, transaction processing apparatus 1a receives a target data, a command, or the like (for example, the obtaining request described above) sent from additional apparatuses 2c, 2ac, and 2bc (S171) and sends the target data, the command, or the like (for example, the obtaining request described above) to settlement relay center 5 (S172).

Transaction processing apparatus 1a receives response data from settlement relay center 5 and sends the response data to additional apparatuses 2c, 2ac, and 2bc (S173; refer to “K” in FIG. 29). Additional apparatuses 2c, 2ac, and 2bc receive the response data and display on display 38 of touch panel TP2 the screen data that is included in the response data and prompts input of the settlement information in a subsequent input process (for example, “select brand” in Step S152).

By sending in Step S173, regarding “load initial settlement screen” in Step S151 illustrated in FIG. 29, an input process for the settlement information is performed between settlement relay center 5 and additional apparatuses 2c, 2ac, and 2bc through transaction processing apparatus 1 in an order of additional apparatuses 2c, 2ac, and 2bc (refer to FIG. 29)→transaction processing apparatus 1a (refer to FIG. 30)→settlement relay center 5→transaction processing apparatus 1a (refer to FIG. 30)→additional apparatuses 2c, 2ac, and 2bc.

Hereinafter, “select brand” in step S152, “read card number and expiration date” in Step S153, “input sum” in Step S154, “input method of payment and number of times” in Step S155, “input PIN” in Step S156, and “send settlement request” in Step S157 illustrated in FIG. 29 will be performed in the same order described in Step S151.

As described above in the third exemplary embodiment, information related to a card brand of a card (for example, an IC credit card) selected by an input operation of the staff member is input into CPU 22 of additional apparatuses 2c, 2ac, and 2bc in “select brand” (S152), and screen data related to “read card number and expiration date” in Step S153 is displayed on display 38 as a result of the process of Step S152.

Information that is read by contact IC card reader 26 or non-contact IC card reader/writer 28 is input into CPU 22 of additional apparatuses 2c, 2ac, and 2bc in “read card number and expiration date” (S153), and screen data related to “input sum” in Step S154 is displayed on display 38 as a result of the process of Step S153.

Information as to the transaction sum is input into CPU 22 of additional apparatuses 2c, 2ac, and 2bc by an input operation of the staff member in “input sum” (S154), and screen data related to “input method of payment and number of times” in Step S155 is displayed on display 38 as a result of the process of Step S154.

Information as to each of the method of payment and the number of payments is input into CPU 22 of additional apparatuses 2c, 2ac, and 2bc by an input operation of the staff member in “input method of payment and number of times” (S155), and screen data related to “input PIN” in Step S156 is displayed on display 38 as a result of the process of Step S155.

The PIN of the customer is input into CPU 22 of additional apparatuses 2c, 2ac, and 2bc by an input operation of the customer in “input PIN” that is an input process for the settlement information (S156), and screen data related to “settlement request” in Step S157 is displayed on display 38 as a result of the process of Step S156.

A settlement request (settlement process request) is generated by CPU 22 of additional apparatuses 2c, 2ac, and 2bc by an input operation of the staff member in “send settlement request” that is the last input process (S157), “settlement request” is performed in the same order described in Step S151, and additional apparatuses 2c, 2ac, and 2bc receive from transaction processing apparatus 1a a settlement completion notification sent from settlement relay center 5 in a case where settlement is normally ended in settlement relay center 5. In this case, additional apparatuses 2c, 2ac, and 2bc, in response to the settlement completion notification, send to transaction processing apparatus 1a a printing instruction that includes print data of slip copies (for example, a customer copy and a store copy) related to settlement of a transaction using the card (for example, an IC credit card) (S158; refer to “E” in FIG. 23). FIG. 23 will not be described here.

Additional apparatuses 2c, 2ac, and 2bc delete the settlement information (that is, the brand information, the card number, the expiration date, the transaction sum, the method of payment, the number of payments, the PIN, and the settlement request) related to the transaction printed on the slip copies after additional apparatuses 2c, 2ac, and 2bc receive the data of result of printing of the slip copies (S159). A return is made to the process of Step S151 if settlement of a transaction using card CrD (IC credit card) is continued (NO in S160). The flow illustrated in FIG. 29 is ended in a case where settlement of a transaction using card CrD (IC credit card) is not continued (YES in S160).

Next, in FIG. 31 (that is, the offline state), the processes illustrated in FIG. 29 are performed in additional apparatuses 2c, 2ac, and 2bc in the same manner. Thus, FIG. 31 will not be described in detail. When additional apparatuses 2c, 2ac, and 2bc send an obtaining request or a settlement request to transaction processing apparatus 1a in the processes of Step S151 to Step S157 illustrated in FIG. 31, operation of transaction processing apparatus 1a in FIG. 32 is different from operation of transaction processing apparatus 1a in FIG. 30. That is, when transaction processing apparatus 1a receives the obtaining request or the settlement request sent from additional apparatuses 2c, 2ac, and 2bc in the offline state, transaction processing apparatus 1a, in the same manner as the third exemplary embodiment, sends the obtaining request or the settlement request to settlement relay center 5 through additional apparatus 2c that has a role as, for example, a relay apparatus for the settlement information (refer to FIG. 32 and FIG. 33).

Specifically, in FIG. 32, transaction processing apparatus 1a receives a target data, a command, or the like (for example, the obtaining request described above) sent from additional apparatuses 2c, 2ac, and 2bc (S171) and sends the target data, the command, or the like (for example, the obtaining request described above) to settlement relay center 5 via additional apparatus 2c (S272; refer to “G1” in FIG. 33).

In FIG. 33, by this sending, additional apparatus 2c that has a role as a relay apparatus for the settlement information receives the target data, the command, or the like (for example, the obtaining request described above) sent from transaction processing apparatus 1a (S81) and sends the target data, the command, or the like (for example, the obtaining request described above) to settlement relay center 5 (S82). Additional apparatus 2c receives response data (for example, the data indicating that the initial screen is displayed in additional apparatus 2c and the screen data that prompts input of the settlement information corresponding to a subsequent input process (for example, “select brand” in Step S152) in response to the obtaining request described above) from settlement relay center 5 (S83). Additional apparatus 2c sends the response data from settlement relay center 5 to transaction processing apparatus 1a (S84; refer to “H1” in FIG. 32) and deletes the response data after sending (S85).

In transaction processing system 10A of the present exemplary embodiment described heretofore, transaction processing apparatus 1a makes connection related to settlement of a transaction using the IC credit card to settlement relay center 5 to which settlement of a transaction using the IC credit card is connected, and performs a settlement process in a case where communication between transaction processing apparatus 1a and settlement relay center 5 is in a state of availability (typical online state). Transaction processing apparatus 1a, in each input process for a plurality of different settlement information related to a transaction, sends to additional apparatus 2c an obtaining request for a screen that includes any settlement information input and prompts input of the settlement information corresponding to a subsequent input process, in a case where communication between transaction processing apparatus 1a and settlement relay center 5 is in a state of unavailability (offline state). Additional apparatus 2c sends to transaction processing apparatus 1a screen data corresponding to the obtaining request in a case where additional apparatus 2c sends to settlement relay center 5 the obtaining request sent from transaction processing apparatus 1a. Transaction processing apparatus 1a prompts input of the settlement information on the screen data in a case where transaction processing apparatus 1a receives the screen data. Transaction processing apparatus 1a sends to additional apparatus 2c a settlement process request that includes any settlement information input in the last input process. Additional apparatus 2c sends to transaction processing apparatus 1a the settlement completion notification sent from settlement relay center 5 in a case where additional apparatus 2c sends to settlement relay center 5 the settlement process request sent from transaction processing apparatus 1a. Transaction processing apparatus 1a prints slip copies related to a transaction in a case where transaction processing apparatus 1a receives the settlement completion notification.

Accordingly, transaction processing system 10A, in a settlement scheme in which information required for authentication of the IC credit card used in a settlement process is sent and received between the IC credit card and settlement relay center 5, can obtain and display the input screen for the settlement information in each input process for the settlement information by using additional apparatus 2c as an input apparatus for the settlement information in communication between transaction processing apparatus 1a and settlement relay center 5 either in the typical online state or in the offline state including when a line to settlement relay center 5 is unavailable and when a failure occurs, and thus smoothly and accurately performs settlement using the IC credit card while confirming the settlement using the IC credit card in order, and can use additional apparatuses 2c, 2ac, and 2bc as a replacement as, for example, an input apparatus for the settlement information. Transaction processing system 10A, in the offline state including when a line to settlement relay center 5 is unavailable and when a failure occurs, may not use settlement by the magnetic credit card function that uses information recorded in the magnet stripe of the IC credit card, or can use settlement by the IC credit card function. Thus, degradation of security of the authentication information of the customer can be prevented.

In transaction processing system 10A, for example, the brand information of the IC credit card, the transaction sum, the method of payment, the number of payments, and the authentication information of the customer are input as the settlement information by additional apparatuses 2c, 2ac, and 2bc. The card number and the expiration date of the IC credit card are read by additional apparatuses 2c, 2ac, and 2bc from the IC credit card. Transaction processing apparatus 1a sends a printing completion notification for slip copies to additional apparatuses 2c, 2ac, and 2bc. Additional apparatuses 2c, 2ac, and 2bc delete the brand information, the card number, and the expiration date of the IC credit card, the transaction sum, the method of payment, the number of payments, and the authentication information of the customer after additional apparatuses 2c, 2ac, and 2bc receive the printing completion notification.

Accordingly, transaction processing system 10A can temporarily use additional apparatuses 2c, 2ac, and 2bc as settlement means that replaces transaction processing apparatus 1a (that is, an input tool for input of the transaction settlement information and a wide-range wireless communication tool for communication with settlement relay center 5) either in the typical online state or in the offline state including when a line between transaction processing apparatus 1a and settlement relay center 5 is unavailable and when a failure occurs. Furthermore, a printing completion notification for slip copies that indicates that settlement of a transaction using the IC credit card is normally ended allows transaction processing system 10A to delete the transaction settlement information remaining in additional apparatuses 2c, 2ac, and 2bc. Thus, security of personal information of a settlement target customer can be securely guaranteed when, for example, an application for general purposes other than settlement (for example, a mail application and a website browsing application) is used.

In transaction processing system 10A, for example, the brand information of the IC credit card, the transaction sum, the method of payment, the number of payments, and the authentication information of the customer are input as the settlement information by transaction processing apparatus 1a. The card number and the expiration date of the IC credit card are read by transaction processing apparatus 1a from the IC credit card. Transaction processing apparatus 1a deletes the brand information, the card number, and the expiration date of the IC credit card, the transaction sum, the method of payment, the number of payments, and the authentication information of the customer after transaction processing apparatus 1a prints slip copies.

Accordingly, transaction processing system 10A can temporarily use additional apparatuses 2c, 2ac, and 2bc as settlement means that replaces transaction processing apparatus 1 (that is, a wide-range wireless communication tool for communication with settlement relay center 5) in the offline state including when a line between transaction processing apparatus 1a and settlement relay center 5 is unavailable and when a failure occurs. Furthermore, a printing completion notification for slip copies that indicates that settlement of a transaction using the IC credit card is normally ended allows transaction processing system 10A to delete the transaction settlement information remaining in transaction processing apparatus 1a. Thus, security of personal information of a settlement target customer can be securely guaranteed.

In transaction processing system 10A, for example, the brand information of the IC credit card, the transaction sum, the method of payment, and the number of payments are input as the settlement information by additional apparatuses 2c, 2ac, and 2bc. The authentication information of the customer is input by transaction processing apparatus 1a. The card number and the expiration date of the IC credit card are read by transaction processing apparatus 1a from the IC credit card. Transaction processing apparatus 1a sends a printing completion notification for slip copies to additional apparatuses 2c, 2ac, and 2bc. Additional apparatuses 2c, 2ac, and 2bc delete the brand information of the IC credit card, the transaction sum, the method of payment, and the number of payments after additional apparatuses 2c, 2ac, and 2bc receive the printing completion notification.

Accordingly, transaction processing system 10A can temporarily use additional apparatuses 2c, 2ac, and 2bc as settlement means that replaces transaction processing apparatus 1a (that is, an input tool for input of a part of the transaction settlement information and a wide-range wireless communication tool for communication with settlement relay center 5) either in the typical online state or in the offline state including when a line between transaction processing apparatus 1a and settlement relay center 5 is unavailable and when a failure occurs. Furthermore, a printing completion notification for slip copies that indicates that settlement of a transaction using the IC credit card is normally ended allows transaction processing system 10A to delete the transaction settlement information remaining in additional apparatuses 2c, 2ac, and 2bc. Thus, security of personal information of a settlement target customer can be securely guaranteed when, for example, an application for general purposes other than settlement (for example, a mail application and a website browsing application) is used.

Transaction processing apparatus 1a of the present exemplary embodiment, in a case where, for example, communication between transaction processing apparatus 1a and settlement relay center 5 is in a state of unavailability (offline state), sends to additional apparatus 2c, in each input process for the settlement information, an obtaining request for the screen data that includes any settlement information input and prompts input of the settlement information corresponding to a subsequent input process, and sends to additional apparatus 2c a settlement process request that includes any settlement information input in the last input process. Transaction processing apparatus 1a prompts input of the settlement information on the screen data in a case where transaction processing apparatus 1a receives the screen data, and prints slip copies (for example, a customer copy and a store copy related to settlement of a transaction using the IC credit card) related to a transaction in a case where transaction processing apparatus 1a receives a settlement completion notification for a transaction.

Accordingly, transaction processing apparatus 1a, in a settlement scheme in which information required for authentication of the IC credit card is sent and received between the IC credit card and settlement relay center 5, can obtain and display the input screen for the settlement information in each input process for the settlement information by using additional apparatuses 2c, 2ac, and 2bc in communication between transaction processing apparatus 1a and settlement relay center 5 in the offline state including when a line to settlement relay center 5 is unavailable and when a failure occurs, and thus has a simple apparatus configuration of a thin client type and smoothly and accurately performs settlement using the IC credit card while confirming the settlement using the IC credit card in order.

Additional apparatus 2c of the present exemplary embodiment, in each input process for a plurality of different settlement information related to a transaction, sends to settlement relay center 5 an obtaining request for the screen data that includes any settlement information input and prompts input of the settlement information corresponding to a subsequent input process, and sends to settlement relay center 5 a settlement process request that includes any settlement information input in the last input process. Additional apparatus 2c sends to transaction processing apparatus 1a screen data corresponding to the obtaining request in a case where additional apparatus 2c sends to settlement relay center 5 the obtaining request sent from transaction processing apparatus 1a, and sends to transaction processing apparatus 1a a settlement completion notification sent from settlement relay center 5 in a case where additional apparatus 2c sends to settlement relay center 5 the settlement process request sent from transaction processing apparatus 1a.

Accordingly, additional apparatus 2c not only can use an application for general purposes other than settlement (for example, a mail application and a website browsing application) but also can be temporarily used as settlement means (that is, an input tool for input of the transaction settlement information and a wide-range wireless communication tool for communication with settlement relay center 5) that replaces transaction processing apparatus 1 related to settlement of a transaction using the IC credit card.

The fourth exemplary embodiment described above is described on the assumption that communication between an additional apparatus (for example, additional apparatus 2c) and settlement relay center 5 is available in the offline state. However, when transaction processing apparatuses 1 and 1a are settlement terminal apparatuses of thin client types, settlement processes cannot be performed between transaction processing apparatuses 1 and 1a and settlement relay center 5 or settlement center 6 in a case where communication between the additional apparatus (for example, additional apparatus 2c) and settlement relay center 5 is unavailable (hereinafter, referred to as “extended offline state”) in addition to the offline state in the fourth exemplary embodiment. In this case, offline settlement is required to be performed between transaction processing apparatus 1b of a rich client type and card CrD (for example, an IC credit card) to the extent, for example, not exceeding the upper limit determined by the contract between the acquirer and the franchise.

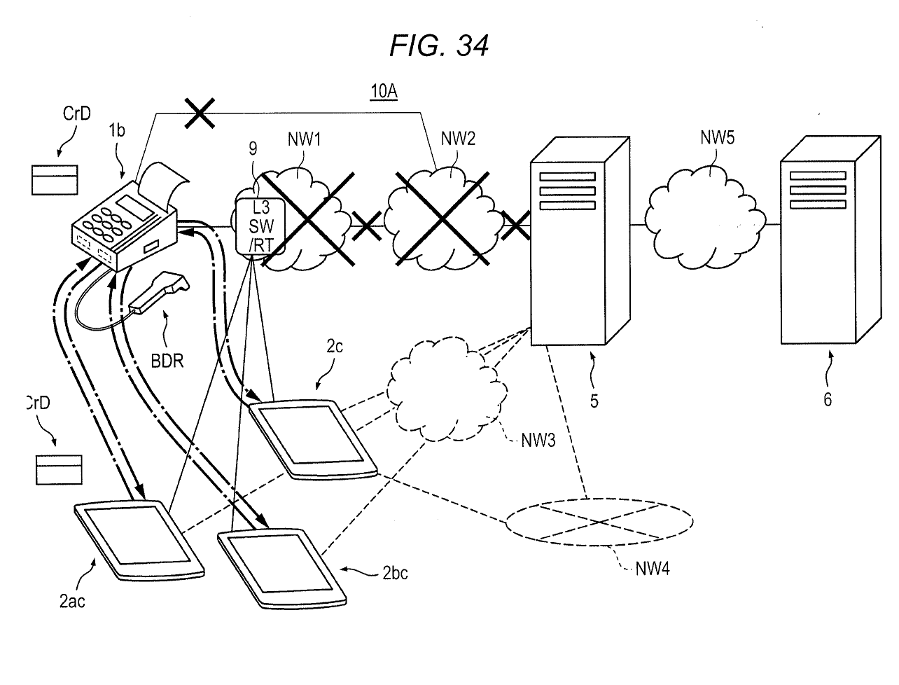

Therefore, an example of transaction processing system 10A that performs offline settlement between transaction processing apparatus 1b and card CrD (for example, an IC credit card) in the extended offline state where all communication with settlement relay center 5 is unavailable will be described with reference to FIG. 34 and the subsequent drawings. An internal configuration of transaction processing apparatus 1b is the same as the internal configuration of transaction processing apparatus 1 illustrated in FIG. 2 and thus will not be described in detail.

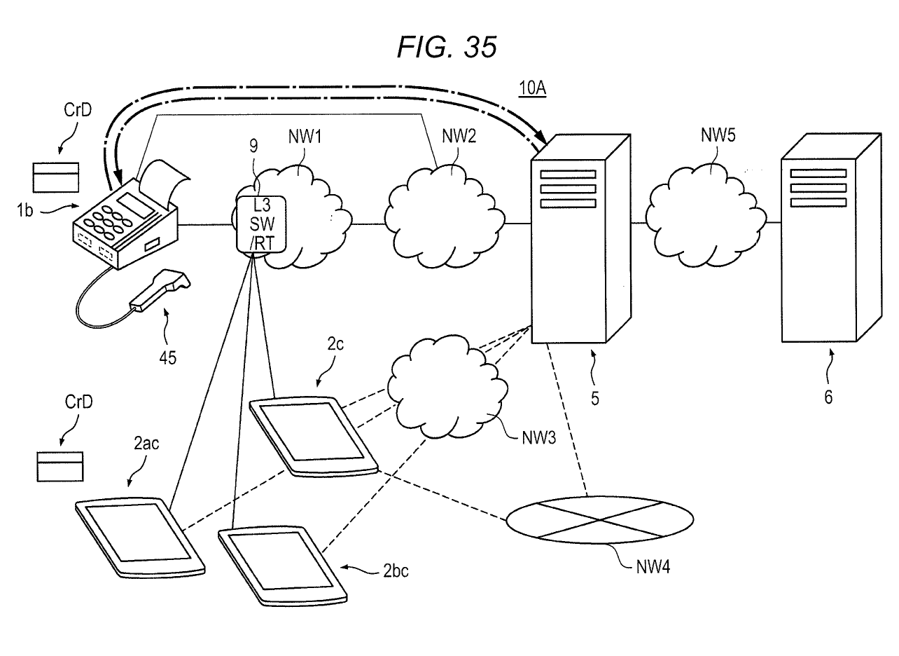

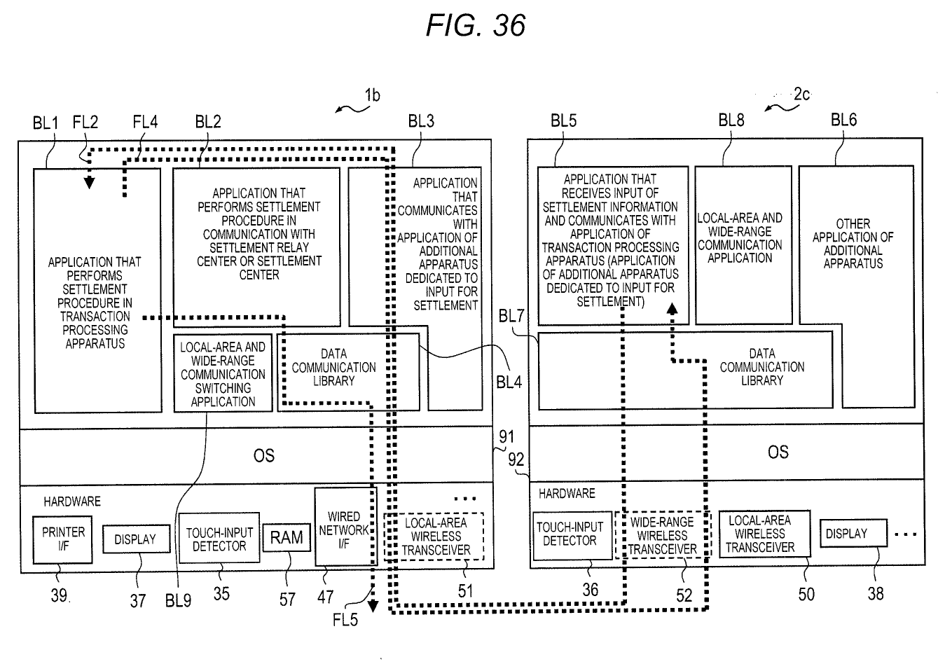

FIG. 34 is a diagram illustrating one example of a connection path of transaction processing apparatus 1b and additional apparatuses 2c, 2ac, and 2bc in a case where a tanking process is performed in the extended offline state. FIG. 35 is a diagram illustrating one example of a connection path of transaction processing apparatus 1b, additional apparatuses 2c, 2ac, and 2bc, and settlement relay center 5 after restoration to the typical online state is made. FIG. 36 is a diagram illustrating one example of a software block configuration of transaction processing apparatus 1b and additional apparatuses 2 and 2c of the fourth exemplary embodiment in a case where a tanking process is performed in the offline state.

In FIG. 36, only a part of each unit illustrated in FIG. 2 is illustrated as hardware of transaction processing apparatus 1b, and not all of the hardware is illustrated. Similarly, only a part of each unit illustrated in FIG. 3 is illustrated as hardware of additional apparatus 2c, and not all of the hardware is illustrated. Furthermore, the same content as in the description of FIG. 4, FIG. 18, or FIG. 28 will not be described in description of FIG. 36, and different contents will be described.

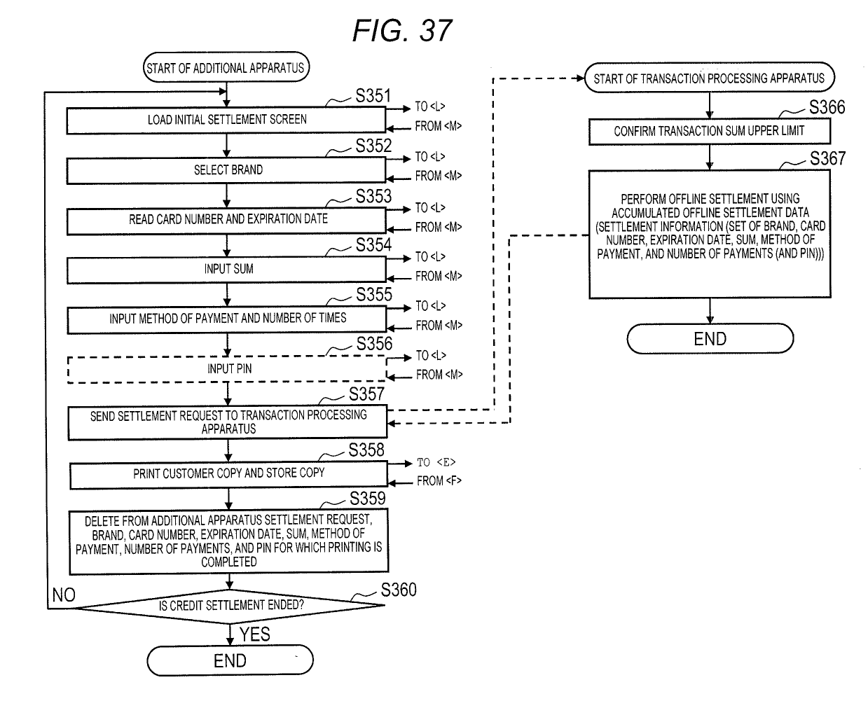

An input process for information required for settlement of a transaction (settlement information) is performed in, for example, additional apparatus 2c by instruction FL1 (refer to FIG. 4; that is, reference in the backward direction of instruction FL2 illustrated in FIG. 28) from transaction processing apparatus 1b in the extended offline state illustrated in FIG. 36 (refer to FIG. 37).

In FIG. 36, additional apparatus 2c sends to transaction processing apparatus 1b an obtaining request for screen data that includes the settlement information and prompts input of the settlement information in a subsequent input process, each time an input process is performed (reference in the forward direction of instruction FL2 illustrated in FIG. 36). Transaction processing apparatus 1b, in the extended offline state, sends to additional apparatus 2c response data with respect to an obtaining request in each input process (that is, a reception response (process result) indicating that the settlement information is input in response to the obtaining request in each input process and the screen data that prompts input of the requested settlement information in a subsequent input process) through application BL1 that performs a settlement process in transaction processing apparatus 1b, application BL3 that communicates with an application of additional apparatus 2c dedicated to input for settlement, data communication library BL4, local-area wireless transceiver 51, local-area wireless transceiver 52, data communication library BL7, and application BL5 (the application of additional apparatus 2c dedicated to input for settlement) that receives input of the settlement information and communicates with an application of transaction processing apparatus 1b (reference in the forward direction of instruction FL4 illustrated in FIG. 36). Accordingly, additional apparatus 2c, in the extended offline state, can send the input settlement information to transaction processing apparatus 1b each time an input process for the settlement information is performed on additional apparatus 2c by the staff member or the customer, and can display the screen data that prompts input of the settlement information in a subsequent input process, and additional apparatus 2c can be used as an input apparatus for the settlement information.

Additional apparatus 2c, in the extended offline state, sends to transaction processing apparatus 1b a settlement request that includes the settlement information input in the last input process (reference in the forward direction of instruction FL2 illustrated in FIG. 36). Transaction processing apparatus 1b, similarly (reference in the forward direction of instruction FL4 illustrated in FIG. 36), performs offline settlement in response to the settlement request to the extent not exceeding a transaction sum upper limit (the upper limit of the offline settlement sum in the offline state) that is determined in advance by the contract between the acquirer and the franchise. Transaction processing apparatus 1b, in a case where offline settlement is normally ended as a result, sends a settlement completion notification indicating the case to additional apparatus 2c. Accordingly, additional apparatus 2c, in the extended offline state, can obtain the settlement completion notification for settlement using the settlement information that is input by the staff member or the customer into additional apparatus 2c.

Transaction processing apparatus 1b, in a case where restoration is made from the extended offline state to the typical online state, sends data of the result of tanking in the extended offline state to settlement relay center 5 or settlement center 6 through application BL1 that performs a settlement process in transaction processing apparatus 1b, application BL2 that performs a settlement procedure in communication with settlement relay center 5 or settlement center 6, data communication library BL4, and wired network I/F 47 (reference in the forward direction of instruction FL5 illustrated in FIG. 36).

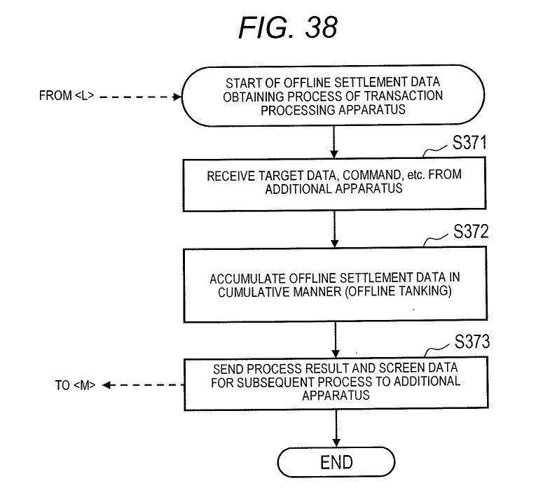

Next, details of operation procedures of transaction processing apparatus 1b and additional apparatus 2c of transaction processing system 10A of the present exemplary embodiment will be described with reference to FIG. 37 and FIG. 38. FIG. 37 is a flowchart describing one example of an operation procedure of additional apparatus 2c and transaction processing apparatus 1b of the fourth exemplary embodiment in a case where a tanking process is performed in the extended offline state. FIG. 38 is a flowchart describing one example of an operation procedure of transaction processing apparatus 1b of the fourth exemplary embodiment in a case where a tanking process is performed in the extended offline state.

In FIG. 37 (that is, the extended offline state), additional apparatuses 2c, 2ac, and 2bc that have a role as an input apparatus for the settlement information, for example, launch the settlement process application in response to operation by the staff member and display an initial screen of the settlement process application (for example, a screen on which a plurality of menus related to a settlement process is lined up) on display 38 of touch panel TP2 (S351). Additional apparatuses 2c, 2ac, and 2bc send to transaction processing apparatus 1b an obtaining request for the screen data that includes data indicating that the initial screen is displayed and that prompts input of the settlement information corresponding to a subsequent input process (for example, “select brand” in Step S352) (refer to “L” in FIG. 38).

In FIG. 38, by this sending, transaction processing apparatus 1b receives a target data, a command, or the like (for example, the obtaining request described above) sent from additional apparatuses 2c, 2ac, and 2bc (S371) and accumulates the target data, the command, or the like (for example, the obtaining request described above) in a cumulative manner as offline settlement data (offline tanking) (S372).

Transaction processing apparatus 1b, after offline tanking is performed, sends response data (for example, the screen data that prompts input of the settlement information corresponding to a subsequent input process (for example, “select brand” in Step S352) in response to the obtaining request described above) to additional apparatuses 2c, 2ac, and 2bc (S373; refer to “M” in FIG. 37). Additional apparatuses 2c, 2ac, and 2bc receive the response data and display on display 38 of touch panel TP2 the screen data that is included in the response data and prompts input of the settlement information in a subsequent input process (for example, “select brand” in Step S352).

By sending in Step S373, regarding “load initial settlement screen” in Step S351 illustrated in FIG. 37, an input process for the settlement information is directly performed between transaction processing apparatus 1b and additional apparatuses 2c, 2ac, and 2bc in an order of additional apparatuses 2c, 2ac, and 2bc (refer to FIG. 37)→transaction processing apparatus 1b (refer to FIG. 37)→additional apparatuses 2c, 2ac, and 2bc.

Hereinafter, “select brand” in step S352, “read card number and expiration date” in Step S353, “input sum” in Step S354, “input method of payment and number of times” in Step S355, “input PIN” in Step S356, and “send settlement request” in Step S357 illustrated in FIG. 37 will be performed in the same order described in Step S351.

As described above in the third exemplary embodiment, information related to a card brand of a card (for example, an IC credit card) selected by an input operation of the staff member is input into CPU 22 of additional apparatuses 2c, 2ac, and 2bc in “select brand” (S352), and screen data related to “read card number and expiration date” in Step S353 is displayed on display 38 as a result of the process of Step S352.

Information that is read by contact IC card reader 26 or non-contact IC card reader/writer 28 is input into CPU 22 of additional apparatuses 2c, 2ac, and 2bc in “read card number and expiration date” (S353), and screen data related to “input sum” in Step S354 is displayed on display 38 as a result of the process of Step S353.

Information as to the transaction sum is input into CPU 22 of additional apparatuses 2c, 2ac, and 2bc by an input operation of the staff member in “input sum” (S354), and screen data related to “input method of payment and number of times” in Step S355 is displayed on display 38 as a result of the process of Step S354.

Information as to each of the method of payment and the number of payments is input into CPU 22 of additional apparatuses 2c, 2ac, and 2bc by an input operation of the staff member in “input method of payment and number of times” (S355), and screen data related to “input PIN” in Step S356 is displayed on display 38 as a result of the process of Step S355.

The PIN of the customer is input into CPU 22 of additional apparatuses 2c, 2ac, and 2bc by an input operation of the customer in “input PIN” that is an input process for the settlement information (S356), and screen data related to “settlement request” in Step S357 is displayed on display 38 as a result of the process of Step S356.

When a settlement request (settlement process request) is generated by CPU 22 of additional apparatuses 2c, 2ac, and 2bc by an input operation of the staff member in “send settlement request” that is the last input process (S357), transaction processing apparatus 1b confirms whether or not the transaction sum sent in Step S354 exceeds the transaction sum upper limit described above (S366). Transaction processing apparatus 1b performs offline settlement in a case where the transaction sum is determined not to exceed the transaction sum upper limit (S367). Transaction processing apparatus 1b sends a settlement completion notification for the offline settlement to additional apparatuses 2c, 2ac, and 2bc in a case where the offline settlement is normally ended. In this case, additional apparatuses 2c, 2ac, and 2bc, in response to the settlement completion notification, send to transaction processing apparatus 1b a printing instruction that includes print data of slip copies (for example, a customer copy and a store copy) related to settlement of a transaction using the card (for example, an IC credit card) (S358; refer to “E” in FIG. 23). FIG. 23 will not be described here.

Additional apparatuses 2c, 2ac, and 2bc delete the settlement information (that is, the brand information, the card number, the expiration date, the transaction sum, the method of payment, the number of payments, the PIN, and the settlement request) related to the transaction printed on the slip copies after additional apparatuses 2c, 2ac, and 2bc receive the data of result of printing of the slip copies (S359). A return is made to the process of Step S351 if settlement of a transaction using card CrD (IC credit card) is continued (NO in S360). The flow illustrated in FIG. 37 is ended in a case where settlement of a transaction using card CrD (IC credit card) is not continued (YES in S360).

Transaction processing apparatus 1b, in a case where restoration is made from the extended offline state to the typical online state, sends to settlement relay center 5 or settlement center 6 a request for sales registration that includes the offline settlement data subjected to offline tanking in Step S372 and a process result of the offline settlement (refer to FIG. 16).

In transaction processing system 10A of the present exemplary embodiment described heretofore, transaction processing apparatus 1b, in the extended offline state, accumulates obtaining requests sent from additional apparatuses 2c, 2ac, and 2bc and performs offline settlement with card CrD (for example, an IC credit card) in a case where the transaction sum is determined not to exceed the transaction sum upper limit that is determined in advance by the contract between the acquirer and the franchise. Transaction processing apparatus 1b prints slip copies related to a transaction after the offline settlement is performed.

Accordingly, transaction processing apparatus 1b can perform offline settlement using card CrD to the extent not exceeding the transaction sum upper limit in the extended offline state where communication between transaction processing apparatus 1b and settlement relay center 5 and communication between settlement relay center 5 and additional apparatuses 2c, 2ac, and 2bc are unavailable, and thus can reduce loss of purchase opportunities for the customer. Accordingly, the franchise can reduce a decrease in sales, and the acquirer can reduce a decrease in income based on sales of the franchise.

In transaction processing system 10A of the present exemplary embodiment, transaction processing apparatus 1b requests settlement relay center 5 to perform sales registration for the offline settlement using the accumulated offline settlement data in a case where communication between transaction processing apparatus 1b and settlement relay center 5 is restored to the typical online state.

Accordingly, transaction processing system 10A can perform, in settlement relay center 5, a sales registration process for offline settlement performed in the offline state, in a case where communication between transaction processing apparatus 1b and settlement relay center 5 is restored to the typical online state.

While various embodiments have been heretofore described with reference to the drawings, it is needless to say that the present disclosure is not limited to such examples. It is apparent that those skilled in the related art may perceive various modification examples and correction examples within the scope disclosed in the claims, and it is understood that those modification examples and correction examples apparently fall within the technical scope of the present disclosure.

While a settlement process using a credit card (more specifically, a magnetic credit card, a contact IC credit card, or a non-contact IC credit card) is described as one example of a card transaction of a purchaser in the present exemplary embodiment described above, the present disclosure is not limited to a settlement process using a credit card and may be applied to a settlement process using, for example, a debit card, electronic money, a prepaid card, a postpaid card, a point card, an electronic coupon, and an electronic gift voucher.

Lastly, a summary of the present disclosure will be described.

A transaction processing system of the present disclosure includes a settlement-side apparatus to which settlement of a transaction using a card is connected, a transaction processing apparatus of a thin client that makes connection related to settlement of a transaction using the card to the settlement-side apparatus, and a transaction communication terminal that is connectable to the transaction processing apparatus and the settlement-side apparatus and makes connection related to settlement of a transaction using the card to the settlement-side apparatus. The transaction communication terminal sends to the transaction processing apparatus transaction settlement information that includes brand information, a card number, and an expiration date of the card, a transaction sum, a method of payment, and the number of payments which are input. The transaction processing apparatus receives the transaction settlement information sent from the transaction communication terminal and sends to the settlement-side apparatus a settlement request that includes the received transaction settlement information. The transaction processing apparatus prints a predetermined slip copy in a case where the settlement request including the transaction settlement information is sent to the settlement-side apparatus.

A transaction processing system of the present disclosure includes a transaction processing apparatus of a thin client that makes connection related to settlement of a transaction using an IC card to a settlement-side apparatus to which settlement of a transaction using the IC card having a card number and an expiration date is connected, and that performs settlement of a transaction with the settlement-side apparatus by authentication of the IC card by the settlement-side apparatus, and a transaction communication terminal of a portable type that is connectable to the transaction processing apparatus and into which brand information, the card number, and the expiration date of the IC card, a transaction sum, a method of payment, and the number of payments are input. The transaction communication terminal sends to the transaction processing apparatus transaction settlement information that includes brand information, a card number, and an expiration date of the IC card, a transaction sum, a method of payment, and the number of payments which are input. The transaction processing apparatus receives the transaction settlement information sent from the transaction communication terminal and sends to the settlement-side apparatus a settlement request that includes the received transaction settlement information. The transaction processing apparatus prints a customer copy and a store copy in a case where the settlement request including the transaction settlement information is sent to the settlement-side apparatus.

In the transaction processing system of the present disclosure, the transaction processing apparatus may send a printing completion notification for the predetermined slip copy to the transaction communication terminal. The transaction communication terminal may delete the brand information, the card number, and the expiration date of the card, the transaction sum, the method of payment, and the number of payments after the printing completion notification is received.

In the transaction processing system of the present disclosure, the transaction processing apparatus may include a storage unit, accumulate the transaction settlement information in the storage unit in a case where communication between the transaction processing apparatus and the settlement-side apparatus is in a state of unavailability, and print the predetermined slip copy after conditional settlement using the transaction settlement information is performed with the card.

In the transaction processing system of the present disclosure, the transaction processing apparatus may request the settlement-side apparatus to perform sales registration for the conditional settlement using the transaction settlement information accumulated in the storage unit in a case where communication between the transaction processing apparatus and the settlement-side apparatus is placed into a state of availability.

A transaction processing method of the present disclosure is a transaction processing method in a transaction processing system to which a settlement-side apparatus, a transaction processing apparatus of a thin client, and a transaction communication terminal are connected. The transaction communication terminal performs a step of receiving input of the transaction settlement information that includes brand information, a card number, and an expiration date of a card used in settlement of a transaction, a transaction sum, a method of payment, and the number of payments. The transaction communication terminal performs a step of sending the input transaction settlement information to the transaction processing apparatus. The transaction processing apparatus performs a step of receiving the transaction settlement information sent from the transaction communication terminal and sending to the settlement-side apparatus a settlement request that includes the received transaction settlement information. The transaction processing apparatus performs a step of printing a predetermined slip copy in a case where the settlement request including the transaction settlement information is sent to the settlement-side apparatus.

A transaction processing apparatus of the present disclosure includes a first transceiver that makes connection related to settlement of a transaction using a card to a settlement-side apparatus to which settlement of a transaction using the card is connected, a second transceiver that communicates with a transaction communication terminal of a portable type, an obtainer that obtains through the second transceiver transaction settlement information which includes brand information, a card number, and an expiration date of the card, a transaction sum, a method of payment, and the number of payments input by the transaction communication terminal, and a printing unit that prints a predetermined slip copy. The first transceiver sends to the settlement-side apparatus a settlement request that includes the transaction settlement information obtained by the obtainer, and the printing unit prints the predetermined slip copy in a case where the settlement request including the transaction settlement information is sent to the settlement-side apparatus.

A transaction communication terminal of the present disclosure includes a third transceiver that communicates with a transaction processing apparatus which makes connection related to settlement of a transaction using a card to a settlement-side apparatus to which settlement of a transaction using the card is connected, and an input into which transaction settlement information that includes brand information, a card number, and an expiration date of the card, a transaction sum, a method of payment, and the number of payments is input. The third transceiver sends the transaction settlement information input by the input to the transaction processing apparatus and, in a case where a settlement request that includes the transaction settlement information is sent from the transaction processing apparatus to the settlement-side apparatus, receives a printing completion notification for a predetermined slip copy that is printed by the transaction processing apparatus.

A transaction processing system of the present disclosure includes a settlement-side apparatus to which settlement of a transaction using a card is connected, a transaction processing apparatus of a thin client that makes connection related to settlement of a transaction using the card to the settlement-side apparatus, and a transaction communication terminal that is connectable to the transaction processing apparatus and the settlement-side apparatus and makes connection related to settlement of a transaction using the card to the settlement-side apparatus. The transaction communication terminal sends to the transaction processing apparatus transaction settlement information that includes brand information, a card number, and an expiration date of the card, a transaction sum, a method of payment, and the number of payments which are input. The transaction processing apparatus receives the transaction settlement information sent from the transaction communication terminal and sends to the settlement-side apparatus a settlement request that includes the received transaction settlement information. The transaction processing apparatus prints a predetermined slip copy in a case where the settlement request including the transaction settlement information is sent to the settlement-side apparatus.

A transaction processing system of the present disclosure includes a transaction processing apparatus of a thin client that makes connection related to settlement of a transaction using an IC card to a settlement-side apparatus to which settlement of a transaction using the IC card having a card number and an expiration date is connected, and that performs settlement of a transaction with the settlement-side apparatus by authentication of the IC card by the settlement-side apparatus, and a transaction communication terminal of a portable type that is connectable to the transaction processing apparatus and into which brand information, the card number, and the expiration date of the IC card, a transaction sum, a method of payment, and the number of payments are input. The transaction communication terminal sends to the transaction processing apparatus transaction settlement information that includes brand information, a card number, and an expiration date of the IC card, a transaction sum, a method of payment, and the number of payments which are input. The transaction processing apparatus receives the transaction settlement information sent from the transaction communication terminal and sends to the settlement-side apparatus a settlement request that includes the received transaction settlement information. The transaction processing apparatus prints a customer copy and a store copy in a case where the settlement request including the transaction settlement information is sent to the settlement-side apparatus.

In the transaction processing system of the present disclosure, the transaction processing apparatus may send a printing completion notification for the predetermined slip copy to the transaction communication terminal. The transaction communication terminal may delete the brand information, the card number, and the expiration date of the card, the transaction sum, the method of payment, and the number of payments after the printing completion notification is received.

In the transaction processing system of the present disclosure, the transaction processing apparatus may include a storage unit, accumulate the transaction settlement information in the storage unit in a case where communication between the transaction processing apparatus and the settlement-side apparatus is in a state of unavailability, and print the predetermined slip copy after conditional settlement using the transaction settlement information is performed with the card.

In the transaction processing system of the present disclosure, the transaction processing apparatus may request the settlement-side apparatus to perform sales registration for the conditional settlement using the transaction settlement information accumulated in the storage unit in a case where communication between the transaction processing apparatus and the settlement-side apparatus is placed into a state of availability.

A transaction processing method of the present disclosure is a transaction processing method in a transaction processing system to which a settlement-side apparatus, a transaction processing apparatus of a thin client, and a transaction communication terminal are connected. The transaction communication terminal performs a step of receiving input of the transaction settlement information that includes brand information, a card number, and an expiration date of a card used in settlement of a transaction, a transaction sum, a method of payment, and the number of payments. The transaction communication terminal performs a step of sending the input transaction settlement information to the transaction processing apparatus. The transaction processing apparatus performs a step of receiving the transaction settlement information sent from the transaction communication terminal and sending to the settlement-side apparatus a settlement request that includes the received transaction settlement information. The transaction processing apparatus performs a step of printing a predetermined slip copy in a case where the settlement request including the transaction settlement information is sent to the settlement-side apparatus.

A transaction processing apparatus of the present disclosure includes a first transceiver that makes connection related to settlement of a transaction using a card to a settlement-side apparatus to which settlement of a transaction using the card is connected, a second transceiver that communicates with a transaction communication terminal of a portable type, an obtainer that obtains through the second transceiver transaction settlement information which includes brand information, a card number, and an expiration date of the card, a transaction sum, a method of payment, and the number of payments input by the transaction communication terminal, and a printing unit that prints a predetermined slip copy. The first transceiver sends to the settlement-side apparatus a settlement request that includes the transaction settlement information obtained by the obtainer, and the printing unit prints the predetermined slip copy in a case where the settlement request including the transaction settlement information is sent to the settlement-side apparatus.

A transaction communication terminal of the present disclosure includes a third transceiver that communicates with a transaction processing apparatus which makes connection related to settlement of a transaction using a card to a settlement-side apparatus to which settlement of a transaction using the card is connected, and an input into which transaction settlement information that includes brand information, a card number, and an expiration date of the card, a transaction sum, a method of payment, and the number of payments is input. The third transceiver sends the transaction settlement information input by the input to the transaction processing apparatus and, in a case where a settlement request that includes the transaction settlement information is sent from the transaction processing apparatus to the settlement-side apparatus, receives a printing completion notification for a predetermined slip copy that is printed by the transaction processing apparatus.

A transaction processing system of the present disclosure includes a settlement-side apparatus to which settlement of a transaction using an IC card is connected, a transaction processing apparatus that makes connection related to settlement of a transaction using the IC card to the settlement-side apparatus, and a transaction communication terminal that is connectable to the transaction processing apparatus and the settlement-side apparatus and makes connection related to settlement of a transaction using the IC card to the settlement-side apparatus. The transaction processing apparatus, in each input process for a plurality of different settlement information related to the transaction, sends any of the input settlement information to the transaction communication terminal in a case where communication between the transaction processing apparatus and the settlement-side apparatus is in a state of unavailability, and sends to the transaction communication terminal a settlement process request that includes any of the settlement information input in the last input process. The transaction communication terminal, in a case where the settlement information sent from the transaction processing apparatus is sent to the settlement-side apparatus, sends to the transaction processing apparatus a screen that prompts input of the settlement information corresponding to the subsequent input process, and in a case where the settlement process request sent from the transaction processing apparatus is sent to the settlement-side apparatus, sends to the transaction processing apparatus a settlement completion notification that is sent from the settlement-side apparatus. The transaction processing apparatus prints a slip copy related to a transaction in a case where the settlement completion notification is received.

In the transaction processing system of the present disclosure, the settlement information may include at least brand information, a card number, and an expiration date of the IC card, a transaction sum, a method of payment, the number of payments, and authentication information of a customer. The brand information, the card number, and the expiration date of the IC card, the transaction sum, the method of payment, the number of payments, and the authentication information of the customer may be input by the transaction communication terminal. The transaction processing apparatus may send a printing completion notification for the slip copy to the transaction communication terminal. The transaction communication terminal may delete at least one of the brand information, the card number, and the expiration date of the IC card, the transaction sum, the method of payment, the number of payments, and the authentication information of the customer after the printing completion notification is received.

In the transaction processing system of the present disclosure, the settlement information may include at least brand information, a card number, and an expiration date of the IC card, a transaction sum, a method of payment, the number of payments, and authentication information of a customer. The brand information, the card number, and the expiration date of the IC card, the transaction sum, the method of payment, the number of payments, and the authentication information of the customer are input by the transaction processing apparatus. The transaction processing apparatus may delete at least one of the brand information, the card number, and the expiration date of the IC card, the transaction sum, the method of payment, the number of payments, and the authentication information of the customer after the slip copy is printed.

In the transaction processing system of the present disclosure, the settlement information may include at least brand information, a card number, and an expiration date of the IC card, a transaction sum, a method of payment, the number of payments, and authentication information of a customer. First settlement information that is configured of a part of the settlement information may be input by the transaction communication terminal. Second settlement information that is configured of information other than the first settlement information in the settlement information may be input by the transaction processing apparatus. The transaction processing apparatus may send a printing completion notification for the slip copy to the transaction communication terminal. The transaction communication terminal may delete at least one in the first settlement information after the printing completion notification is received. The transaction processing apparatus may delete at least one in the second settlement information after the slip copy is printed.

In the transaction processing system of the present disclosure, the settlement information may include at least brand information, a card number, and an expiration date of the IC card, a transaction sum, a method of payment, the number of payments, and authentication information of a customer. The brand information of the IC card, the transaction sum, the method of payment, and the number of payments may be input by the transaction communication terminal. The card number and the expiration date and the authentication information of the customer may be input by the transaction processing apparatus. The transaction processing apparatus may send a printing completion notification for the slip copy to the transaction communication terminal. The transaction communication terminal may delete the brand information of the IC card, the transaction sum, the method of payment, and the number of payments after the printing completion notification is received. The transaction processing apparatus may delete the card number and the expiration date of the IC card and the authentication information of the customer after the slip copy is printed.

A transaction processing method of the present disclosure is a transaction processing method in a transaction processing system to which a settlement-side apparatus, a transaction processing apparatus of a thin client, and a transaction communication terminal are connected. The transaction processing apparatus, in a case where communication between the transaction processing apparatus and the settlement-side apparatus is in a state of availability, makes connection related to settlement of a transaction using an IC card to the settlement-side apparatus to which settlement of a transaction using the IC card is connected. The transaction processing apparatus, in each input process for a plurality of different settlement information related to the transaction, sends any of the input settlement information to the transaction communication terminal in a case where communication between the transaction processing apparatus and the settlement-side apparatus is in a state of unavailability. The transaction communication terminal, in a case where the settlement information sent from the transaction processing apparatus is sent to the settlement-side apparatus, sends to the transaction processing apparatus a screen that prompts input of the settlement information corresponding to the subsequent input process. The transaction processing apparatus sends to the transaction communication terminal a settlement process request that includes any of the settlement information input in the last input process. The transaction communication terminal, in a case where the settlement process request sent from the transaction processing apparatus is sent to the settlement-side apparatus, sends to the transaction processing apparatus a settlement completion notification that is sent from the settlement-side apparatus. The transaction processing apparatus prints a slip copy related to a transaction in a case where the settlement completion notification is received.

A transaction processing apparatus of the present disclosure includes a first transceiver that makes connection related to settlement of a transaction using an IC card to a settlement-side apparatus to which settlement of a transaction using the IC card is connected, a second transceiver that communicates with a transaction communication terminal which makes connection related to settlement of a transaction using the IC card to the settlement-side apparatus, an obtainer that obtains a plurality of different settlement information related to the transaction through the second transceiver, and a printing unit that prints a slip copy related to the transaction. The second transceiver, in a case where communication between the first transceiver and the settlement-side apparatus is in a state of unavailability, sends any of the input settlement information to the transaction communication terminal in each input process for the settlement information and sends to the transaction communication terminal a settlement process request that includes any of the settlement information input in the last input process. The second transceiver, in a case where the settlement information is sent to the settlement-side apparatus, receives a screen that prompts input of the settlement information corresponding to the subsequent input process. The printing unit prints the slip copy related to the transaction in a case where a settlement completion notification for the transaction is received by the second transceiver.

A transaction communication terminal of the present disclosure includes a third transceiver that makes connection related to settlement of a transaction using an IC card to a settlement-side apparatus to which settlement of a transaction using the IC card is connected, a fourth transceiver that communicates with a transaction processing apparatus which makes connection related to settlement of a transaction using the IC card to the settlement-side apparatus, and an input into which a plurality of different settlement information related to the transaction is input. The third transceiver, in each input process for the plurality of different settlement information related to the transaction, sends any of the settlement information input by the input to the settlement-side apparatus in a case where communication between the transaction processing apparatus and the settlement-side apparatus is in a state of unavailability, and sends to the settlement-side apparatus a settlement process request that includes any of the settlement information input in the last input process. The fourth transceiver, in a case where the settlement information sent from the transaction processing apparatus is sent to the settlement-side apparatus, sends to the transaction processing apparatus a screen that prompts input of the settlement information corresponding to the subsequent input process, and in a case where the settlement process request sent from the transaction processing apparatus is sent to the settlement-side apparatus, sends to the transaction processing apparatus a settlement completion notification that is sent from the settlement-side apparatus.

A transaction processing system of the present disclosure includes a settlement-side apparatus to which settlement of a transaction using a card is connected, a transaction processing apparatus that makes connection related to settlement of a transaction using the card to the settlement-side apparatus, and a transaction communication terminal that is connectable to the transaction processing apparatus and the settlement-side apparatus and makes connection related to settlement of a transaction using the card to the settlement-side apparatus. The transaction communication terminal, in each input process for a plurality of different settlement information related to the transaction, sends any of the input settlement information to the transaction processing apparatus and sends to the transaction processing apparatus a settlement process request that includes any of the settlement information input in the last input process. The transaction processing apparatus, in a case where the settlement information sent from the transaction communication terminal is sent to the settlement-side apparatus, sends to the transaction communication terminal a screen that prompts input of the settlement information corresponding to the subsequent input process, and in a case where the settlement process request sent from the transaction communication terminal is sent to the settlement-side apparatus, sends to the transaction communication terminal a settlement completion notification that is sent from the settlement-side apparatus, and prints a slip copy related to the transaction.

In the transaction processing system of the present disclosure, the settlement information may include at least brand information, a card number, and an expiration date of the card, a transaction sum, a method of payment, the number of payments, and authentication information of a customer. The transaction processing apparatus may send to the transaction communication terminal a printing completion notification that indicates that printing of the slip copy is ended. The transaction communication terminal may delete the brand information, the card number, and the expiration date of the card, the transaction sum, the method of payment, the number of payments, and the authentication information of the customer after the printing completion notification is received.

In the transaction processing system of the present disclosure, the transaction processing apparatus may include a storage unit, accumulate the settlement information sent from the transaction communication terminal in the storage unit in a case where communication between the transaction processing apparatus and the settlement-side apparatus is in a state of unavailability, and print the slip copy after settlement using the settlement information is performed with the card.

In the transaction processing system of the present disclosure, the transaction processing apparatus may request the settlement-side apparatus to perform sales registration for the settlement using the settlement information accumulated in the storage unit after communication between the transaction processing apparatus and the settlement-side apparatus is placed into a state of availability.

A transaction processing method of the present disclosure is a transaction processing method in a transaction processing system to which a settlement-side apparatus, a transaction processing apparatus, and a transaction communication terminal are connected. The transaction communication terminal, in each input process for a plurality of different settlement information related to a transaction using a card, sends any of the input settlement information to the transaction processing apparatus. The transaction processing apparatus, in a case where the settlement information sent from the transaction communication terminal is sent to the settlement-side apparatus, sends to the transaction communication terminal a screen that prompts input of the settlement information corresponding to the subsequent input process. The transaction communication terminal sends to the transaction processing apparatus a settlement process request that includes any of the settlement information input in the last input process. The transaction processing apparatus, in a case where the settlement process request sent from the transaction communication terminal is sent to the settlement-side apparatus, sends to the transaction communication terminal a settlement completion notification that is sent from the settlement-side apparatus, and prints a slip copy related to the transaction.

A transaction processing apparatus of the present disclosure includes a first transceiver that makes connection related to settlement of a transaction to a settlement-side apparatus to which settlement of a transaction using a card is connected, a second transceiver that communicates with a transaction communication terminal of a portable type, an obtainer that obtains a plurality of different settlement information input by the transaction communication terminal and related to the transaction through the second transceiver, and a printing unit that prints a slip copy related to the transaction. The first transceiver, in each input process for the settlement information, sends any of the input settlement information to the settlement-side apparatus and sends to the settlement-side apparatus a settlement process request that includes any of the settlement information input in the last input process. The second transceiver, in a case where the settlement information is sent to the settlement-side apparatus, receives a screen that prompts input of the settlement information corresponding to the subsequent input process. The printing unit prints the slip copy related to the transaction in a case where a settlement completion notification for the transaction is received by the first transceiver.

A transaction communication terminal of the present disclosure includes a third transceiver that communicates with a transaction processing apparatus which makes connection related to settlement of a transaction using a card, an input into which a plurality of different settlement information related to the transaction is input, and a display that displays a screen which prompts input of the settlement information. The third transceiver sends any of the settlement information input by the input to the transaction processing apparatus in each input process for the plurality of different settlement information related to the transaction. The display, in a case where the settlement information is sent by the transaction processing apparatus to a settlement-side apparatus to which settlement of the transaction is connected, displays the screen that is sent from the settlement-side apparatus through the transaction processing apparatus and prompts input of the settlement information corresponding to the subsequent input process. The third transceiver sends to the transaction processing apparatus a settlement process request that includes any of the settlement information input in the last input process, and in a case where the settlement process request is sent by the transaction processing apparatus to the settlement-side apparatus, instructs the transaction processing apparatus to print a slip copy related to the transaction in response to a settlement completion notification that is sent from the settlement-side apparatus through the transaction processing apparatus and is related to settlement of the transaction.

### INDUSTRIAL APPLICABILITY

The present invention is useful as a transaction processing system, a transaction processing method, a transaction processing apparatus, and a transaction communication terminal that prevent degradation of security of authentication information and smoothly perform settlement using a card in an offline state including when a line to a settlement-side apparatus is unavailable and when a failure occurs, in a settlement scheme in which information required for authentication of a card used in a settlement process is sent and received between the card and the settlement-side apparatus.

The present invention is useful as a transaction processing system, a transaction processing method, a transaction processing apparatus, and a transaction communication terminal that can smoothly perform settlement using an IC credit card and can avoid an increase in a wait time of a customer for card settlement by using an additional apparatus in communication between the transaction processing apparatus and a settlement relay center in a case where the number of transaction processing apparatuses provided in a store is not sufficient enough to process card settlement for visitors (customers).

### REFERENCE MARKS IN THE DRAWINGS

1, 1a transaction processing apparatus
2, 2a, 2b, 2c, 2ca, 2cb additional apparatus
5 settlement relay center
6 settlement center
7 PINPAD
9 layer 3 switch or router (L3SW/RT)
21, 22 CPU
23, 24 magnet stripe card reader
25 contact IC card reader/writer
26 contact IC card reader
27, 28 non-contact IC card reader/writer
29, 30 loop antenna
31 PINPAD I/F
33, 34 key-input
35, 36 touch-input
37, 38 display
39 printer I/F
41 printer
43 symbol reader I/F
45 symbol reader
47 wired network I/F
49, 50 wide-range wireless transceiver
49A, 50A wide-range wireless antenna
51, 52 local-area wireless transceiver
51A, 52A local-area wireless antenna
55, 56 flash ROM
57, 58 RAM
62 power supply
64 PINPAD processor
BDR symbol reader
BT battery
NW1 intranet
NW2, NW5 Internet
NW3 mobile communication network
NW4 public switched telephone network
TP, TP2 touch panel

1. A transaction processing system comprising:
a settlement-side apparatus to which settlement of a transaction using an IC card is connected;
a transaction processing apparatus that makes connection related to settlement of a transaction using the IC card to the settlement-side apparatus; and
a transaction communication terminal that is connectable to the transaction processing apparatus and the settlement-side apparatus and makes connection related to settlement of a transaction using the IC card to the settlement-side apparatus,
wherein the transaction processing apparatus, in each input process for a plurality of different settlement information related to the transaction, sends any of the input settlement information to the transaction communication terminal in a case where communication between the transaction processing apparatus and the settlement-side apparatus is in a state of unavailability, and sends to the transaction communication terminal a settlement process request that includes any of the settlement information input in the last input process,
the transaction communication terminal
in a case where the settlement information sent from the transaction processing apparatus is sent to the settlement-side apparatus, sends to the transaction processing apparatus a screen that prompts input of the settlement information corresponding to the subsequent input process, and
in a case where the settlement process request sent from the transaction processing apparatus is sent to the settlement-side apparatus, sends to the transaction processing apparatus a settlement completion notification that is sent from the settlement-side apparatus, and
the transaction processing apparatus
prints a slip copy related to the transaction in a case where the settlement completion notification is received.

2. The transaction processing system of claim 1,
wherein the settlement information includes at least brand information, a card number, and an expiration date of the IC card, a transaction sum, a method of payment, the number of payments, and authentication information of a customer,
the brand information, the card number, and the expiration date of the IC card, the transaction sum, the method of payment, the number of payments, and the authentication information of the customer are input by the transaction communication terminal,
the transaction processing apparatus sends a printing completion notification for the slip copy to the transaction communication terminal, and
the transaction communication terminal deletes at least one of the brand information, the card number, and the expiration date of the IC card, the transaction sum, the method of payment, the number of payments, and the authentication information of the customer after the printing completion notification is received.

3. The transaction processing system of claim 1,
wherein the settlement information includes at least brand information, a card number, and an expiration date of the IC card, a transaction sum, a method of payment, the number of payments, and authentication information of a customer,
the brand information, the card number, and the expiration date of the IC card, the transaction sum, the method of payment, the number of payments, and the authentication information of the customer are input by the transaction processing apparatus, and
the transaction processing apparatus deletes at least one of the brand information, the card number, and the expiration date of the IC card, the transaction sum, the method of payment, the number of payments, and the authentication information of the customer after the slip copy is printed.

4. The transaction processing system of claim 1,
wherein the settlement information includes at least brand information, a card number, and an expiration date of the IC card, a transaction sum, a method of payment, the number of payments, and authentication information of a customer,
first settlement information that is configured of a part of the settlement information is input by the transaction communication terminal,
second settlement information that is configured of information other than the first settlement information in the settlement information is input by the transaction processing apparatus,
the transaction processing apparatus sends a printing completion notification for the slip copy to the transaction communication terminal,
the transaction communication terminal deletes at least one in the first settlement information after the printing completion notification is received, and
the transaction processing apparatus deletes at least one in the second settlement information after the slip copy is printed.

5. The transaction processing system of claim 1,
wherein the settlement information includes at least brand information, a card number, and an expiration date of the IC card, a transaction sum, a method of payment, the number of payments, and authentication information of a customer,
the brand information of the IC card, the transaction sum, the method of payment, and the number of payments are input by the transaction communication terminal,
the card number and the expiration date and the authentication information of the customer are input by the transaction processing apparatus,
the transaction processing apparatus sends a printing completion notification for the slip copy to the transaction communication terminal,
the transaction communication terminal deletes the brand information of the IC card, the transaction sum, the method of payment, and the number of payments after the printing completion notification is received, and
the transaction processing apparatus deletes the card number and the expiration date of the IC card and the authentication information of the customer after the slip copy is printed.

6. A transaction processing system comprising:
a settlement-side apparatus to which settlement of a transaction using a card is connected;
a transaction processing apparatus that makes connection related to settlement of a transaction using the card to the settlement-side apparatus; and
a transaction communication terminal that is connectable to the transaction processing apparatus and the settlement-side apparatus and makes connection related to settlement of a transaction using the card to the settlement-side apparatus,
wherein the transaction communication terminal, in each input process for a plurality of different settlement information related to the transaction, sends any of the input settlement information to the transaction processing apparatus and sends to the transaction processing apparatus a settlement process request that includes any of the settlement information input in the last input process, and
the transaction processing apparatus
in a case where the settlement information sent from the transaction communication terminal is sent to the settlement-side apparatus, sends to the transaction communication terminal a screen that prompts input of the settlement information corresponding to the subsequent input process, and
in a case where the settlement process request sent from the transaction communication terminal is sent to the settlement-side apparatus, sends to the transaction communication terminal a settlement completion notification that is sent from the settlement-side apparatus, and prints a slip copy related to the transaction.

7. The transaction processing system of claim 6,
wherein the settlement information includes at least brand information, a card number, and an expiration date of the card, a transaction sum, a method of payment, the number of payments, and authentication information of a customer, and
the transaction processing apparatus sends to the transaction communication terminal a printing completion notification that indicates that printing of the slip copy is ended, and the transaction communication terminal deletes the brand information, the card number, and the expiration date of the card, the transaction sum, the method of payment, the number of payments, and the authentication information of the customer after the printing completion notification is received.

8. The transaction processing system of claim 6,
wherein the transaction processing apparatus includes a storage unit, accumulates the settlement information sent from the transaction communication terminal in the storage unit in a case where communication between the transaction processing apparatus and the settlement-side apparatus is in a state of unavailability, and prints the slip copy after settlement using the settlement information is performed with the card.

9. The transaction processing system of claim 8,
wherein the transaction processing apparatus requests the settlement-side apparatus to perform sales registration for the settlement using the settlement information accumulated in the storage unit after communication between the transaction processing apparatus and the settlement-side apparatus is placed into a state of availability.

10. A transaction processing system comprising:
a settlement-side apparatus to which settlement of a transaction using an IC card is connected;
a transaction processing apparatus of a thin client that makes connection related to settlement of a transaction using the IC card to the settlement-side apparatus; and
a transaction communication terminal that is connectable to the transaction processing apparatus and the settlement-side apparatus and makes connection related to settlement of a transaction using the IC card to the settlement-side apparatus,
wherein the transaction processing apparatus, in a case where communication between the transaction processing apparatus and the settlement-side apparatus is in a state of unavailability, sends to the transaction communication terminal transaction settlement information that includes brand information of the IC card, a transaction sum, a method of payment, the number of payments, and authentication information of a customer which are input, and includes a card number and an expiration date which are read from the IC card,
the transaction communication terminal, in a case where a settlement request that includes the transaction settlement information sent from the transaction processing apparatus is sent to the settlement-side apparatus, sends a sending completion notification for the settlement request including the transaction settlement information to the transaction processing apparatus, and
the transaction processing apparatus prints a predetermined slip copy in a case where the sending completion notification is received.

11. The transaction processing system of claim 10,
wherein the brand information of the IC card, the transaction sum, the method of payment, the number of payments, and the authentication information of the customer are input by the transaction communication terminal,
the card number and the expiration date of the IC card is read from the IC card by the transaction communication terminal,
the transaction processing apparatus sends a printing completion notification for the predetermined slip copy to the transaction communication terminal, and
the transaction communication terminal deletes the brand information, the card number, and the expiration date of the IC card, the transaction sum, the method of payment, the number of payments, and the authentication information of the customer after the printing completion notification is received.

12. The transaction processing system of claim 10,
wherein the brand information of the IC card, the transaction sum, the method of payment, the number of payments, and the authentication information of the customer are input by the transaction processing apparatus,
the card number and the expiration date of the IC card is read from the IC card by the transaction processing apparatus, and
the transaction processing apparatus deletes the brand information, the card number, and the expiration date of the IC card, the transaction sum, the method of payment, the number of payments, and the authentication information of the customer after the predetermined slip copy is printed.

13. The transaction processing system of claim 10,
wherein the brand information of the IC card, the transaction sum, the method of payment, and the number of payments are input by the transaction communication terminal,
the authentication information of the customer is input by the transaction processing apparatus,
the card number and the expiration date of the IC card are read from the IC card by the transaction processing apparatus,
the transaction processing apparatus sends a printing completion notification for the predetermined slip copy to the transaction communication terminal, and
the transaction communication terminal deletes the brand information of the IC card, the transaction sum, the method of payment, and the number of payments after the printing completion notification is received.

14. A transaction processing system comprising:
a settlement-side apparatus to which settlement of a transaction using a card is connected;
a transaction processing apparatus of a thin client that makes connection related to settlement of a transaction using the card to the settlement-side apparatus; and
a transaction communication terminal that is connectable to the transaction processing apparatus and the settlement-side apparatus and makes connection related to settlement of a transaction using the card to the settlement-side apparatus,
wherein the transaction communication terminal sends to the transaction processing apparatus transaction settlement information that includes brand information, a card number, and an expiration date of the card, a transaction sum, a method of payment, and the number of payments which are input,
the transaction processing apparatus receives the transaction settlement information sent from the transaction communication terminal and sends to the settlement-side apparatus a settlement request that includes the received transaction settlement information, and
the transaction processing apparatus prints a predetermined slip copy in a case where the settlement request including the transaction settlement information is sent to the settlement-side apparatus.

15. The transaction processing system of claim 14,
wherein the transaction processing apparatus sends a printing completion notification for the predetermined slip copy to the transaction communication terminal, and
the transaction communication terminal deletes the brand information, the card number, and the expiration date of the card, the transaction sum, the method of payment, and the number of payments after the printing completion notification is received.

16. The transaction processing system of claim 14,
wherein the transaction processing apparatus includes a storage unit, accumulates the transaction settlement information in the storage unit in a case where communication between the transaction processing apparatus and the settlement-side apparatus is in a state of unavailability, and prints the predetermined slip copy after conditional settlement using the transaction settlement information is performed with the card.

17. The transaction processing system of claim 16,
wherein the transaction processing apparatus requests the settlement-side apparatus to perform sales registration for the conditional settlement using the transaction settlement information accumulated in the storage unit in a case where communication between the transaction processing apparatus and the settlement-side apparatus is placed into a state of availability.

18. A transaction processing method in a transaction processing system to which a settlement-side apparatus, a transaction processing apparatus of a thin client, and a transaction communication terminal are connected,
wherein in a case where communication between the transaction processing apparatus and the settlement-side apparatus is in a state of availability,
the transaction processing apparatus makes connection related to settlement of a transaction using an IC card to the settlement-side apparatus to which settlement of a transaction using the IC card is connected, and
in a case where communication between the transaction processing apparatus and the settlement-side apparatus is in a state of unavailability,
the transaction processing apparatus, in each input process for a plurality of different settlement information related to the transaction, sends any of the input settlement information to the transaction communication terminal,
the transaction communication terminal, in a case where the settlement information sent from the transaction processing apparatus is sent to the settlement-side apparatus, sends to the transaction processing apparatus a screen that prompts input of the settlement information corresponding to the subsequent input process,
the transaction processing apparatus sends to the transaction communication terminal a settlement process request that includes any of the settlement information input in the last input process,
the transaction communication terminal, in a case where the settlement process request sent from the transaction processing apparatus is sent to the settlement-side apparatus, sends to the transaction processing apparatus a settlement completion notification that is sent from the settlement-side apparatus, and
the transaction processing apparatus prints a slip copy related to the transaction in a case where the settlement completion notification is received.

19. A transaction processing method in a transaction processing system to which a settlement-side apparatus, a transaction processing apparatus, and a transaction communication terminal are connected,
wherein the transaction communication terminal, in each input process for a plurality of different settlement information related to a transaction using a card, sends any of the input settlement information to the transaction processing apparatus,
the transaction processing apparatus, in a case where the settlement information sent from the transaction communication terminal is sent to the settlement-side apparatus, sends to the transaction communication terminal a screen that prompts input of the settlement information corresponding to the subsequent input process,
the transaction communication terminal sends to the transaction processing apparatus a settlement process request that includes any of the settlement information input in the last input process, and
the transaction processing apparatus, in a case where the settlement process request sent from the transaction communication terminal is sent to the settlement-side apparatus, sends to the transaction communication terminal a settlement completion notification that is sent from the settlement-side apparatus, and prints a slip copy related to the transaction.

20. A transaction processing method in a transaction processing system to which a settlement-side apparatus, a transaction processing apparatus of a thin client, and a transaction communication terminal are connected,
wherein the transaction processing apparatus, in a case where communication between the transaction processing apparatus and the settlement-side apparatus is in a state of availability, performs a step of making connection related to settlement of a transaction using an IC card to the settlement-side apparatus to which settlement of a transaction using the IC card is connected,
the transaction processing apparatus, in a case where communication between the transaction processing apparatus and the settlement-side apparatus is in a state of unavailability, performs a step of sending to the transaction communication terminal transaction settlement information that includes brand information of the IC card, a transaction sum, a method of payment, the number of payments, and authentication information of a customer which are input, and includes a card number and an expiration date which are read from the IC card,
the transaction communication terminal performs a step of sending to the settlement-side apparatus a settlement request that includes the transaction settlement information sent from the transaction processing apparatus,
the transaction communication terminal, in a case where a settlement request that includes the transaction settlement information is sent to the settlement-side apparatus, performs a step of sending a sending completion notification for the settlement request including the transaction settlement information to the transaction processing apparatus, and
the transaction processing apparatus performs a step of printing a predetermined slip copy in a case where the sending completion notification is received.

21. A transaction processing method in a transaction processing system to which a settlement-side apparatus, a transaction processing apparatus of a thin client, and a transaction communication terminal are connected,
wherein the transaction communication terminal performs a step of receiving input of the transaction settlement information that includes brand information, a card number, and an expiration date of a card used in settlement of a transaction, a transaction sum, a method of payment, and the number of payments,
the transaction communication terminal performs a step of sending the input transaction settlement information to the transaction processing apparatus,
the transaction processing apparatus performs a step of receiving the transaction settlement information sent from the transaction communication terminal and sending to the settlement-side apparatus a settlement request that includes the received transaction settlement information, and
the transaction processing apparatus performs a step of printing a predetermined slip copy in a case where the settlement request including the transaction settlement information is sent to the settlement-side apparatus.

22. A transaction processing apparatus comprising:
a first transceiver that makes connection related to settlement of a transaction using an IC card to a settlement-side apparatus to which settlement of a transaction using the IC card is connected;
a second transceiver that communicates with a transaction communication terminal which makes connection related to settlement of a transaction using the IC card to the settlement-side apparatus;
an obtainer that obtains a plurality of different settlement information related to the transaction through the second transceiver; and
a printing unit that prints a slip copy related to the transaction,
wherein the second transceiver, in each input process for the settlement information, sends any of the input settlement information to the transaction communication terminal in a case where communication between the first transceiver and the settlement-side apparatus is in a state of unavailability, and sends to the transaction communication terminal a settlement process request that includes any of the settlement information input in the last input process,
the second transceiver, in a case where the settlement information is sent to the settlement-side apparatus, receives a screen that prompts input of the settlement information corresponding to the subsequent input process, and
the printing unit prints the slip copy related to the transaction in a case where a settlement completion notification for the transaction is received by the second transceiver.

23. A transaction processing apparatus comprising:
a first transceiver that makes connection related to settlement of a transaction to a settlement-side apparatus to which settlement of the transaction using a card is connected;
a second transceiver that communicates with a transaction communication terminal of a portable type;
an obtainer that obtains a plurality of different settlement information input by the transaction communication terminal and related to the transaction through the second transceiver; and
a printing unit that prints a slip copy related to the transaction,
wherein the first transceiver, in each input process for the settlement information, sends any of the input settlement information to the settlement-side apparatus and sends to the settlement-side apparatus a settlement process request that includes any of the settlement information input in the last input process,
the second transceiver, in a case where the settlement information is sent to the settlement-side apparatus, receives a screen that prompts input of the settlement information corresponding to the subsequent input process, and
the printing unit prints the slip copy related to the transaction in a case where a settlement completion notification for the transaction is received by the first transceiver.

24. A transaction processing apparatus comprising:
a first transceiver that makes connection related to settlement of a transaction using an IC card to a settlement-side apparatus to which settlement of a transaction using the IC card is connected;
a second transceiver that communicates with a transaction communication terminal which makes connection related to settlement of a transaction using the IC card to the settlement-side apparatus;
an obtainer that obtains through the second transceiver transaction settlement information which includes brand information, a card number, and an expiration date of the IC card, a transaction sum, a method of payment, the number of payments, and authentication information of a customer; and
a printing unit that prints a predetermined slip copy,
wherein the second transceiver, in a case where communication between the first transceiver and the settlement-side apparatus is in a state of unavailability, sends the transaction settlement information obtained by the obtainer to the transaction communication terminal, and
the printing unit, in a case where the transaction communication terminal sends to the settlement-side apparatus a settlement request that includes the transaction settlement information, prints the predetermined slip copy in response to a sending completion notification, from the transaction communication terminal, for the settlement request including the transaction settlement information.

25. A transaction processing apparatus comprising:
a first transceiver that makes connection related to settlement of a transaction using a card to a settlement-side apparatus to which settlement of a transaction using the card is connected;
a second transceiver that communicates with a transaction communication terminal of a portable type;
an obtainer that obtains through the second transceiver transaction settlement information which includes brand information, a card number, and an expiration date of the card, a transaction sum, a method of payment, and the number of payments input by the transaction communication terminal; and
a printing unit that prints a predetermined slip copy,
wherein the first transceiver sends to the settlement-side apparatus a settlement request that includes the transaction settlement information obtained by the obtainer, and
the printing unit prints the predetermined slip copy in a case where the settlement request including the transaction settlement information is sent to the settlement-side apparatus.

26. A transaction communication terminal comprising:
a third transceiver that makes connection related to settlement of a transaction using an IC card to a settlement-side apparatus to which settlement of a transaction using the IC card is connected;
a fourth transceiver that communicates with a transaction processing apparatus which makes connection related to settlement of a transaction using the IC card to the settlement-side apparatus; and
an input into which a plurality of different settlement information related to the transaction is input,
wherein the third transceiver, in each input process for the plurality of different settlement information related to the transaction, sends any of the settlement information input by the input to the settlement-side apparatus in a case where communication between the transaction processing apparatus and the settlement-side apparatus is in a state of unavailability, and sends to the settlement-side apparatus a settlement process request that includes any of the settlement information input in the last input process, and
the fourth transceiver
in a case where the settlement information sent from the transaction processing apparatus is sent to the settlement-side apparatus, sends to the transaction processing apparatus a screen that prompts input of the settlement information corresponding to the subsequent input process, and
in a case where the settlement process request sent from the transaction processing apparatus is sent to the settlement-side apparatus, sends to the transaction processing apparatus a settlement completion notification that is sent from the settlement-side apparatus.

27. A transaction communication terminal comprising:
a third transceiver that communicates with a transaction processing apparatus which makes connection related to settlement of a transaction using a card;
an input into which a plurality of different settlement information related to the transaction is input; and
a display that displays a screen which prompts input of the settlement information,
wherein the third transceiver
sends any of the settlement information input by the input to the transaction processing apparatus in each input process for the plurality of different settlement information related to the transaction,
the display
in a case where the settlement information is sent by the transaction processing apparatus to a settlement-side apparatus to which settlement of the transaction is connected, displays the screen that is sent from the settlement-side apparatus through the transaction processing apparatus and prompts input of the settlement information corresponding to the subsequent input process,
the third transceiver
sends to the transaction processing apparatus a settlement process request that includes any of the settlement information input in the last input process, and
in a case where the settlement process request is sent by the transaction processing apparatus to the settlement-side apparatus, instructs the transaction processing apparatus to print a slip copy related to the transaction in response to a settlement completion notification that is sent from the settlement-side apparatus through the transaction processing apparatus and is related to settlement of the transaction.

28. A transaction communication terminal comprising:
a third transceiver that makes connection related to settlement of a transaction using an IC card to a settlement-side apparatus to which settlement of a transaction using the IC card is connected;
a fourth transceiver that communicates with a transaction processing apparatus which makes connection related to settlement of a transaction using the IC card to the settlement-side apparatus;
an input into which brand information of the IC card, a transaction sum, a method of payment, the number of payments, and authentication information of a customer are input; and
a reading unit that reads a card number and an expiration date of the IC card from the IC card,
wherein the fourth transceiver sends to the transaction processing apparatus transaction settlement information that includes the brand information of the IC card, the transaction sum, the method of payment, the number of payments, and the authentication information of the customer input by the input and the card number and the expiration date of the IC card read by the reading unit,
the third transceiver, in response to an instruction from the transaction processing apparatus, sends to the settlement-side apparatus a settlement request that includes the transaction settlement information, and
the fourth transceiver sends a sending completion notification for the settlement request including the transaction settlement information to the transaction processing apparatus.

29. A transaction communication terminal comprising:
a third transceiver that communicates with a transaction processing apparatus which makes connection related to settlement of a transaction using a card to a settlement-side apparatus to which settlement of a transaction using the card is connected; and
an input into which transaction settlement information that includes brand information, a card number, and an expiration date of the card, a transaction sum, a method of payment, and the number of payments is input,
wherein the third transceiver sends the transaction settlement information input by the input to the transaction processing apparatus and, in a case where a settlement request that includes the transaction settlement information is sent from the transaction processing apparatus to the settlement-side apparatus, receives a printing completion notification for a predetermined slip copy that is printed by the transaction processing apparatus.
